(19) United States
(12) Patent Application Publication
(10) Pub. No.: US 2011/0153351 A1
(43) Pub. Date: Jun. 23, 2011

(54) COLLABORATIVE MEDICAL IMAGING WEB APPLICATION

(76) Inventors: Gregory Vesper, Cave Creek, AZ (US); Jhon W. Honce, Cave Creek, AZ (US); C. Roger Bird, Phoenix, AZ (US); Anatoly Geyfman, Phoenix, AZ (US)

(21) Appl. No.: 12/971,302

(22) Filed: Dec. 17, 2010

Related U.S. Application Data
(60) Provisional application No. 61/287,611, filed on Dec. 17, 2009.

(51) Int. Cl. G06Q 50/00

(52) U.S. Cl. 705/2

(57) ABSTRACT

A system and method for acquiring, hosting and distributing medical images for healthcare professionals. The system can include a database for storing private health information split from a medical imaging record. The system can also include a repository for storing at least one anonymized image split from the medical record. The anonymized images are parsed into a schema upon request with the schema provided in response to the request. The schema can define a structure mapping the anonymized images into a study. The personal information can be joined with the anonymized images to form medical imaging records into the study according to the structure. One or more participant devices in communication with the medical information network can provide collaborative features having application level capabilities that access, process, analyze or augment the personal information from the database and the non-personal information from the repository split from the medical imaging records.

### REFERENCE TO RELATED APPLICATIONS

This application claims priority to U.S. patent application Ser. No. 12/968,657 titled WEB ENABLED MEDICAL IMAGE REPOSITORY that was filed on Dec. 15, 2010, U.S. patent application Ser. No. 12/964,038 titled GLOBAL MEDICAL IMAGING REPOSITORY that was filed on Dec. 9, 2010 and U.S. Provisional Application Ser. No. 61/287,611 titled MEDICAL INFORMATION NETWORK AND METHODS THEREIN that was filed on Dec. 17, 2009, which were continuation-in-part applications of U.S. Pat. No. 7,660,413 titled SECURE DIGITAL COURIERING SYSTEM AND METHOD that was filed on Apr. 10, 2006, which claimed priority to U.S. Provisional Application Ser. No. 60/669,407 titled DICOM GRID SYSTEM that was filed on Apr. 8, 2005, all of which are hereby incorporated by reference in their entirety.

### TECHNICAL FIELD

The present application generally relates to medical images, and, more particularly, to a collaborative medical imaging web application for processing and analyzing images stored in a global medical imaging repository.

### BACKGROUND

The Digital Imaging and Communications in Medicine (DICOM) standard was created by the National Electrical Manufacturers Association (NEMA) for improving distribution and access of medical images, such as CT scans, MRI and x-rays. DICOM arose in an attempt to standardize the image format of different machine vendors (i.e., GE, Hitachi, Philips) to promote compatibility such that machines provided by competing vendors could transmit and receive information between them. DICOM defines a network communication protocol as well as a data format for images.

Each image can exist independently as a separate data structure, typically in the form of a textual header followed by a binary segment containing the actual image. This data structure can be commonly persisted as a file on a file system. An image study can be a collection of DICOM images with the same study unique identifier (UID). The study UID can be stored as metadata in the textual header of each DICOM image. The DICOM communication protocol does not comprehend collections of DICOM images into an image study, it can only comprehend individual DICOM images. An image study is an abstraction that can be a collection of DICOM images with the same study UID, which is beyond the scope of the DICOM communication protocol.

Furthermore, digital medical images are not routinely transported outside of a secure intranet environment (e.g., over the Internet) for two principal reasons. First, medical images are, in most cases, too large to easily email. Second, and more importantly, under the Health Insurance Portability and Accountability Act of 1996 (“HIPAA”), measures can be taken to provide enhanced security and guarantee privacy of a patient's health information. These requirements cannot be satisfied through routine email or conventional network connections.

As a result, if a medical record or imaging study is to be sent from an imaging center or hospital to a referring physician's office, a physical film or compact disc (CD) can be printed and hand delivered. Often, this is expensive, inaccurate, inefficient and slow. There does not exist today a simple electronic means of moving imaging studies, or other medical or similar records, among unaffiliated sites. Therefore, in light of the present methods available for moving medical records, images and other personal information, a need exists for a system and method for providing a secure system for accessing and moving those records among authorized parties.

To transmit one or more DICOM images between DICOM devices, a network level DICOM connection can be created between two devices through a TCP/IP communication channel. Once a connection is established, at the discretion of the sender, one or more DICOM images can be transmitted from the sender to the receiver. A sender can choose to send a single DICOM image per DICOM association, a group of images containing the same study UID per DICOM association, or a group of images containing a variety of study UIDs per DICOM association. The receiving DICOM device typically has no protocol level mechanism for determining when it has received all of the DICOM images for a given DICOM study. Convention in the DICOM development community is for a receiving DICOM device to introspect the DICOM header of individual images as they are being received, identify the study UID, and then aggregate the individual images into image studies in a database or on a file system. While this technique is effective to a degree, there is no way for a receiving DICOM device to know when it has received the last image for a given image study.

Because of this, it is difficult to determine when to make a study available for a downstream DICOM device or application. A common mitigating technique is to introduce artificial latency, or timers, on a study UID by study UID basis. A timer for a given study UID should expire before making a group of images available to a downstream DICOM device.

This industry standard approach attempts to impose a study-oriented communication protocol on top of the inherently image-oriented DICOM protocol. This fundamental mismatch between an image-oriented network protocol and a study-oriented application metaphor creates significant downstream liabilities for clinical radiological workflows.

Through artificial latencies, described above, each DICOM device in a clinical workflow can wait a defined amount of time before making studies available to an end user or to a downstream DICOM device. This technique is by definition non-deterministic and non-event driven. A serial sequence of DICOM devices can create a chain of latencies that materially delay the clinical workflow.

If additional image content is received after the application defined latency period, then the study can be updated in the downstream devices and user applications, which in turn raises both mechanism and policy issues for clinical DICOM workflow. If a study update is simply adding new images to an existing study, then an additive policy can be implemented by downstream devices and applications. If a study update is modifying data in an existing study, perhaps textual data in the DICOM header that was incorrectly entered by a technician, now there is a possibility that previously processed DICOM data was in error and can be corrected. This means that any downstream device needs to update the errant DICOM files with the corrected ones. If a study update is attempting to remove previously submitted images, downstream devices and applications need to delete the appropriate DICOM files. Nonetheless, and under the current DICOM protocol, no mechanism is provided for deleting or correcting errant images, so each device and application addresses this problem based on their own internally derived mechanism and policy.

DICOM is a store and forward protocol that is deterministic image by image, but nondeterministic image study by image study. This creates a non-deterministic, study-oriented data flow. DICOM dataflow is the foundation of radiological clinical workflows. Nondeterministic DICOM dataflows introduce non-determinism into the clinical workflow. Getting the right images to the right person at the right time becomes problematic and inefficient.

The awkward nature of the study-oriented store and forward of DICOM data lends itself to silo-ed and overlapping repositories of DICOM images inside the four walls of an institution. This creates significant storage inefficiencies and infrastructure carrying costs. It also lends itself to fragmented repositories where there is no single repository that holds all images for a given facility. This introduces challenges when treating return patients where access to prior imaging studies is fundamental to the clinical process.

Silo-ed images, accessible through an artificial application level image study metaphor, create an opaque domain model for images in an image study with no visibility into the relative importance of images. The clinical reality is that some images are more valuable than others. The more important images are frequently tagged by radiologists as ‘key’ images and annotated or post-processed to enhance the imaging data within the image. Key images, and the images immediately adjacent to key images, are often the high value content within an image study. Downstream referring physicians typically do not want to view an entire image study, they want to view the small subset of high value images. But study oriented processing is opaque in the fact that there is no ability to distinguish the relevancy of images within the study. Optimized radiological workflow demands appropriate mechanisms for data relevancy and study oriented processing inhibits these mechanisms.

In current systems, providing collaborative features to access medical images over the web creates numerous challenges. Standard protocols do not exist for those systems described in the previously filed applications. It would be desirable to provide a medical information network with collaborative medical imaging web applications that overcome the above described issues as well as provide other related advantages.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a system is provided. The system can include a database storing personal information split from medical imaging records and a repository storing non-personal information split from the medical imaging records. In addition, the system can include one or more participant devices in communication with the database and repository including collaborative functions having application level capabilities that access, process, analyze or augment the personal information from the database and the non-personal information from the repository split from the medical imaging records.

In accordance with another aspect of the present application, a device is provided. The device can include a processor and memory coupled to the processor, wherein the memory can include program instructions executable by the processor to implement at least one application. The at least one application can be in communication with cloud services for executing collaborative functions. The cloud services can include stored medical imaging records. The medical imaging records can be split between a database having personal information and a repository having non-personal information within the cloud services.

In accordance with yet another aspect of the present application, a method for implementing collaborative features on a medical imaging system is provided. The method can include providing one or more routines to a participating node. In addition, the method can include receiving a routine request from the participating node corresponding to the one or more routines. The method can also include processing or analyzing medical imaging records dependent on the routine request by accessing the medical imaging records in the medical imaging system.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIGS. 1A and 1B are general overviews of a digital couriering system;

FIG. 2 is a flowchart illustrating the general flow of the disclosed digital couriering system and method;

FIG. 3 illustrates one embodiment of the disclosed digital couriering system;

FIG. 4 is a detailed illustration of the production environment of the disclosed system;

FIG. 5 is an illustration of the central network component of the disclosed digital couriering system;

FIG. 6 is an illustration of the node server or node services component of the disclosed digital couriering system;

FIG. 7 is an illustration of one embodiment of the record producer component of the disclosed digital couriering system;

FIG. 8 is a further illustration of one embodiment of the record producer component of the disclosed system;

FIG. 9 is an illustration of one embodiment of the record consumer component of the disclosed system;

FIG. 10 is a further illustration of one embodiment of the record consumer component of the disclosed system;

FIG. 11 illustrates one embodiment of the communication pathway between the central network and the nodes of the disclosed system;

FIGS. 12A and 12B further illustrate one embodiment of the communication pathway between the central network and the nodes and transfer of information between the central network and the nodes and between the nodes;

FIG. 13 illustrates nodal registration on the system, according to one embodiment of the disclosure;

FIGS. 14A and 14B are flowcharts illustrating registration of record consumers and record producers on the system;

FIGS. 15A through 15K illustrate various user interfaces for the disclosed system;

FIG. 16A through 16C illustrate the search and add features of the described system;

FIG. 17 is a basic illustration of how records are digitally couriered according to the disclosure;

FIG. 18 is an alternate illustration of the digital couriering method of the present system, including the record producing, harvesting and uploading features of the disclosed system;

FIG. 19 illustrates the digital couriering mechanism of the disclosed system from the source node server to the central network;

FIG. 20 illustrates one mechanism by which a source node of the system manages records from a record producer prior to transmission;

FIG. 21 illustrates one embodiment of nodal communication and verification of the disclosed system;

FIG. 22 illustrates one embodiment of record retrieval by record consumers;

FIGS. 23A and 23B illustrate one embodiment of the node software and a detailed data model of the components of the disclosed system;

FIGS. 24A through 24G illustrate the administrative components or ID Hub features of the system;

FIG. 25 is a high level diagram illustrating the transfer of information across the disclosed system in conjunction with the chain of trust relationships in the system;

FIGS. 26A though 26D illustrate the chain of trust features of the digital couriering system;

FIGS. 27A and 27B illustrate forwarding and referral chain of trust features of the system;

FIGS. 28A through 28D illustrate proxy chain of trust features of the disclosed system;

FIGS. 29A and 29B illustrate trust revocation and expiration features of the digital couriering system;

FIG. 30 depicts a block diagram representing the split-join concept described earlier;

FIG. 31 is a representative diagram showing an exemplary repository storing anonymized DICOM files and imaging-related non-DICOM data;

FIG. 32 shows a DICOM grid global resource address;

FIG. 33 is a block diagram showing typical features for a grid within the repository;

FIG. 34 shows a block diagram representing typical cloud and local services;

FIG. 35 depicts exemplary features provided by the cloud services;

FIG. 36 is a block diagram showing an illustrative timing sequence for uploading DICOM files to the repository as well as the database;

FIG. 37 shows illustrative features for a grid workflow;

FIGS. 38A, 38B and 38C provide illustrative processes for the producer, central index and consumer;

FIG. 39 provides a typical node deployable stack;

FIGS. 40A and 40B are illustrative interactive and auto forwarding viewing node workflows;

FIG. 41 illustrates layers within a communication node;

FIGS. 42A, 42B and 42C show retrieval of DICOM data;

FIG. 43 provides a typical environment for node deployment;

FIG. 44 depicts further deployment of the DICOM images;

FIG. 45 depicts a diagram representing web enabling DICOM data;

FIG. 46 is a block diagram showing an illustrative timing sequence for acquisition of medical imaging records;

FIG. 47 shows dynamic schema generation;

FIG. 48 depicts a collaborative medical imaging web application; and

FIG. 49 provides an anatomy of a DICOM grid global resource locator.

### DESCRIPTION OF THE APPLICATION

The description set forth below in connection with the appended drawings is intended as a description of presently preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

The present application is directed to a system and method for the storage and distribution of medical records, images and other personal information, including DICOM format medical images. While it is envisioned that the present system and method are applicable to the electronic couriering of any records comprising both personal information and other information which is not personally identifiable (non-personal information), the present disclosure describes the system and method, by way of non-limiting example only, with particular applicability to medical records, and more specifically to medical image records, which are also referred to herein as DICOM files.

The disclosed system and method is a network that makes it possible for records comprising personal information and other non-personal information to be delivered in seconds via the Internet, instead of days through the use of the current standard couriers, such as messenger services or regular mail. Using the disclosed system and method, vital documents not only reach their destination more quickly but also in a more cost-effective manner.

According to the present system and method, a record, for example, a DICOM file, is composed of two major components: 1) the actual body of the record, for example, the image data, and 2) the image header information, which contains the personal or patient-identifying information. According to the present disclosure, the header contains personal identifying information, also known as personal information, Protected Health Information, or PHI. According to the present disclosure, without the PHI header, record data, including image data, is anonymous and does not contain any unique patient identifying information. Therefore, the non-personal or anonymous data portion of a record is referred to herein as the Body. Thus, records according to the present disclosure have at a minimum, two parts: 1) a header and 2) a body. It is recognized that not all personal information will be present in the form of a traditional header, but the term is used in the description of some embodiments for ease of reference to any PHI or personal information in a record. In other embodiments it is referred to as personal information or PHI.

Generally, the disclosed system and method stores the original record, comprised of the PHI and body of the record (for example, the image itself) at the original site (such as the hospital, laboratory or radiology practice group) where the record was created, for example, where the imaging procedure was first performed. Then, a centralized collection of servers helps manage the movement of the records, for example, DICOM files, over a peer-to-peer network.

These servers may include, but are not limited to: (1) a database of user accounts, also called a credential store. This database indicates persons authorized to access the system, which determines who is authorized to access the system; (2) a PHI directory, also called a Central Index, that maintains pointers to the distributed locations of all copies of all PHIs in the system; (3) a Storage Node Gateway Registry, also called a Node Manager that tracks the status and location of all Storage Nodes (or Source Nodes) associated with the system; and (4) a financial database to monitor transactions for billing purposes.

When a patient undergoes a procedure that produces a DICOM medical image file, the storage node at the originator securely forwards a copy of the DICOM PHI to the Central Index. Moreover, the image data devoid of its PHI information but accompanied by an encrypted identification key, is preemptively and securely transmitted from the originator's storage node to an authorized receiver's network node.

A non-preemptive, but rather subsequent, properly-authorized request identifying the patient and images can also cause the same non-PHI image data transmission to occur. At the receiver's network node, a properly-authorized user can view the image data and, using the encrypted identification key, dynamically download and append the respective PHI to the anonymous image data to effectively recompose the original DICOM image file.

The PHI directory, or Central Index, keeps track of the locations of all copies of the original DICOM files. The Node Manager oversees inter-nodal peer-to-peer communication and monitors the status of each node, including whether currently online. Thus, in the case of multiple copies, a request to view a DICOM study will be routed from the closest available Storage Node containing the file. Images move on the network without identifying information and identifiers move without any associated images; only an authorized account holder with the proper encryption key can put the PHI and image data together, and then only on a transitory basis without the ability to save or otherwise store them.

As discussed above, this system also functions with medical records in the known HL7 format, or other records comprised of personal and non-personal information in various other formats known in the art.

A subsidiary feature of the system is a “chain of trust” in which certain classes of authorized viewers (e.g., a treating physician) may pass on electronic authorization to another viewer (e.g., a consulting specialist) who is also in the accounts database. The owner of the information, the patient, may log on and observe all pointers to his or her data and the chain(s) of trust associated with his PHI and may activate or revoke trust authority with respect to any of them.

The following detailed description of the figures graphically illustrates the interrelationship of elements in the system. A technical architecture design of the system is also described in detail.

Before proceeding to a description of the figures, some preliminary matters will be addressed. The term “Central Server” or “Central Network” will be used to designate the servers on which the central functions of the disclosed couriering system and method will be maintained. The Central Server may comprise one or more servers. For example, the Central Server may be comprised of a website server, a storage server, a security server, a system administration server, a node manager and one or more application servers. In another embodiment, the Central Server may be comprised of a set of managers, including but not limited to a header manager, an audit manager, a security manager, a node manager, a database manager, and a website manager.

Also, the Central Server or Central Network comprises at least a database of user accounts, also referred to herein as the credential store and a PHI directory or Central Index that holds all the information on what patients and their records are in the couriering system. Thus, the Central Index is comprised of pointers to the distributed locations of all copies of all PHIs in the system.

The Record Producer, also called the Image Producer, is the entity, such as the imaging center, hospital, doctor or other entity, that creates the record or image and has the original electronic record stored on its server. Image Producers also include PACS machines or Picture Archiving Communication Systems. PACS is an existing technology that allows medical images to be shared digitally within a group or by Internet.

The disclosed courier system and method is substantially different than PACS. PACS depend on a Virtual Private Network (VPN) solution to electronic records access. However, VPN solutions do not solve the problems with electronic couriering of records that the present system and method solve. For example, VPN infrastructure is exponentially more costly than the present system and method. VPN does not have the same user management and point-to-point access control as the present system and method. VPN does not have secure connection in which to transmit user credentials.

Further, unlike PACS, the present system and method does not have to manage multiple user logins for separate facilities. Rather, each Record Consumer has a single user login that works at all facilities, including home, office or mobile units. Finally, according to the present system and method, the authentication of Record Consumers is based on industry-wide standards and credentials that are consistent across the system, rather than the particular requirements of a facility, such as association with a hospital or clinic.

The Record Producer component of the system is set up as a Source Node, also referred to in some embodiments as a Storage Note or Local Storage Node (LSN), on the Peer-to-Peer Network, the primary responsibility of which is to supply records to the system. The record remains on the Record Producer's Storage Node or Local Storage Node until it is requested or the requesting party (usually the Record Consumer) is identified and the study is pushed to the Record Consumer's Target Node, also referred to as a Network Node. As will be discussed in greater detail below, there is a technical distinction between Target or Network Nodes (or P2P Network Nodes) and Source Nodes or Storage Nodes or LSNs, in that Source Nodes hold original records comprising both headers and a Body, while Target Nodes are nodes that do not store any original records. Some entities may have Nodes that function as both Source Nodes and Target Nodes if the entity is both a Record Producer and Record Consumer.

The Record Harvester, also referred to herein as the Harvester or Image Harvester, is defined as the primary method for getting records from the Record Producers into the Central Index. The Record Harvester tags each record, for example a DICOM file, with a Harvester Tag. The Harvester Tag allows each record to be linked back up with the associated header (personal information) once the file has been moved to the Record Consumer's server for viewing.

The Harvester Tag may be complementary unique identifiers, complementary hashes or watermarks. Watermarking is a process whereby irreversible, and often invisible-to-the-human eye, changes are made to an image file. This is essentially a process of embedding a key within an image. These visible or invisible image file alterations can be detected by software applications and used to confirm the authenticity and origin of an image. Such information can be used as a key to bind an image to its original personal information.

The Record Consumers, also called Image Consumers, are the recipients of the records stored on the Record Producer's Source Node. In one embodiment, Record Consumers include, but are not limited to, doctors, their proxies, hospital staff, patients, insurance companies, and administrators. The Record Consumer's server normally has Client Application software loaded on it. Client Application software is also referred to herein as the User Application or Client Viewer. The Client Application software allows the Record Consumers to view their records or their patients' records. For example, records can be viewed, forwarded and requested by a physician using the Client Application. The viewing of the record, as facilitated by the Client Application, includes the security of managing the PHI as well as security and role authentication.

Therefore, according to one embodiment, records are stored in two locations: (1) the Record Producer's computer; and (2) the Source Node. The body is stored on the Record Consumer's computer but the header is stored only on the Source Node and at the Central Network. The header is never stored on the record consumer's system. The record producer also maintains a record consumer list.

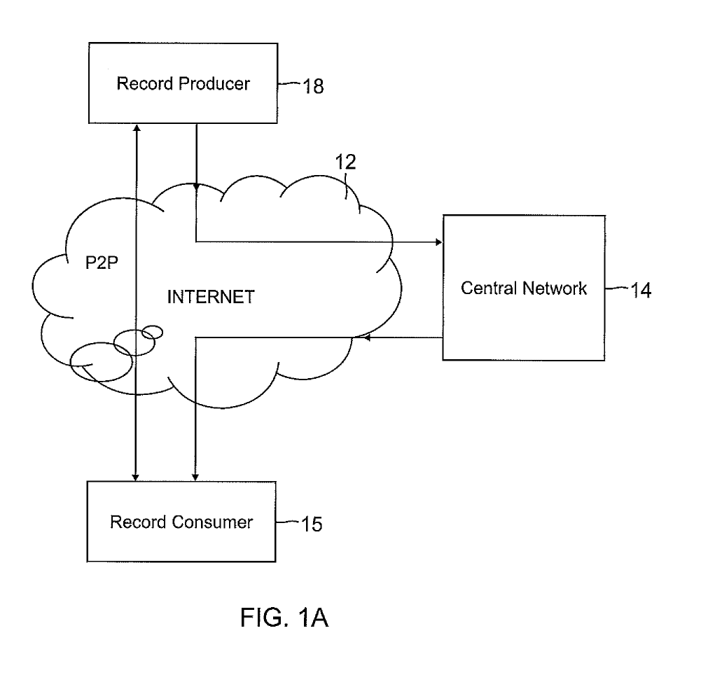

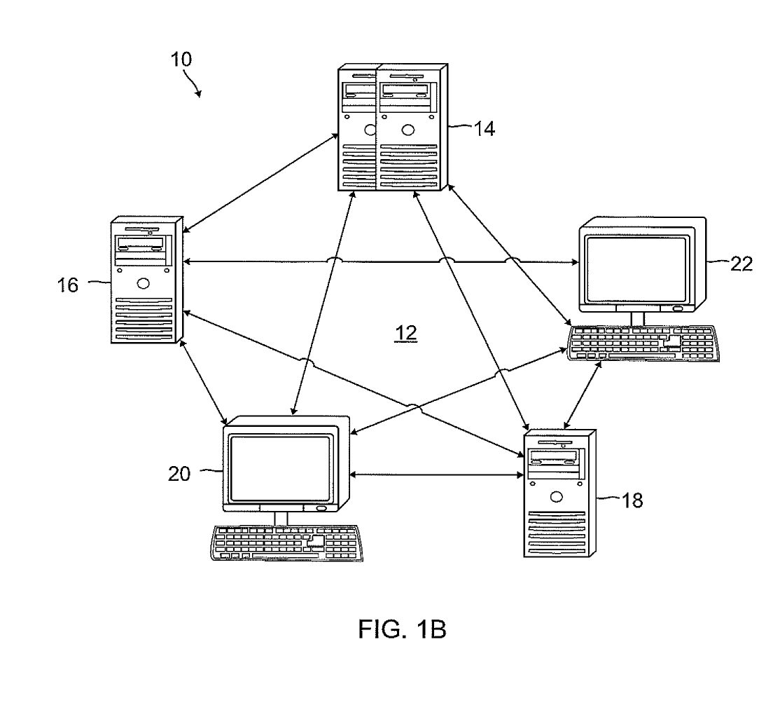

As shown in FIG. 1A, the Peer-to-Peer Network and the Central Network 14 are accessed through the Internet or World Wide Web, in some instances as a web site. Additionally, while it is recognized that there is a technological distinction between Internet and World Wide Web, the terms are seemingly interchangeable and used as such throughout this description. The use of these terms in this fashion is for descriptive convenience only. The skilled artisan will appreciate that the system encompasses the technological context of both the Internet and the World Wide Web.

The Peer-to-Peer Network controls the flow of records across the system and ensures that the records are only transmitted to valid Record Consumers. The endpoints of the Peer-to-Peer Network comprise nodes that can be Record Producer Nodes 18, Record Consumer Nodes 15, or both, and are also referred to herein as Peer-to-Peer Nodes or P2P Nodes.

Finally, the security features of the disclosed system and method may include three separate levels of security to maintain a secure end-to-end system. The first level is User Authentication. Use Authentication employs various techniques known in the art to authenticate various end users of the system, such as Record Consumers.

The second level of security is Nodal Validation. Nodal Validation is the process of identifying unique nodes to the disclosed system. As is disclosed herein, there are different types of nodes that will be available on the system, such as Target or Peer-to-Peer Nodes, Source or Local Storage Nodes (including LSNs that are part of the Edge Server) and Virtual Local Storage Nodes. Each node type will require a unique identification and validation process.

Third, as discussed above, the system will transfer various types of data over its network in different functional scenarios. As noted above, the data typically falls into two categories, PHI or private data that must be encrypted and body data that is not sensitive or private by itself and may be left unencrypted over the wire. However, the present disclosure envisions that even body data may be encrypted if so desired.

One particular application and embodiment of the present system and method links facilities that produce and consume medical images in DICOM format. The disclosed system, including a peer-to-peer network, enables the linking of imaging centers and physicians' offices to reduce the costs of moving medical imaging files from location to location via mail and courier services. As noted above, the system addresses the concerns of HIPAA guidelines to maintain all private patient information during transit and storage, and only allow visibility to this information by the appropriate people who are giving care to the patient.

In the particular application, the system takes images from imagining centers and hospitals as input into the system and makes those available to the appropriate physician or healthcare provider at the time of visit to consult with the patient. This system eliminates the need for the imaging film to be sent to the physician's office or to have the patient carry the film with him once a study has been completed.

The disclosed system and method is based on the peer-to-peer network concept where clients, attached to the network, are able to communicate among themselves and transfer DICOM files without having to store these files at a central location. The movement of files across this network is managed by a central index and node manager which ensure that the files are transported to the proper locations and provides the security for the network.

In order to meet HIPAA regulations while working with PHI, the treatment of the DICOM files and their private information is monitored carefully across the network and always transmitted in a secure fashion using industry standards such as Secure Sockets Layer (SSL) and Public Key Infrastructure (PKI). Security is also paramount when transmitting files to a desktop of a physician so he can view them without waiting for a download to complete. At this point, no private information is stored with the DICOM file. Only with direct privilege of a physician login can the private healthcare information for a patient be viewed together with the medical image or study.

When the patient's information (PHI) is requested, it is always transferred in a secure fashion and promptly and completely deleted when it is no longer needed. Furthermore, this information is never written to a local file or stored in any way outside the secure boundaries of the Central Server.

Finally, the system is able to track and audit the movement and viewing of DICOM files across the network. The tracking mechanism allows patients to see where their files are going as well as who has viewed them. A patient can also control access to his studies to prevent or enable a physician to gain access to them.

FIG. 1B illustrates one embodiment of a system 10 for couriering according to the present disclosure. System 10 includes a peer-to-peer network connecting a Central Server 14 with several other servers, including a storage server and a network (P2P) server. The Central Server 14 is any type of computer server capable of supporting a web site and web-based management tool. The operating system used to run Central Server 14 and programming used in implementing the method of one embodiment are stored in unillustrated memory resident with Central Server 14. The operating system and stored programming used in implementing the method of one embodiment can be any operating system or programming language. According to this embodiment of the application, the other servers may include, but are not limited to, hospital server 16, record producer server 18, doctor's office server 20 and home server 22. It is important to note that according to the present disclosure, hospital server 16, doctor's office server 20 and home server 22 are collectively referred to as record consumers.

As shown in FIG. 1B, servers on the P2P network communicate via electronic communication, for example via the Internet or other secured data transfer mechanism. However, it is envisioned that the preferred method will be Internet communication using standard, generally-known data exchange techniques such as the TCP/IP protocol.

The various hardware and software components of system 10 communicate, in one embodiment, via the Internet 12, to implement the method of the present application. Although not depicted, Internet 12 accesses by nodes could be implemented via an Internet Service Provider (ISP), a direct dial-up modem connection, a digital subscriber link (DSL), a dedicated T-1 connection, a wireless local area network connection (WLAN), a cellular signal or satellite relay, or any other communication link.

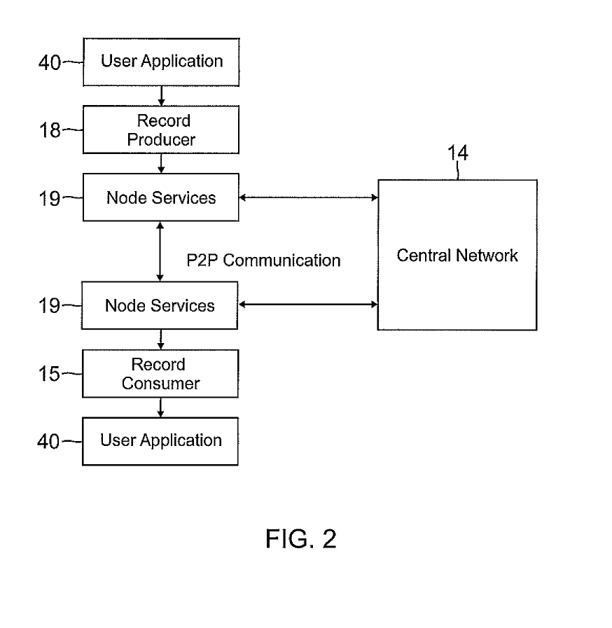

FIG. 2 illustrates the general flow of information across the disclosed system. User application 40 is installed on Record Producer 18 and Record Consumer 15 computers, which facilitate end user communication and information flow through the node services 19 in each node, e.g., Target and Source, to other nodes via P2P communication, and to and from the Central Network 14.

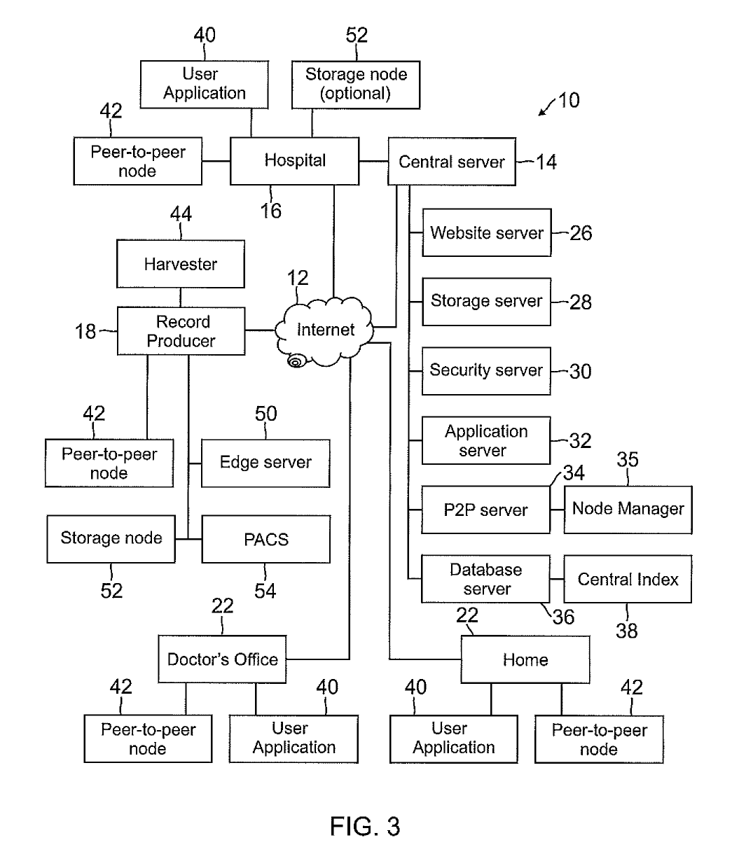

One embodiment of the disclosed system is shown in more detail in FIG. 3. In this embodiment, central network or central server 14 comprises one or more main server types, including website server 26, storage server 28, security server 30, application server 32, P2P server 34, and database server 36. Website server 26 hosts both the main website for patients as well as the web service layer that supports the P2P network for the viewing application, discussed below. These web services are secured both from SSL as well as session ID tokens that change over a given period of time. Website server 26 can be any suitable machine known in the art running any suitable software. For example, website server 26 is a Windows 2003 server running IIS 6.0.

As noted above, website server 26 provides web service via one or more web sites stored in un-illustrated memory, with the web site including one or more web pages. More specifically, the web pages are formatted and developed using Hyper Text Markup Language (HTML) code. As known in the art, an HTML web page includes both “content” and “markup” portions. The content portion is information that describes a web page's text or other information for display or playback on a computer or other personal electronic device via a display screen, audio device, DVD device or other multimedia device.

The markup portion is information that describes the web page's behavioral characteristics, including how the content is to be displayed (e.g., the frame set) and how other information can be accessed (e.g., hyperlinks). It is appreciated that other languages, such as SMGL (“Standard Generalized Markup Language”), XML (“Extensible Markup Language”) DHMTL (“Dynamic Hyper Text Markup Language”), Java, Flash, Quick Time, or any other language for implementing web pages could be used.

Central Server 14 also includes database server 36. Database server 36 may run any suitable software, for example SQL2000 or SQL2005. Database server 36 comprises the Central Index 38 and thus is the main repository for patient information (PHI) and the location of related records on the system. Because the actual Body of the records is located on the Local Storage Nodes and not sent to the Central Server 14, the size of the database is relatively small.

Because a large amount of information is captured during the auditing of each transfer and record action, it is recommended that the system have some type of archiving of this audit information in order to maintain a high performance transactional system for the movement of records.

Finally, the P2P network server 34 is designated to manage the P2P network and the authorization to transfer files between different nodes on the network. The P2P network server 34 can run any suitable operating system and software; for example, the P2P network server 34 is a Windows 2003 server running 6.0 for web services. The P2P network server 34 also runs the node manager 35.

As noted above, the nodes on the network are comprised of two types: Storage Nodes for Record Producers and Network (P2P) Nodes for Record Consumers. According to the image embodiment of the present disclosure, producers are primarily imaging centers and consumers are mainly doctors' offices. However, hospitals, for example, may be hybrids and have a node that functions both as a source or storage node and as a target or network node, in that a hospital is likely to be both an image producer (performs an MRI) and an image consumer (retrieves an x-ray of a patient).

The computer or device used by the Record Producers 18 and Record Consumers (hospital 16, doctor's office 20, or home 22) in communicating with the Central Server 14 are any type of computing device capable of accessing the Central Server 14 through a host web site via the Internet 12, and capable of displaying the website server 26's stored web pages using well-known web browser software packages, or any other web browser software. Such computing devices or other electronic devices include, but are not limited to, personal computers (PCs), both IBM-compatible and Macintosh; hand-held computing devices (e.g., PDAs), cellular telephone devices and web-based telephone sets (e.g., “Web-TV”), collectively referred to herein as Nodes.

The Nodes are responsible for all file transfers across the system and are controlled by the Node Manager 35 in the Central Server 14. Each record transfer is initiated by the Node Manager 35 and is validated once complete. This ensures that studies are only transferred to validated nodes and provides accurate detail for purposes of auditing and billing, discussed in detail below.

The Nodes are also the gateway for viewing the Client Application (user application) 40 and the Harvester 44 to communicate with the Central Server 14. By having this one point for communication with all Nodes, the system maintains tighter security and ensures that all communications are monitored and audited correctly.

When a record is transferred from one node to another, the Node Manager 35 is the controller of these records. Even though the traffic of the file does not travel through the Node Manager 35 or Central Server 14, all management and authorization to move files is controlled and logged at this level.

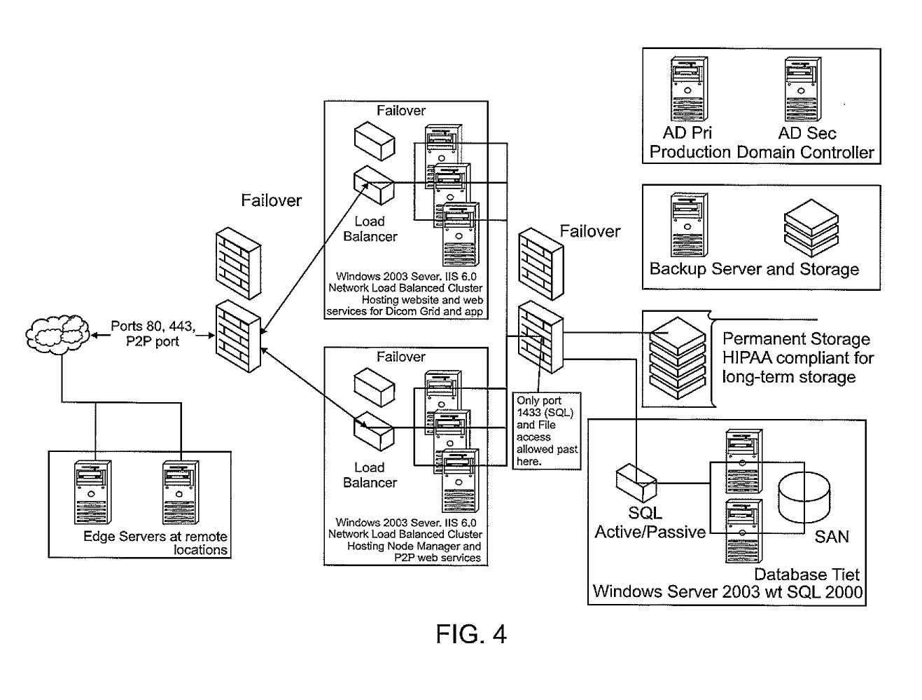

FIG. 4 illustrates the production environment of the disclosed system in detail. The production environment shown in FIG. 4 portrays the hardware and setup needed to support the transaction level and user level of the disclosed system and associated applications. The primary advantages of this environment shown in FIG. 3 are reliability, redundancy, scalability and security.

As shown in FIG. 4, each single piece of hardware has a failover device in case of hardware failure. To allow for scalability and performance, clusters of three or more servers are used; however it is recognized that one server is sufficient. Multiple servers allow for significant failover, as all servers would have to go down before the system would become unresponsive.

Also as shown in FIG. 4, all personal information is located behind a dual firewall which provides for the most secure storage. The application, web and node servers all access this data through a secure transaction zone (DMZ). No private data is ever stored in the secure transaction zone, as this is the only method for accessing the data. In the secure data area, the domain controllers will provide the needed security for backups and SQL and possibly control access to the fixed storage.

In order to store records as permanent records for either image producers or patients, there is a HIPAA-compliant storage system that allows for Write Only, Read Many (WORM) disks. These disks ensure that records are not modified once they are stored and provide a method for HIPAA-compliant long-term storage. This storage can also be combined with a Storage Area Network (SAN) solution to provide a central area for all system storage.

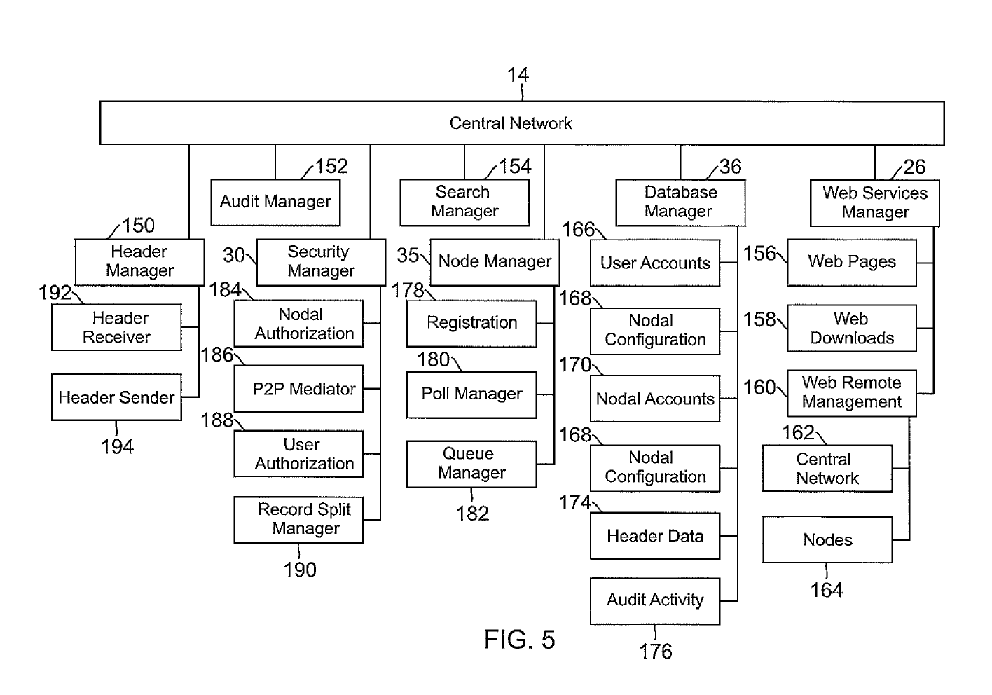

FIG. 5 illustrates an alternate embodiment of Central Network 14. In FIG. 5, Central Network 14 is comprised of several managers, rather than servers. Central Network 14 may include, but is not limited to, web services manager 26, database manager 36 (similar to FIG. 3 database server 36), node manager 35, security manager 30 (similar to FIG. 3 security server 30), header manager 150, audit manager 152 and search manager 154.

The web services 26 component administers the web pages 156, web downloads 158 and web remote management 160. Web remote management 160 has at least two components: central network web management 162 and node web management 164.

Database manager 36 is comprised of components that manage user accounts 166, nodal accounts 170, header data 174 and audit activity 176. Both the user account component and nodal account provide for nodal configuration 168. Nodal configuration 168 provides and manages the latest configuration values for the node and transmits these to the node manager configuration, which pulls down the latest configuration values for the node and loads these onto the node's local storage of configuration data. Nodal configuration 168 could also include any updates to code in order to push out new versions or bug fixes.

Header manager 150 administers the access and storage of the header or PHI information in the database. The header, PHI or personal information is encrypted in the database to prevent any unauthorized database access from viewing the data. Header manager 150 is comprised of header retriever 192 and header sender 194. Header manager 150, including header retriever 192 and header sender 194, provides for several functions in the disclosed system. The header manager 150 only returns header information to a trusted session.

Header manager 150 encrypts the header information before loading it onto the database, and decrypts it before sending it to a calling function. In one embodiment, the encryption level is 32 bytes. The system encrypts search criteria for patient information and identifies encrypted data in the database using an encryption indicator in the tables. However, header information is never changed or deleted, and all access to the header information in the database is logged. The header sender 194 verifies the account has a trust for the header data before it is transmitted. Finally, header manager 150 manages searches from calling applications.

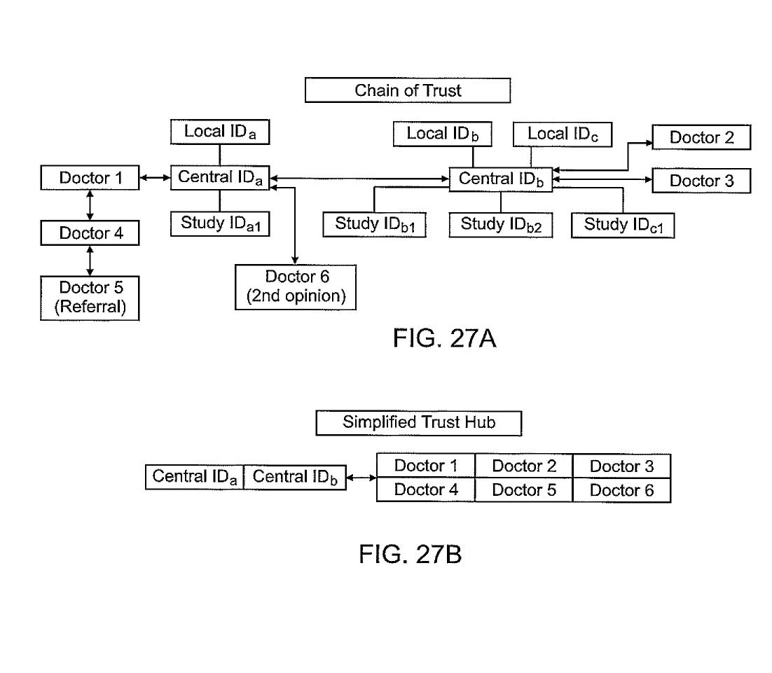

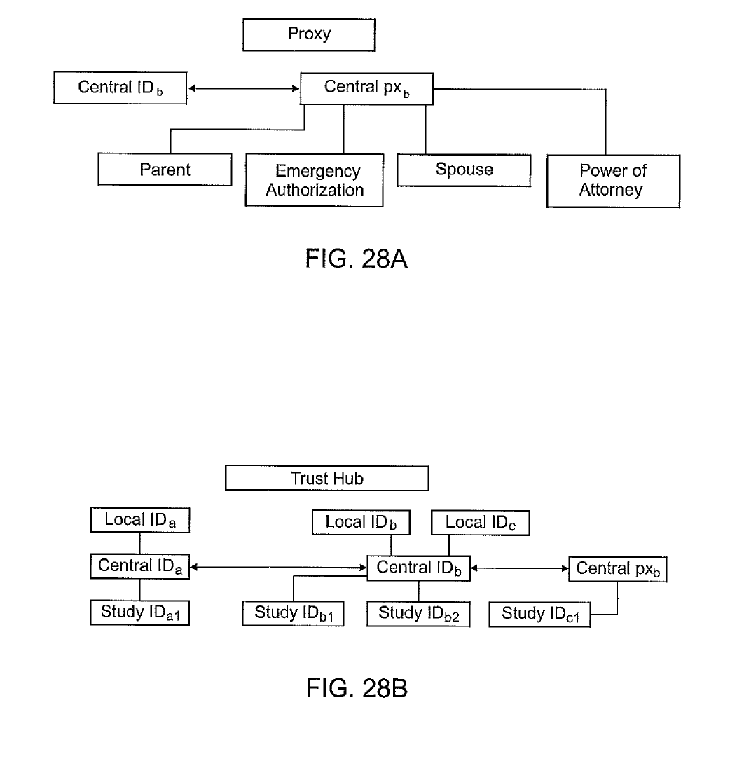

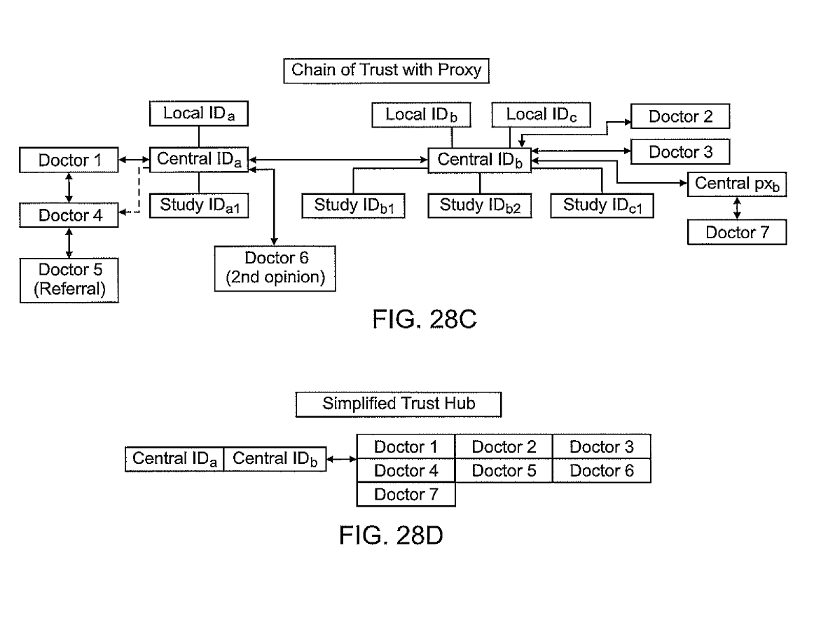

Header manager 150 interfaces with security manager 30, and in particular with user authorization 188. The interface with user authorization determines if the session identification or user has permission to receive the header data before being sent. This is accomplished in part by record split manager 190. In general, security manager 30 administers and authorizes access to the central network, the P2P network (through P2P mediator 186) and the trusts between record consumer and the record owner (e.g. physician and patient). Security manager 30 functions so that all access to the digital couriering system and the central network must have a valid session identification. Only one active session is allowed per user account. All nodes must be validated nodes to access the system through nodal authorization 184. Users are checked through user authorization 188 for trusts and permissions before information is transmitted. Nodes are authenticated when they access the central network. Security manager 30 logs messages when new trusts and proxies are created. FIGS. 27 and 28 illustrate the new trusts and proxies features in greater detail. All access is logged to the database.

Header manager 150 and security manager 30 also interface with the audit manager 152. Audit manager 152 centralizes the auditing of activity of the nodes and users on the system. Audit manager 152 is the component that logs the session identification or user and when the header identification data was accessed and/or viewed. Each record requires the session ID to record the activity. Audit manager 152 also logs the activity and transactions of the entire system, including saving the search criteria and session information to the database to track record viewing. Audit manager 152 creates a record in the database for each event that occurs on the system. Finally, all issues and errors are logged and assigned to a node or a node administrator.

Additionally, header manager 150 interfaces with search manager 154 to search the headers or personal information. Search manager 154 allows a search to be performed on a patient, physician and/or a facility. The type of search determines if the search requires header information. All header searches are passed to the header manager 150. As noted above, the header search process requires the search criteria to be encrypted before the search is performed on the encrypted information in the database. All searches are logged in the database.

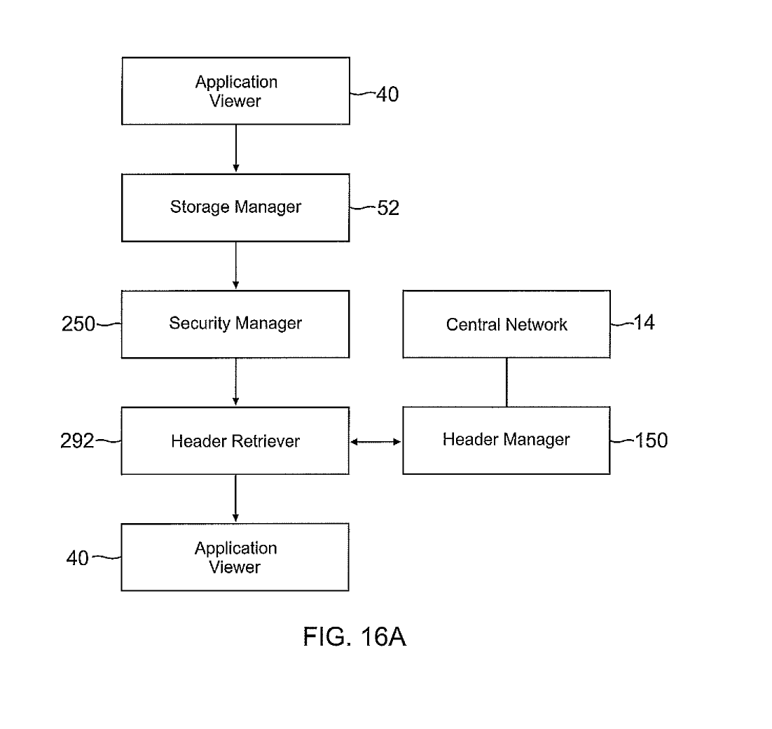

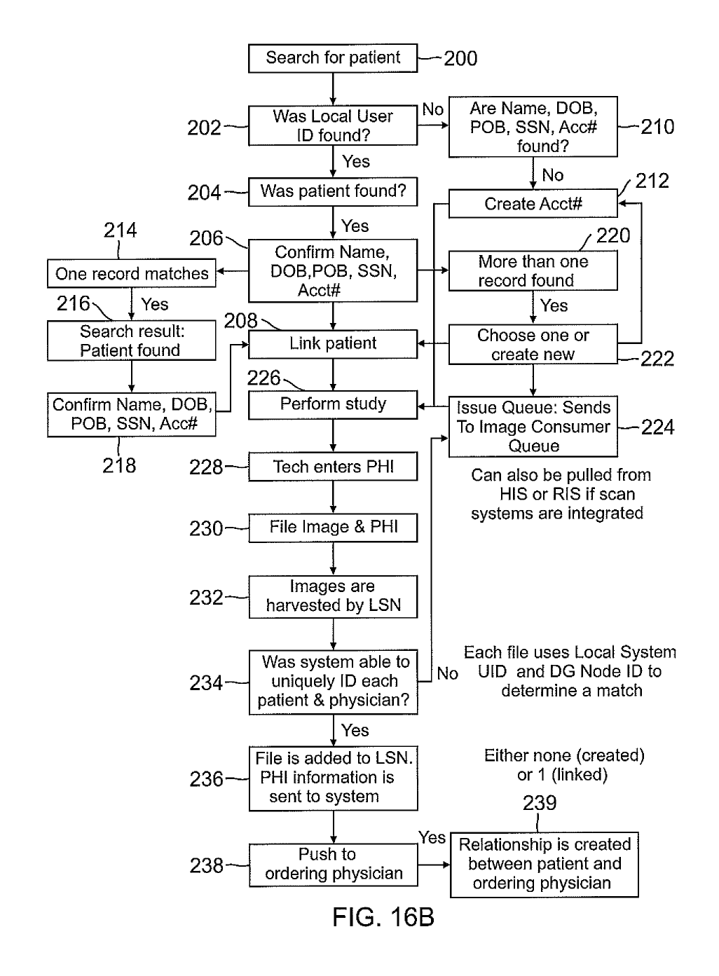

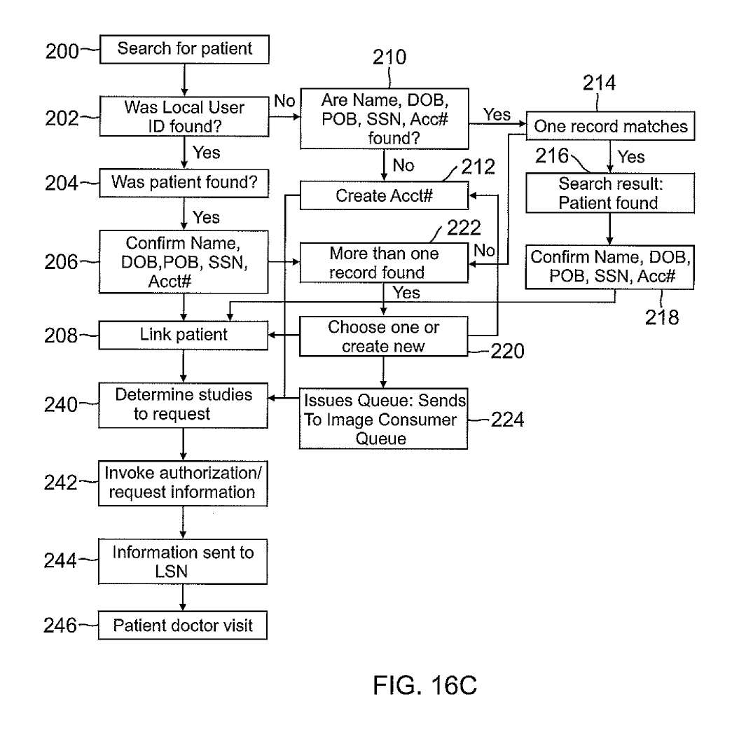

Further, the search manager 150 only searches publicly available patient information. Records that are blacked out are not included in the search. The search does not allow open searches, but rather criteria must be provided. For example, the header search may provide three different fixed criteria: (1) Central or System ID, (2) Local ID, or (3) Last Name, First Name, Date of Birth and Birth City. The patient search function allows record consumers to search for header information with which the record consumer has a trusted relationship. FIGS. 16A through 16C illustrate the search features of the present system in greater detail.

The search function may allow either the node server or the central network to be used to conduct the search for record consumers. Search results are returned in a dataset. Search columns are fixed at the database layer, but additional filters can be applied at the application server level to reduce the number of records returned. This reduces the number of indexes to maintain in the database and improve inserting new records into the tables. Search results with multiple records containing personal information will not be returned.

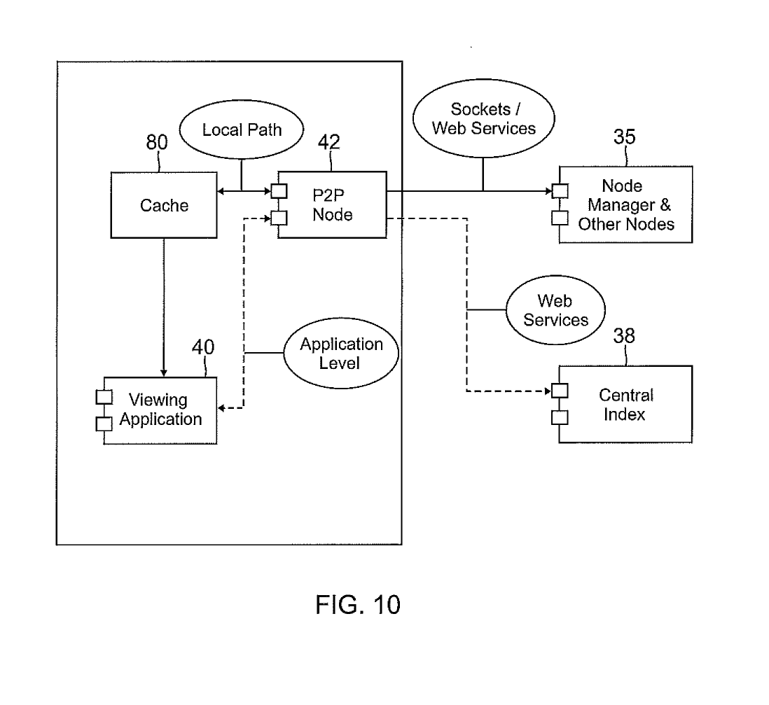

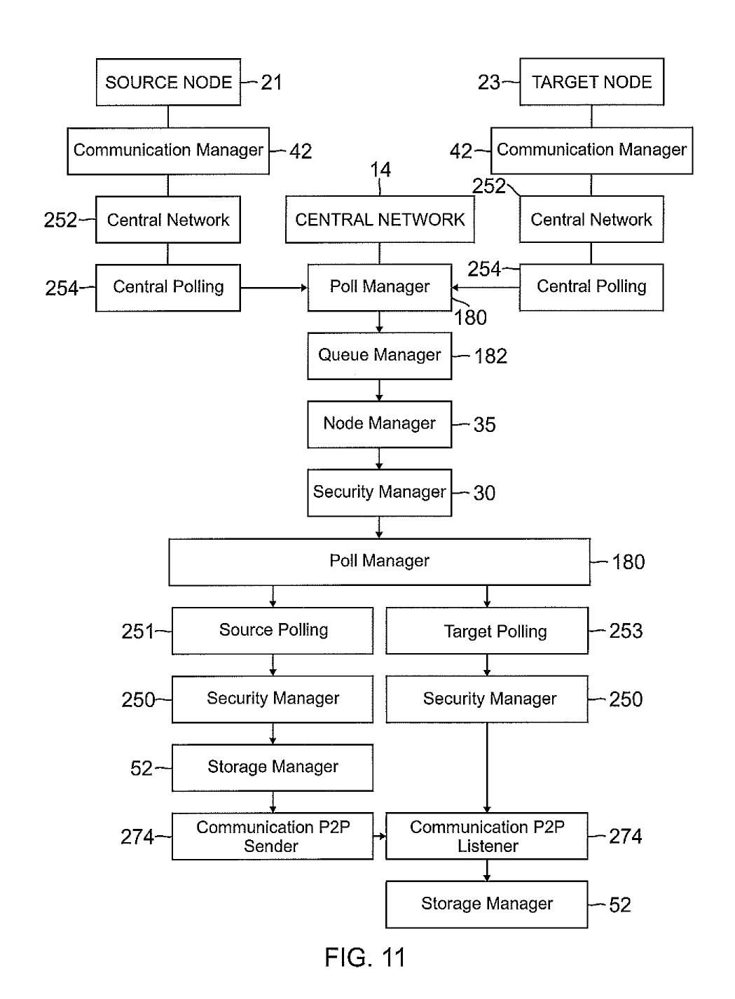

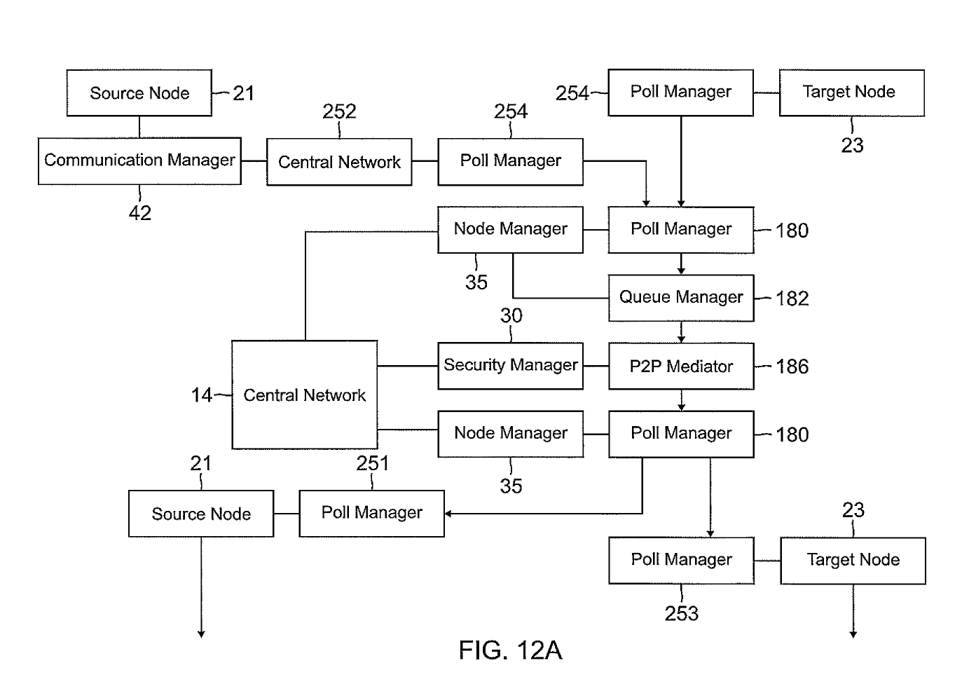

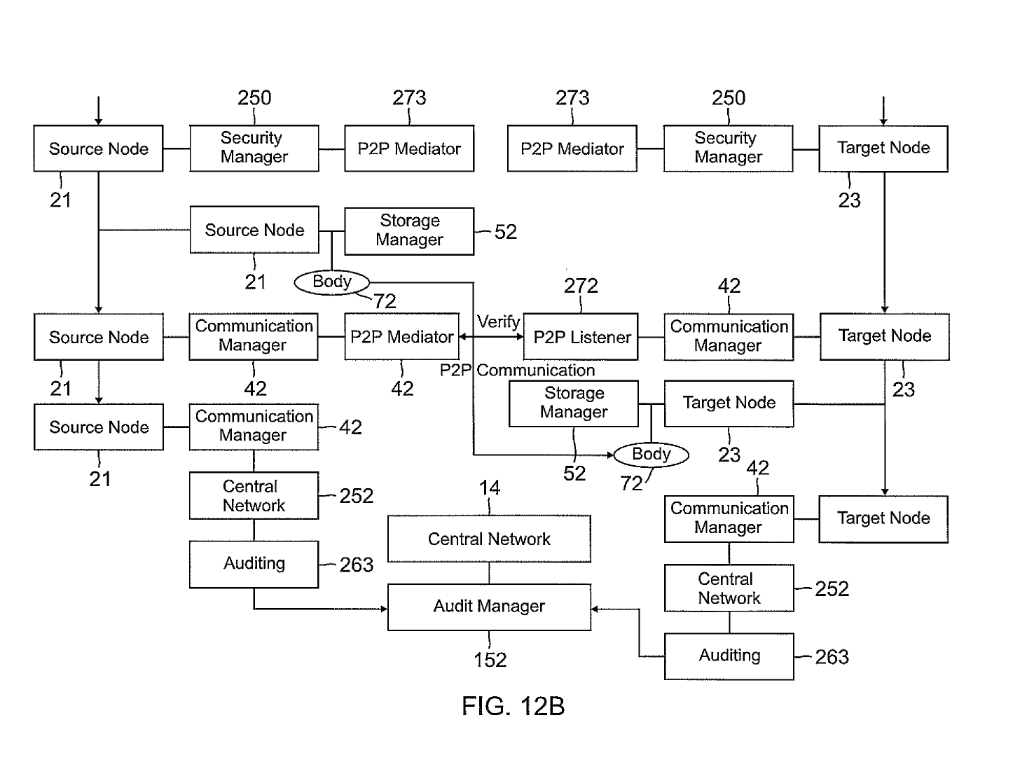

Node manager 35 manages the access of each node to the central network. Node manager 35 also administers the communication and transfer of records between a node and another node. Both are accomplished through poll manager 180 and this communication and transfer of records is illustrated in greater detail in FIGS. 11 and 12.

Queue manager 182 of node manager 35 allows studies transferred to record consumers not yet signed up or registered on the system to be queued until the record consumers are permitted access. Registration 178 handles nodal registration as described in more detail in FIGS. 11 and 12.

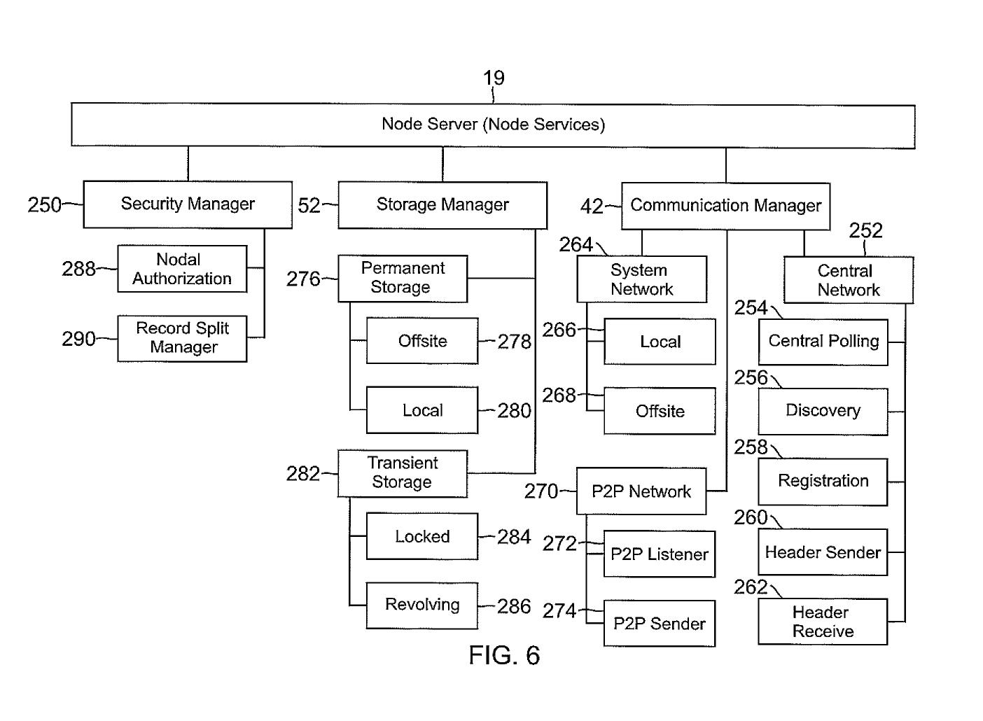

FIG. 6 illustrates an alternate embodiment of node server or node services 19 of the disclosed digital couriering system, also referred to as source and target nodes or storage and P2P nodes. According to this embodiment, the node server or node services 19 are comprised of basically two different types of nodes: a source node (alternately called a storage node or LSN) and a target node (previously referred to as the P2P node). Node server 19 is comprised of a security manager 250, storage manager 52 and communication manager 42.

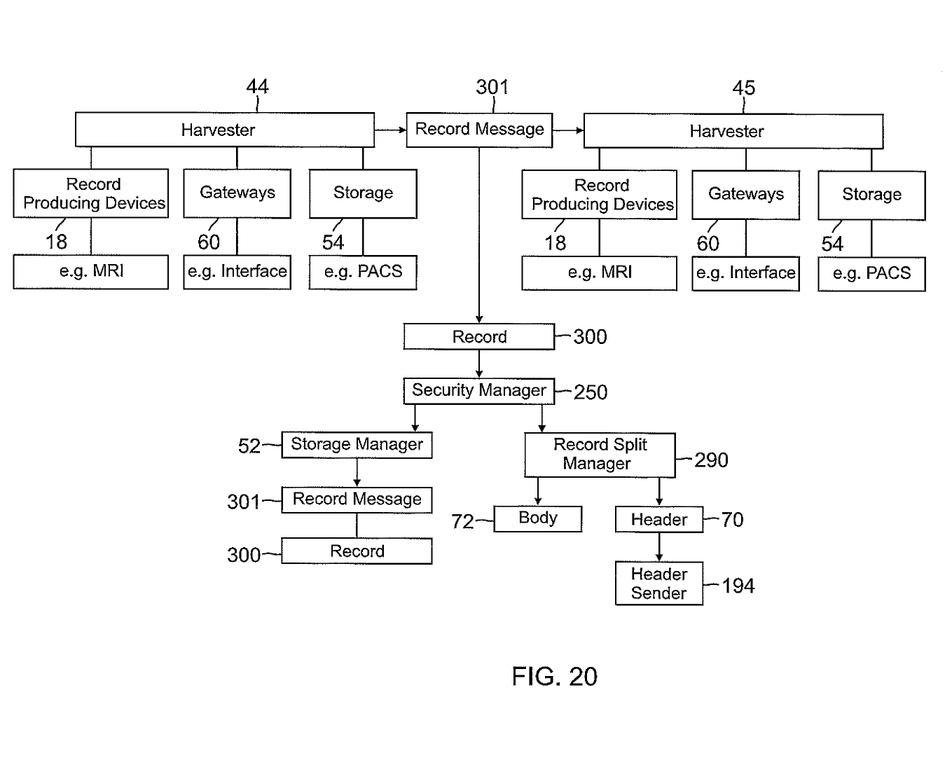

Security manager 250 is comprised of nodal authorization 288 and record split manager 290 (also called a file handler or file manager). Record split manager 290 contains the functionality to read and update records that have been received from the network or a local harvester. Record split manager 290 contains the functionality to remove and append the header information from the record and create the unique ID to track the record on the system. Record split manager 290 is described in more detail in FIG. 20.

Storage manager 52 stores and manages the records on the local nodes. Storage manager 52 synchronizes the information between the local node and the central network to keep track of the available records on the node. Storage manager 52, in conjunction with security manager 250, administers the access to the stripped records and the headers based on the current user logged into the user application. Storage manager 52, in conjunction with communication manager 42, receives new studies from the local node manager.

Storage manager 52 is comprised of permanent storage 276 that can access both offsite storage 278 and local storage 280. Storage manager 52 is also comprised of transient storage 282 which could be either locked 284 or revolving 286. Storage manager 52 will not have a defined screen to display information but the component will be able to send its statistics to another component. Storage manager 52 will be able to generate statistics on the number of studies on the node, the storage size of the studies on the node, the study transfer history and storage limits.

Communication manager 42 has three major functions: communication with the central network 252, communication with the P2P network 270 and communication with in the system network 264 in general. Communication with the system network 264 primarily coordinates whether the communication is directed locally 266 or to an offsite location 268. The communication with the central network 252 governs communication with central polling 254, which is described in more detail in FIGS. 11 and 12.

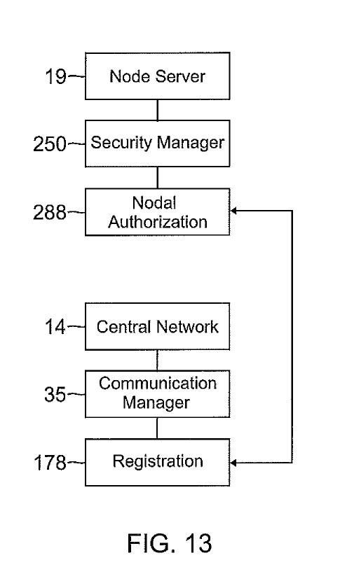

Communication manager central network 252 also includes discovery 256. Discovery 256 is responsible for initiating a node to the network and ensuring that all nodal registration 258 (also see FIG. 13) and nodal authentication 288 is performed. This is the manner with which a node lets the network know about itself and the services that it has. Discovery 256 initiates a communication with the central network. Discovery 256 authenticates the node on the network and login status and reports the connection IP address and port. Discovery 256 communicates current storage allotment and any updates to storage since the last connection, as reported by storage manager 52. Discovery 256 also initiates the header sender 260 and header receiver 262 processes.

P2P network communication manager 270 is comprised of P2P listener 272 and P2P sender 274. P2P sender 274 directly integrates with P2P listener 272 in order to transmit files from one node to another. In order to be able to send and receive multiple files at the same time, P2P sender 274 and P2P listener 272 use thread pools and create worker threads to complete the file transfer.

P2P listener 272 listens for incoming transmission to the node and accepts data into the node for processing. P2P listener 272 must be able to accept a study from any other node on the system, and must be able to process more than one request at a time. P2P listener must check to ensure the transfer is coming from a validated node and that the transfer is authorized by a trust relationship. P2P listener 272 reports and records all failed receive attempts and decompresses a file if it has been compressed.

P2P sender 274 is responsible for sending files out over the P2P network and making sure that delivery is completed and confirmed. P2P sender 274 receives instructions from the node manager to transmit a given file to a separate node. P2P sender 274 has the ability to send multiple files at the same time to different nodes on the system. P2P sender 274 verifies the file exists on storage manager 52, and locks 284 the file in transient storage 282 for transmission. P2P sender 274 is capable of compressing a record to a temporary location. P2P sender also unlocks the record on the local storage node and reports successful completion to the central network. If an error occurs during transmission, the P2P sender 274 retries, in one embodiment, three times, before reporting a transmission failure to the central network. A space of time, in one embodiment, five minutes, occurs before each retransmission attempt.

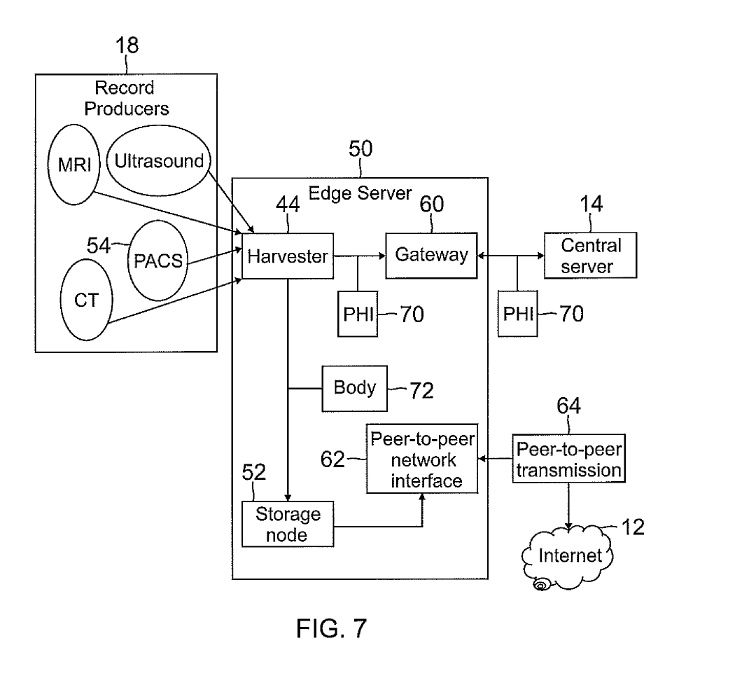

FIG. 7 illustrates the Record Producer 18 portion of the system. The Record Producer component is a node on the network whose primary responsibility is to supply records to the system, also referred to as the source node. The Record Producer 18 does not upload the entire record directly to the Central Server 14, but only sends the personal information (PHI) 70. The record remains on the record producer 18's storage node 52 until it is requested, or the requesting record consumer (physician) is identified and the body 72 of the record (the non-personal information) is pushed to the record consumer's (physician's) node. It is noted here that this pushing of the body 72 of the record to an identified record consumer, before the record is requested, is a novel feature of the disclosed system and method. Other features shown in FIG. 7 are described in further detail below.

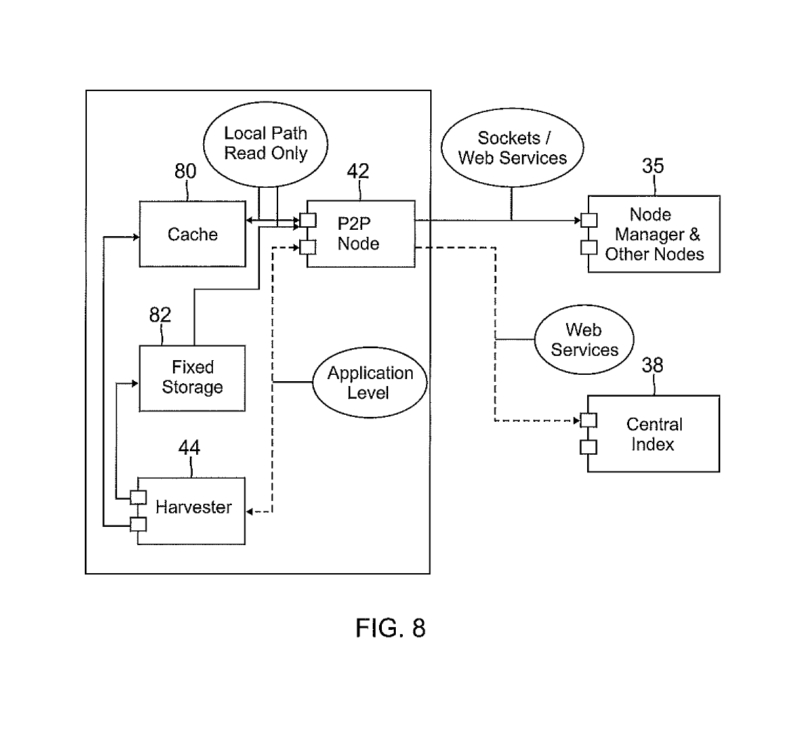

As shown in FIG. 8, the Record Producer 18 component integrates the harvesting or acquisition of records, registering of records to the Central Index 38 and pushing these records out to other nodes on the network. The Record Producer 18 has both cache storage 80 as well as fixed storage 82. The fixed storage 82 is read-only by the P2P Node 42. This means that all fixes coming in are written to the local cache 80 instead. As shown in FIG. 8, the only way for files to move to the fixed storage 82 is for the harvester 44 to put them there. Also, as shown in FIG. 8, all communication to all other nodes (the outside world) is done through the P2P network node 42. This includes both socket and web service traffic. As shown in FIG. 8, the record harvester, described below, communicates directly with each node and the Central Index through the node component.

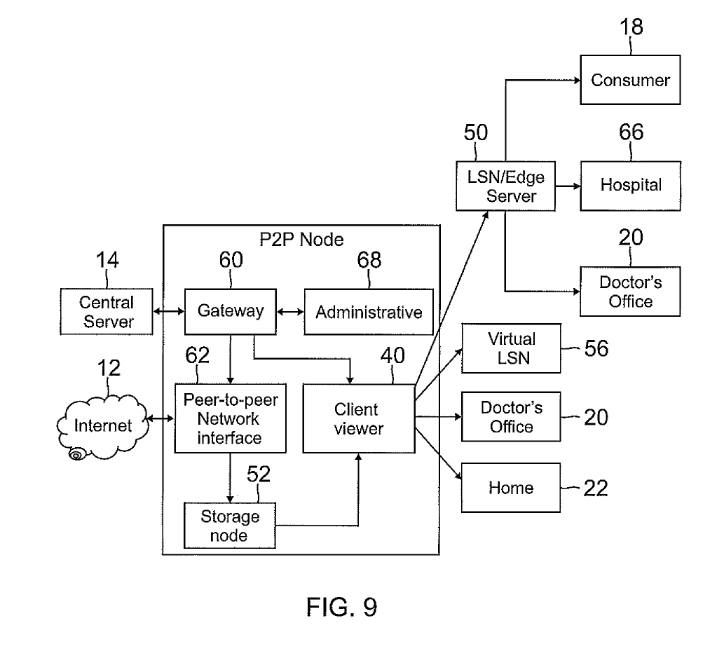

Record Consumers make up the remaining nodes on the system, which are also referred to as target nodes. As shown in FIG. 9, these nodes (P2P, network or target nodes) 42 are set up to be able to receive and send records, but they also contain the viewing software, shown as client viewer or viewing application 40, for recombining the PHI with the body of the record in order to present a complete record to the record consumer. As described in detail below, the record consumer can also search for patients and allow another record consumer to invoke his authority to request that records be sent to his node.

FIGS. 9 and 10 illustrate the functionality of the record consumer component of the system and its interaction with other components of the disclosed system. The viewing application or client viewer 40 shown in FIGS. 9 and 10 includes the node component and ensures all communication is tracked and logged.

Each peer or node that joins the network must register with the Central Server 14 before it can communicate with other nodes in the network. The node is then authenticated and the Central Server 14 monitors which nodes are connecting. According to the disclosed system, there are two modes with which nodes can connect, as a Record Consumer (Network Node) 42 or as a Record Producer 18 (with Storage Node 52).

When an organization, whether it be a doctor's office, hospital, or other record producer, becomes a “member” of the system, the facility, its physicians and staff must be added or enrolled in the system. The enrollment process for a record consumer, such as a doctor is fairly simple. In one embodiment, in order to connect as a Record Consumer, a physician ID is required to set up and begin operations. In other embodiments, other criteria would be acceptable, for example, a patient ID or system account number.

FIGS. 11 and 12A-12B illustrate alternate embodiments of the communication pathway between the central network and the nodes of the disclosed system (here, source node 21 and target node 23) and the P2P communication between nodes, including in FIG. 12B, transfer of information between the central network and the nodes and among the nodes. The following description of the components refers to all three figures in conjunction. The basis of all communication between the central network 14 and the nodes is the poll managers. The nodes have a poll manager with two aspects, central polling 254 to send communications to the central network 14's poll manager 180, and source polling 251 or target polling 253, depending on whether the node is a source node or target node, for receiving communications from the central network 14's poll manager 180.

Node manager 35 is a group of web services and socket connections that control the nodes in the network. Most functionality is managed with the node making requests to the node manager for login or configuration information. Node manager 35 relays the IP address and port number to the other nodes. Node manager 35 transfers record lists from the nodes to central network 14. Node manager 35 is responsible for determining whether there is availability to transfer a record. Node manager 35 also sends records in the queue when the recipient logs in. Transfers are queued in queue manager 182.

As shown in FIG. 12A, node manager 35 communications with the other nodes through the P2P network via the P2P mediator 186. The central network P2P mediator 186 in conjunction with the nodal P2P mediators 273, facilitate peer-to-peer network communication and manage all of the nodes that can connect to the network. The management of these nodes is what maintains the network and controls the traffic across the network. P2P mediator 186 allows node to login and authenticate to the central network using a node ID and credential key. P2P mediators 186 and 273 allow nodes to check in to let the system know that they are online and active. The central network 14 stores this information in the database.

As shown in FIG. 12B, P2P mediator 273 in conjunction with P2P listener 272 allows the transfer of a stripped record or body 72 from one node to another. The P2P mediators 186 and 273 also indicate to a source node that a record should be transferred and give the destination node ID, IP address and port. P2P mediators 186 and 273 also supply configuration information to an authenticated node and allow configuration information to be viewed from an administrative screen. Auditing function 263 tracks the transfer of these stripped records from one node to another. Also, the auditing 263 updates status based on failed attempts, successful attempts and pause/hold (retry) attempts.

FIG. 13 illustrates nodal registration and authorization on the system, according to one embodiment of the disclosure. The authorization component processes new record consumers on the system and verifies that the record consumer should be allowed access to the system. One particular embodiment of this process, described below, by way of example only, illustrates this process in greater detail.

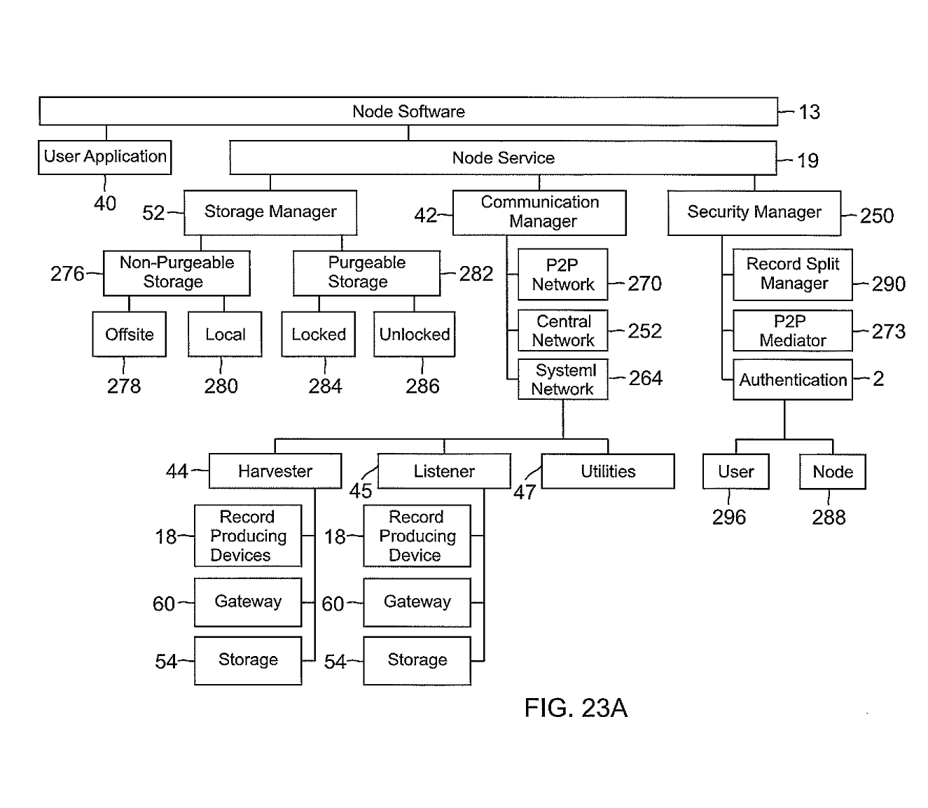

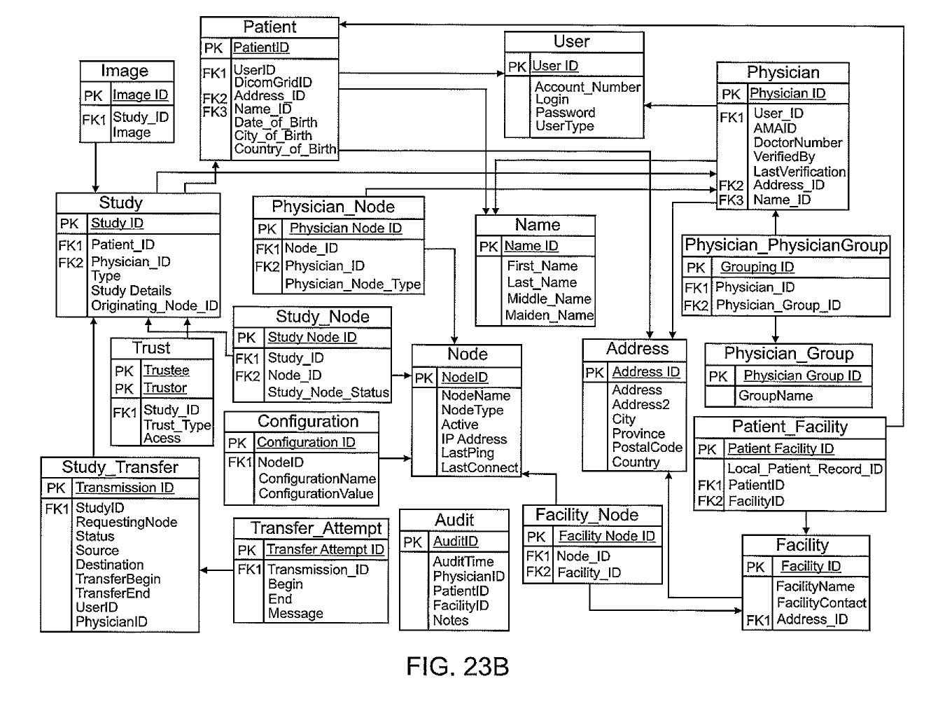

Access to the system may be tiered. For example, three tiers may exist: (1) no access, (2) tier 1 access and (3) tier 2 access. If no access is granted, the account is not permitted to gain access to the system and does not have permission to authenticate and activate a node. If Tier 1 access is granted, the record consumer can activate a node and log in to the system. However, the record consumer is only allowed to view a record that has been pushed to him preemptively. The record consumer, in Tier 1, is not allowed to request records, forward records or create a chain of trust with any other record on the system. If Tier 2 access is granted, all functions are allowed for this record consumer. The record consumer has qualified or provided the required documentation to allow for a chain of trust to be created as well as request and forward records on the system. Either Tier 1 or Tier 2 access will allow access to download the user application and node software (see FIG. 23A).

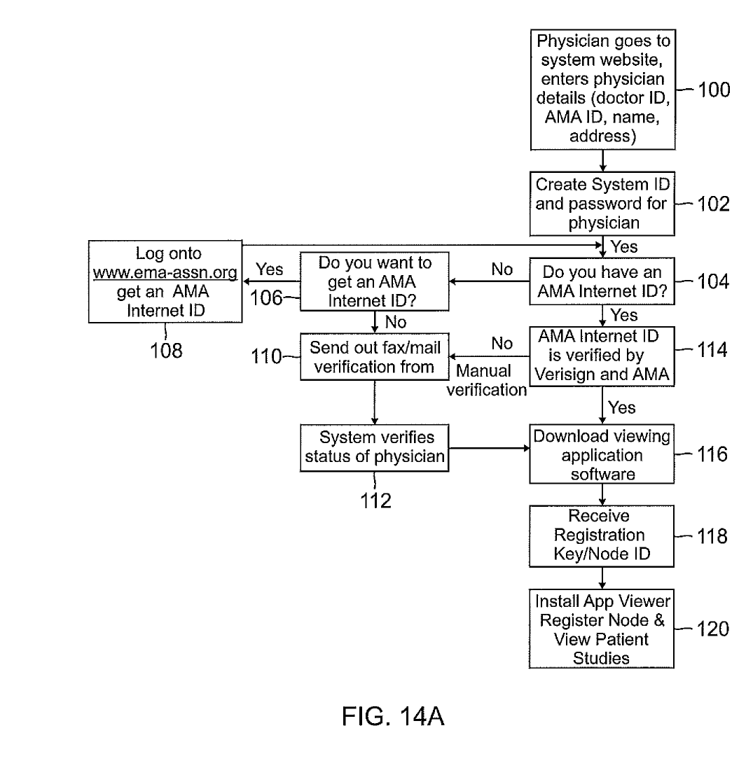

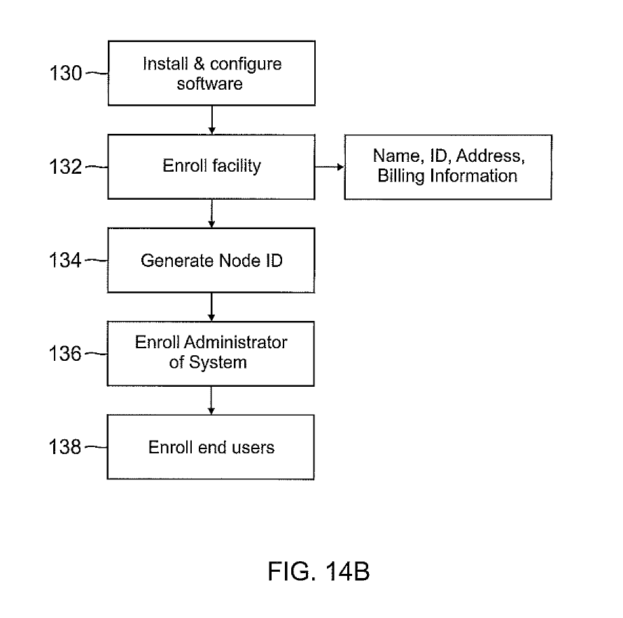

FIG. 14A is a flowchart illustrating record consumer registration on the system, according to one embodiment. By way of example only, record consumer registration is illustrated by physician enrollment on the system. According to the present disclosure, the terms doctor and physician are interchangeable. In block 100, the physician accesses the system's website and enters physician details, such as doctor ID, American Medical Association (AMA) ID, name and address, as well as any other information requested by the system.

The system then creates an ID and password for the physician in step 102. In one embodiment, in block 104, the system asks the physician if he has an AMA Internet ID. If not, in block 106, the system asks if the doctor would like to get an AMA Internet ID. If so, the physician, in block 108, is either redirected to www.ema-assn.org or is asked to log on to that website and acquire an AMA Internet ID.

If the physician does not want to obtain an AMA Internet ID, in block 110, a fax or mail verification form is sent to the physician, and based on the information on this form, verifies, in block 112, the status of the physician. However, if the physician in block 114, had or obtained an AMA Internet ID, the physician in block 116 is permitted to download the Client Application, also called the Viewing Application, software. In block 118, the physician receives a registration key and node ID, and then, in block 120, the Client Application, including, for example, the applications viewer, register node and view records software applications, are installed on the physician's server. This physician is now a network node on the system and can request and view records.

If an entire office or hospital is enrolling onto the system, the software can be loaded on each computer via a download or CD. Then an individual administrator must set up the list of valid physicians and other users. According to one embodiment, only physicians and patients have the initial ability to view the records. In order for non-physician and non-patient users of the system to view records, association between the physician and the user must be established as a proxy of the patient. (FIG. 28) Thus, in the disclosed system the explicit trust relationship between the physician and the proxy user must be defined and validated.

FIG. 14B is a flowchart illustrating record producer registration on the system, according to one embodiment. In order to connect as a Record Producer, the Central Server first needs to authorize upon connection and then set up security certificates for the entity. An entity or facility that serves as a Record Producer must assign an administrator and then add end users who will add or search for records. In block 130, the software is installed and configured. Then, in block 132, the facility is enrolled by providing requested information, including facility name, facility address, facility ID, billing information, and any other requested information.

Next, in block 134, the system automatically generates a Node ID for the facility. In block 136, an administrator is enrolled. The administrator is the individual or group of individuals responsible for configuring and maintaining the application at the Record Producer. Finally, in block 138, the end users are enrolled. The end users are the day-to-day users of the system. The administrator is asked to enter the username, password, the node ID and assign a role or access rights. All other parts of the Storage and Network Nodes function similarly as far as sending and receiving file from other nodes and are controlled through the Central Server.

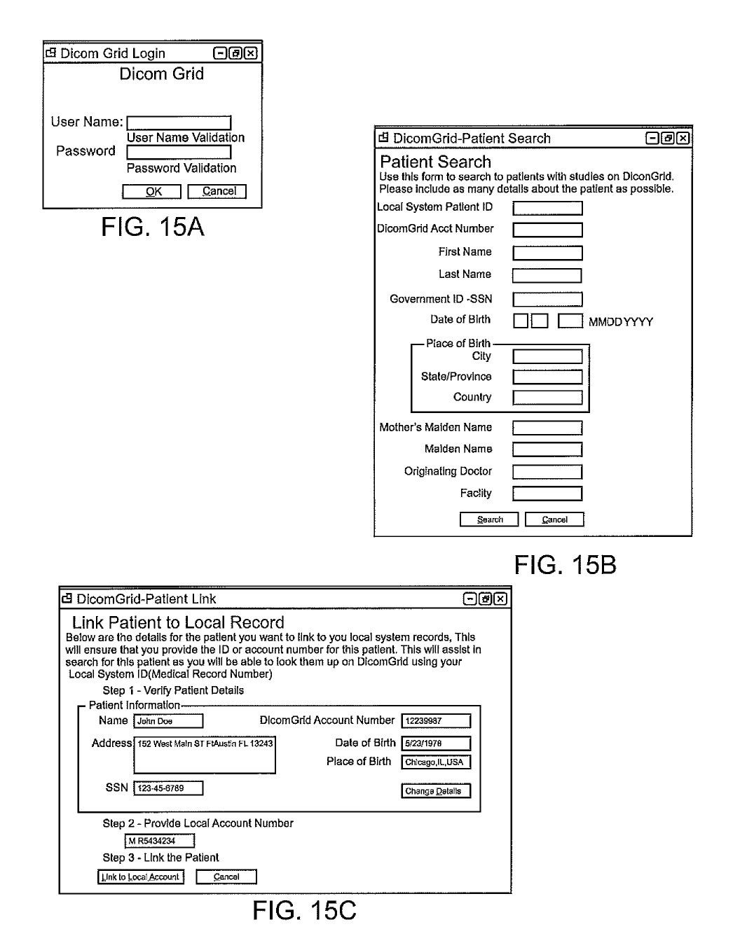

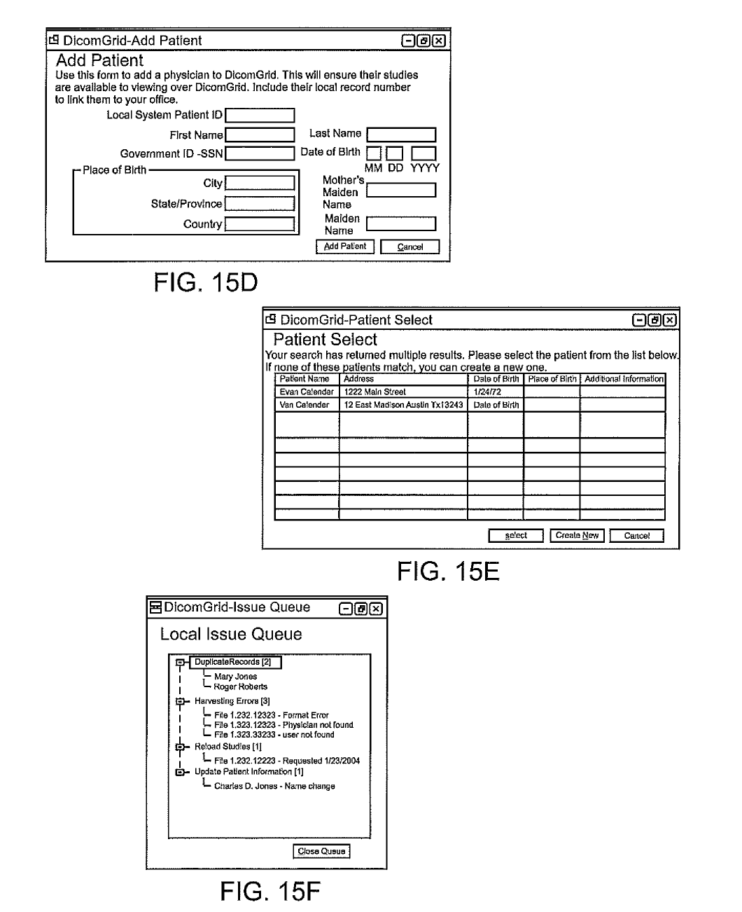

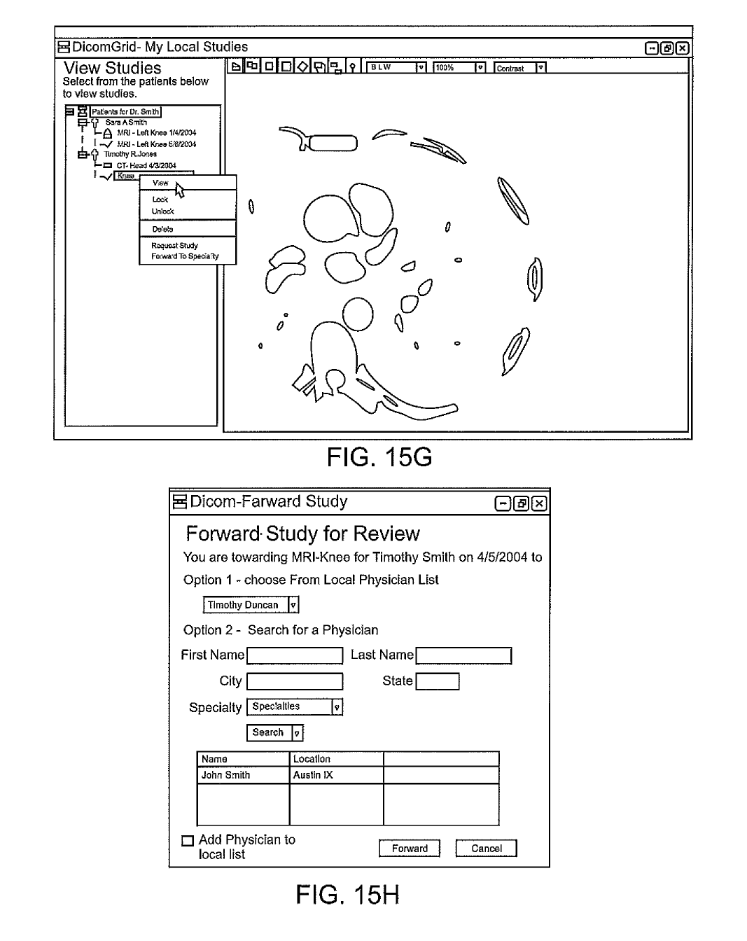

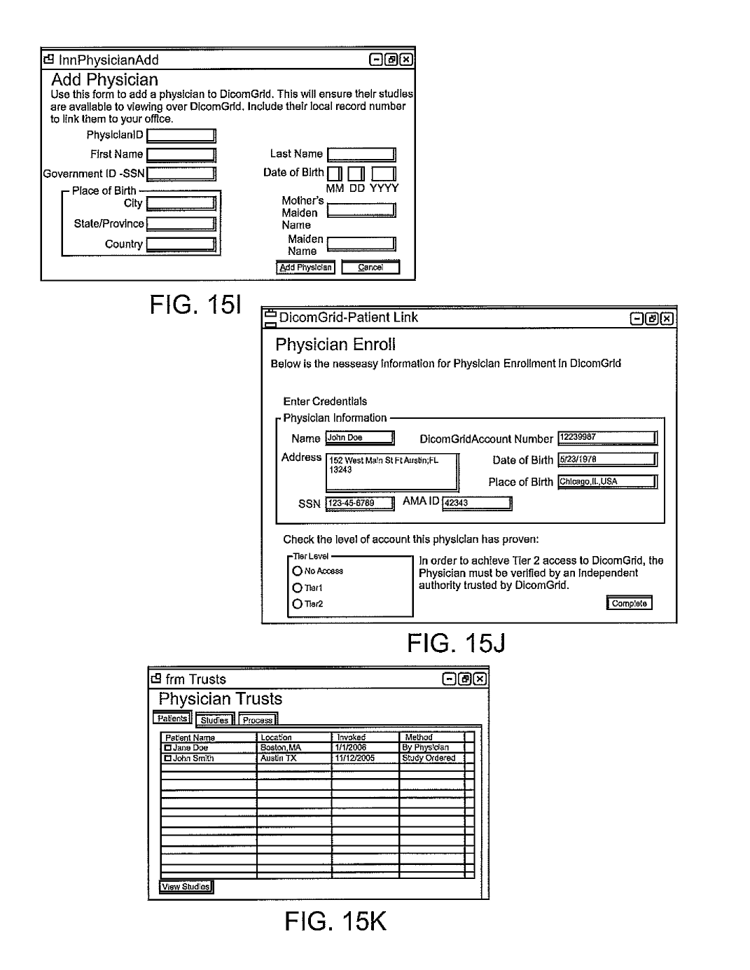

FIG. 15A is an example of the first screen the user encounters when launching the Client Application on the system from his computer. The login screen will allow a user to access the system by entering his Username and Password as shown in FIG. 15A. This login process defines the user gaining access to the system and which node or nodes he is affiliated with. Once the user is logged in, the user will have the ability to view information based upon his access rights. Once the user is logged in, the user can search for a patient to see if he is already affiliated with the system.

FIG. 16A generally illustrates the communication pathway necessary to add and search for existing record owners (e.g., patients). The user application or viewer application 40 is the component record consumers use to view the current records available to that record consumer. Viewer application 40 allows multiple records to be loaded simultaneously in the application to allow side by side and other types of comparisons.

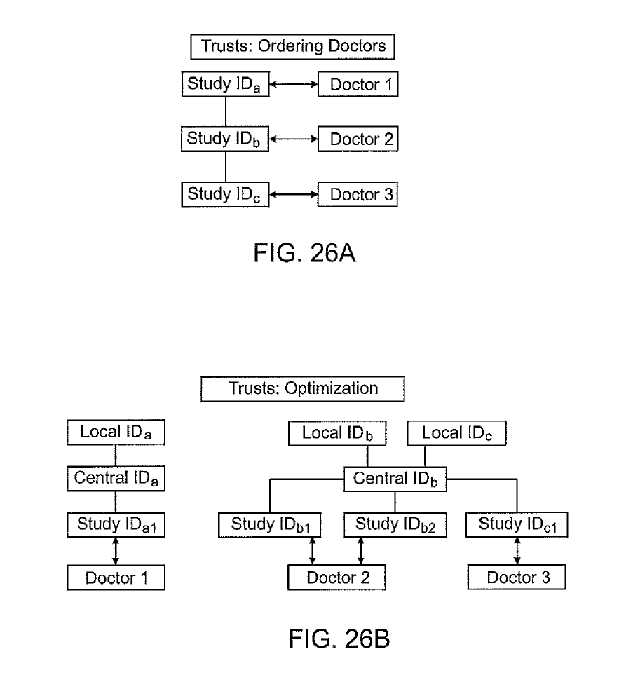

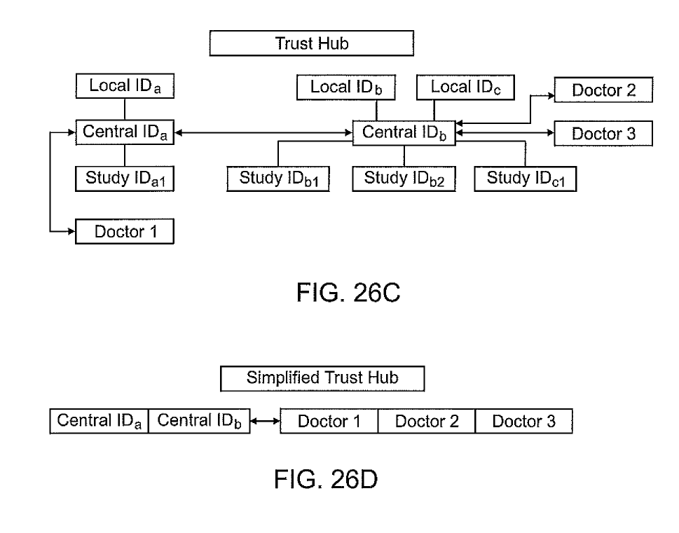

The viewer requires a user to log in before the application can be used. Multiple viewers can be open using the same or separate login credentials. The viewer will display information of records trusted to the record consumer based on the trust hub for that record consumer as shown in FIG. 15K. Only records trusted to the record consumer that are found on the target node will be displayed in the application. Record consumers can request records that do not exist on the target, if the record is included in the consumers' trust hub (FIG. 26) or if they have received a proxy (FIG. 28). Records can also be forwarded to another record consumer as shown in FIG. 27. All records viewed are logged in the central network as described above.

FIGS. 16B and 16C are flowcharts illustrating the search and record creation or viewing process for the record producer (FIG. 16B) and the record consumer (FIG. 16C). As shown in FIG. 16B, and by way of example only using the medical imaging field, when a patient comes to a record producer facility to have a record made, in this case, a medical image, the record producer search requests the patient to complete the required HIPAA release form. Once the form is received by the record producer, the record producer searches for the patient to see if he is already affiliated with the system before adding new records. Various algorithms known in the art are used to optimize and rank search results for patients. These different search paths depend in part on the amount of information supplied to the search component.

Referring now to FIGS. 16B and 16C, the search process for both the record producers and record consumers in block 200 begins by the record producer viewing a screen, such as that shown in FIG. 15B. If the patient has previously been entered into the system, the patient will have a System ID number and will already be linked to the system. Thus, only the System ID number needs to be entered into the system. If the patient has been to the facility before, the patient may have a local account number for the facility's system (Local User ID) and that is entered into the search request in block 202.

If the patient is found in block 204, then in block 206, the record consumer or record producer confirms the patient's personal information, which may include, but is not limited to, the patient's social security number, date of birth, place of birth, mother's maiden name, requesting or originating record consumer, facility name, patient's maiden name, patient's address and patient's phone number. The patient is the linked to the system in block 208. Linking of the patient to the system comprises associating a Local User ID with a System ID. An example of the screen for linking the patient to a Local User ID is shown in FIG. 15C.

If the patient does not have a system account number or Local User ID, the system then searches for the patient's personal information, which is entered into the search form shown in FIG. 15B. If the patient is not found in block 210, the patient is then added and an account created in step 212. An example of the screen for adding a patient is shown in FIG. 15D. If the search in block 210 results in a single record match, as shown in block 214, the patient's personal information, the patient is found in the system in block 216 and the patient's personal information is confirmed in block 218. The patient is then linked to the system in block 208.

If the search in block 210 yields multiple record matches, as shown in block 220, the listing of possible matching records are displayed, and the user chooses the correct patient from the list in block 222 and the patient is linked to the system in block 208. An example of the patient select screen is shown in FIG. 15D. If in block 222, none are correct, the user creates a new account in block 212. When multiple matches are generated from a search, the result is sent to the issues queue to resolve the issue of personal information generating multiple results.

The issues queue is local to a single node and includes a list of all items that cannot be resolved programmatically and require review and intervention by a person. Examples of issues sent to the issues queue include, but are not limited to, records that have the incorrect format; records where the record consumer has been deemed invalid; records where the patient cannot be linked to the system; records where the patient personal information cannot be linked to a single System ID (multiple results); records that have been requested but are not longer on the local storage cache.

FIG. 15F is an example of the local issues queue. The functionality of the issues queue is envisioned to include one queue per node for all issues. Items are automatically pushed to the issues queue if they cannot be routed to the record consumer. There are automated “wizards” to assist the end users' walkthrough and to resolve the issues. If the item is flagged for correction, the record is routed to the record producer. If the local node cannot resolve the situation, the issue can be forwarded to the Central Server for resolution.

Referring now to FIG. 16B, once the patient has been entered, selected and linked to the facility, the patient undergoes whatever examination or test or other treatment that has been requested by one or more record consumers, as shown in block 226. Once the procedure is complete, a record is created and PHI is associated with that record in block 228.

As described above, the record consists of two parts: the personal information or PHI, and the Body. The personal information may include, but is not limited to, patient name, date of birth, sex, local user ID, record consumer's name to whom the record will be pushed, place of birth, address, phone number and social security number. The record will also contain certain information about the record producer, including, but not limited to, entity name, entity address, date and time record was created, and brief description of the record.

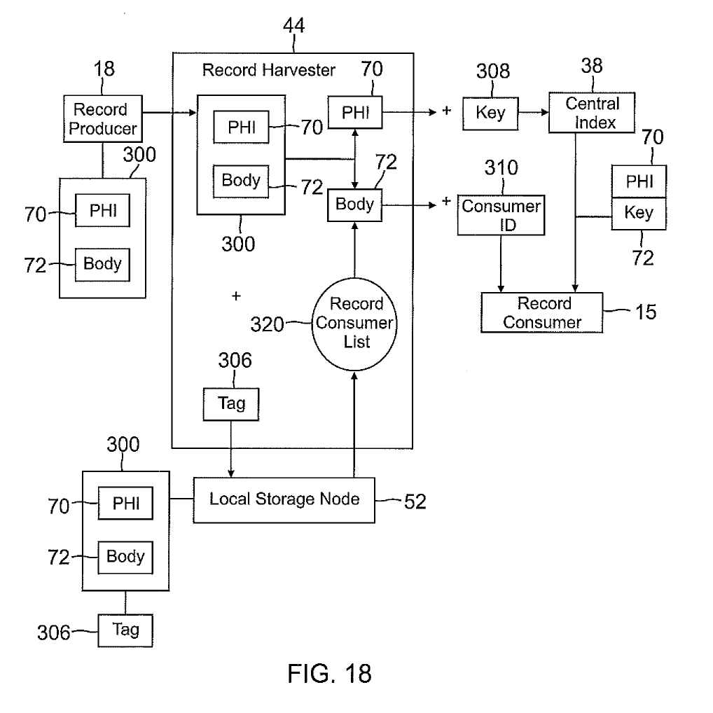

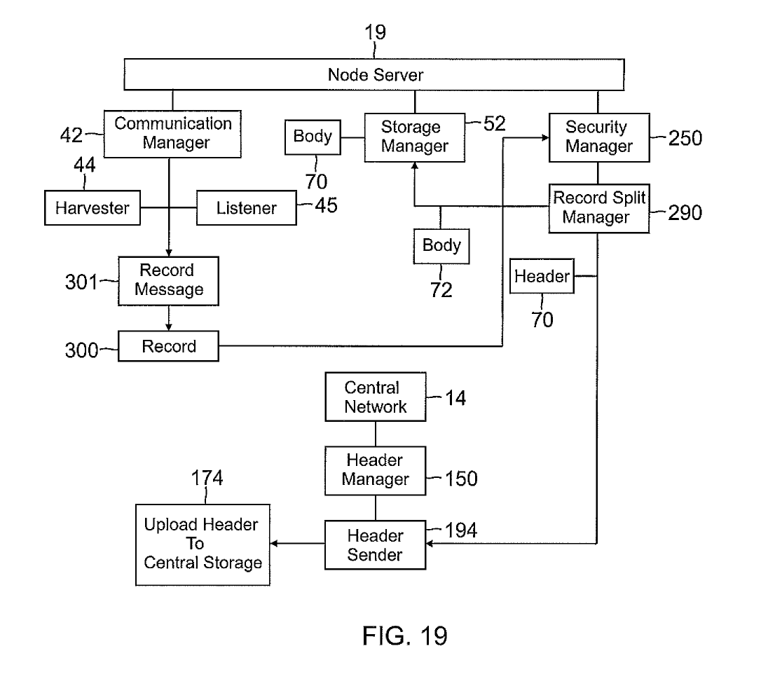

Once the record has been created, the record is filed in block 230 and may be loaded onto a PACS or other storage system and that system serves as the local storage system. In other embodiments, for example, for facilities that do not have a PACS or other storage capabilities or for facilities that do have storage capabilities, but find that storage on the facilities local system is not practical or desired, the records can be stored on the Central Server's storage node which will serve as the local storage node and maintain the record, as described above. In either case, the records are harvested from the PACS or other storage system in block 232. Block 234 through 238 are described in more detail with reference to FIG. 18.

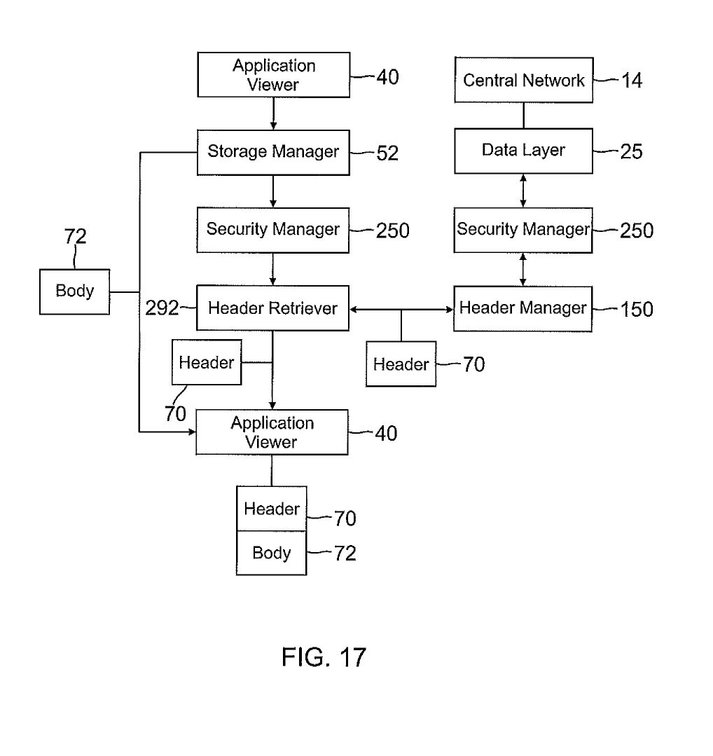

FIG. 17 is a basic illustration of how records are digitally couriered according to the present disclosure. As shown in FIG. 17, the body 72 of the record being stored in storage manager 52 is transmitted via P2P communication to the record consumer's application viewer 40. The PHI or header 70 is transferred from the header manager 150 in the central network 14 to the header retriever 292 in the target node and then transferred to the application viewer 40 of the record consumer, where the header 70 and body 72 are recombined to form a complete record.

FIG. 18 is a more detailed illustration of the digital couriering method, including the harvesting process. The harvesting process is completed at the server level. During the harvesting process, new records are identified, an encryption key is associated with the study and the PHI 70 and the record are then copied to the local storage node 52. A copy of the PHI 70 is also sent to the Central Index 38. The PHI 70 and body 72 of the record are linked using a unique identifier, referred to herein as the Tag or Harvester Tag 306. This identifier or tag is not an encryption key, but only the link between the PHI 70 and the body 72 of the record. FIG. 18 illustrates the different components of a record 300 as it is harvested, including PHI 70, body 72, Harvester Tag 306, and Encryption Key 308.

As shown in FIG. 18, when the record is created at the record producer 18, the record 300 comprises PHI 70 and a body 72. The record 300 then enters the harvesting process. The record harvester 44 adds the Tag 306 to the record before sending the record to be stored on the local storage node 52 (FIG. 16B, block 236).

The loading of records from the system can occur in a few different ways. For examples, records can be pulled from record producer's computer or from PACS or other local storage systems. Loading of records can also occur when records are restored on the system, from direct loading from a file system, either single or multiple files, or CD import of records for directly uploading to the Central Server. When records are harvested, each record is verified on the system to ensure that duplicates are not created (FIG. 16B, block 234). Each file uses the Local System ID and Node ID to determine a match. Verification here occurs both when a record is uploaded and when a record is restored on the system.

In addition to being stored on the local storage node, the record is split by the record harvester into its two main parts: PHI 70 and body 72. The PHI 70 is then encrypted and a Key or Encryption Key 308 is added to the PHI 70. The PHI 70 plus Key 308 are then sent to the Central Index 38.

The Central Index 38 component is the central control point for the system. The Central Index keeps track of studies and the corresponding patient and referring record consumers for each. The Central Index keeps track of which nodes contain which records and when those records should move between the nodes. The Central Index may also comprise a set of services for different components of the system. Such services include, but are not limited to: upload PHI for a record; search for patient and associated records; search PHI for all records on a node; audit trail that shows each time PHI is touched by a user in the system; and billing information tracking.

FIGS. 19 and 20 further illustrate alternate embodiments of the record harvesting process. As shown in FIG. 19, communication manager 42 receives record message 301 and record 300 from the harvester or the listener. Communication manager 42 transmits record 300 with record 300 to security manager 250, and in particular record split manager 290. Record split manager 290 strips record 300 of its header 70 and send header 70 to header sender 194 in central network 14. Header sender 194 uploads header to central storage, namely header data 174 in database manager 36. Body 72, remaining after record split manager 290 removes header 70, send body 72 to storage manager 52 to store body 72.

As shown in FIG. 20, harvester 44 and listener 45 are both in communication with record producers 18, e.g. MRIs, gateways 60 (interfaces) and storage 54 (PACS). The configuration for harvester 44 maintains all the configuration values for the different record producing devices 18 located at the source node. These configuration values are stored permanently on the central network 14 and cached at the different nodes upon the registration of the node. Harvester 44 will still use the peer-to-peer network to pull down configuration values, but the values are not stored on the peer-to-peer network. Harvester 44 thus has the capability for an unlimited number of record producing devices to be configured and read by the harvester.

Harvester 44 further can take any file path or byte stream and send the file to storage manager 52 for processing. The primary use of this mechanism will be in loading files or records via a CD on-ramp or the reloading of records that had been previously removed from a source node.

As shown in FIG. 20, listener 45 listens for incoming transmission to the node and accepts data into the node for processing. As shown, the transmission consists of record message 301 and record 300. Also as shown in FIG. 20, listener 45 allows multiple record producing devices 18 to connect and push records to the harvester 44. Listener 45 accepts each record and deposits it to the storage manager 52.

In order to ensure HIPAA compliance with regard to protecting PHI, the audit trail of a record and the associated PHI are stored permanently by the system. In addition, certain rules exist about what information can and cannot be changed. For example, record consumer, record producer and patient data can be updated by the system upon appropriate authenticated request. Any change is this regard is captured in the audit trail and the full history of the change is saved in the system. However, the records and associated PHI are never modified by the system. The records are written to the system constitute the final version.

Within the central index, the PHI Manager is the central component that handles the collection and distribution of PHI associated with records that are on the system. The main input for the PHI Manager is the record harvester component. The main consumer of PHI is the viewing application at the remote storage nodes of the record consumer.

Also within the Central Server is the Network Node Manager. The network node manager is the central controlling point for the Peer-to-Peer Network. All nodes will authenticate or login to the system through this component. The management of record transfer, node status and node errors are handled here.

The node manager breaks down into two main sections, depending on the network transport used. Web services is used when information is being requested from the nodes and the manager needs to respond. Web services allows for easier transfers of dataset type information over a secure standard. Any communication when the manager is the initiator is done over the socket layer connection. This permits the local node to run with a thinner client and not have to host a web services and IIS to receive web service calls to it.

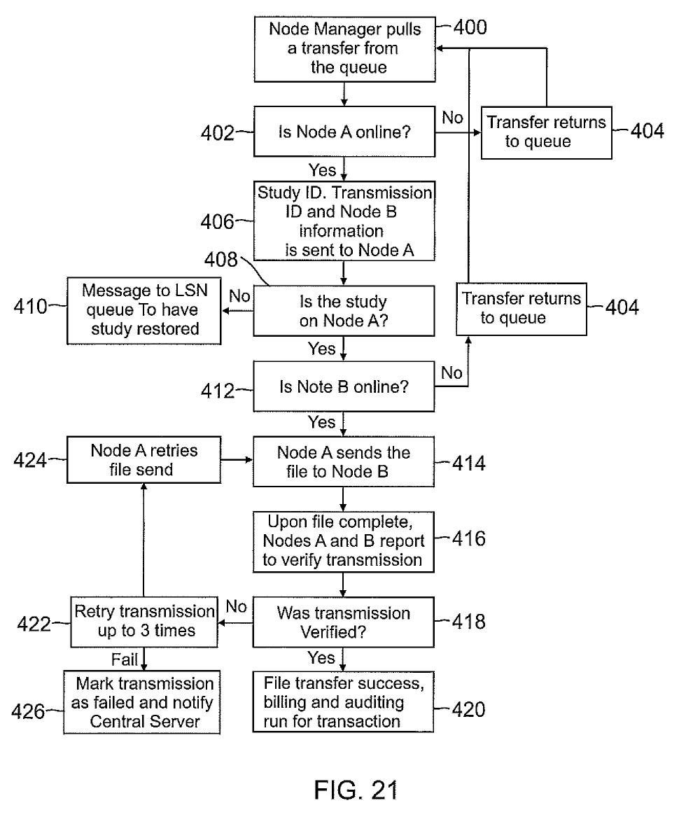

The record is then transferred to the record consumer. The transfer process is also referred to as Node-to-Node File Transfer as is illustrated in detail in FIG. 21. Further, FIG. 23B is a detailed data model of the components of the system according to one embodiment of the disclosed system.

A transfer occurs when a record is either requested from a record consumer, or when a record has been added and all the information is available to preemptively push the record to the appropriate record consumer. The record transfer is logged into the transfer queue, with source and destination nodes given. In FIG. 21 the source node is referred to as Node A and the destination nodes as Node B.

When a record is set to be transferred from one node to another, the Node Manager is the controller of these studies' moving. In block 400, the node manager pulls a transfer from the queue and in block 402, checks to see if Node A is online. If not, in block 404, the system returns to the queue. In block 406, information regarding the transfer, including, but not limited to the Record ID, Transmission ID and Node B information, including the IP address, is sent to Node A. The system then checks, in block 408, whether the record is on Node A. If not, in block 410, a message is sent to the local storage node to have the record restored.

Once the system has verified that the record is on Node A, it is then locked so the cache will not remove it before transmission is complete. The system then checks, in block 412, to see if Node B is online. If not, the system returns to the queue in block 404. Node A sends the record to Node B in block 414. It is important to note that the record sent in block 414 is comprised of only the body of the record plus the Consumer ID directing it to Node B and to the particular record consumer for which it is destined. At the point where the transfer occurs, the PHI has already been separated from the body of the record through the record harvester described above.

Even though the traffic of the record will not travel through the node manager or central servers, all management and authorization to move records is controlled and logged at this level. Although security requirements do not call for encrypting information that transmits over the peer-to-peer network, due to the previous stripping of the PHI and because of the possible large file sizes, one embodiment envisions encrypting the initial data that transmits over the system as a safety measure to prevent hacking or DOS attacks.

In block 416, once the transfer is complete, both Nodes A and B report to verify transmission. The verification report consists of certain information, including, but not limited to, the Record ID, Transmission ID, date and time transmission was completed and checksum/hash on the nodes. Verification occurs when both nodes report success and the checksums match for the record transferred.

If it is verified in block 416, the record transfer was successful, in block 420 the billing and auditing are run for that transaction. If the transmission is not verified in block 416, in block 422, the transmission is retried multiple times, for example, three, and in block 424, Node A tries again to send the record. If transmission continues to fail, the transmission is marked as failed in block 426, and the Central Server is notified.

In at least one embodiment and based on the information connected with the record, the record consumer to whom the record needs to be transferred is selected from a record consumer list 320, and the ID of the record consumer, referred to as Consumer ID 310, is added to the body 72. The body 72 plus Consumer ID 310 is then pushed to the Record Consumer's P2P node, awaiting access by the Record Consumer (FIG. 16B, block 238). Once a record is pushed to the record consumer, a relationship, or “trust,” is created between the patient and record consumer (FIG. 16B, block 239).

Thus, once the record has been created and harvested, as shown in FIGS. 18 through 20, the body of the record is preemptively sent from the record producer's Local Storage Node to the designated record consumer. The preemptive push constitutes a transmission for purposes of billing, described below. However, a search can also be conducted by the record consumer, record requested and the record then pulled to the record consumer depending on what records the record consumer has requested (FIG. 16C, block 240).

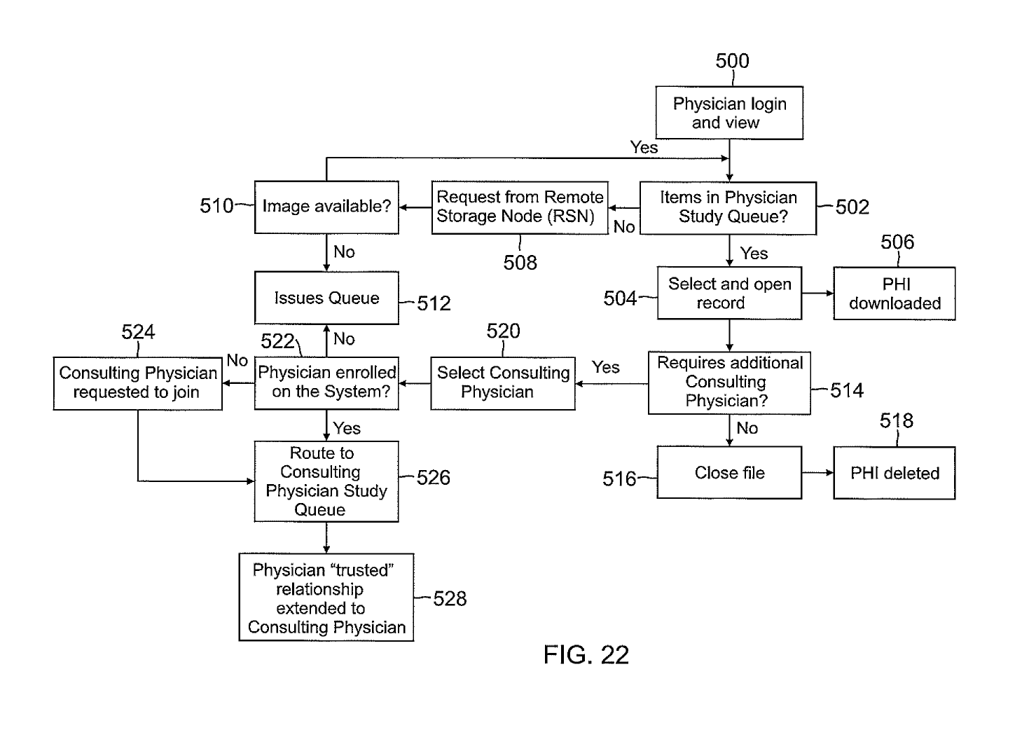

As shown in FIG. 22, the record consumer logs in, in block 500, as shown in FIG. 15A. The record consumer is able to view any records in his queue that have been preemptively pushed to the queue. If there are records in the queue, in block 502, the record consumer selects and opens the record in step 504, comprised of the body only, and the PHI is downloaded from the Central Index in block 506.

The viewing application allows the record consumer to execute the steps in FIG. 22. Non-limiting examples of viewing applications are ones based on the .NET Smart Client. This allows for a simpler distributed install for end users as well as better updates of the software over time. The smart client architecture also allows for certain offline capabilities should internet connectivity be lost if the Central Server is offline.

This viewing application component allows the record consumer to rejoin the body of the record with the PHI onscreen. Inside the viewing application, the PHI is merged back with the body of the record to allow the record consumer to view the entire record. In order to ensure that PHI is never compromised, one embodiment envisions an overlay of the PHI on the body of the record. Such an overlay would permit simultaneous viewing of both parts without having to merge the PHI with the body of the record in the memory and then removing it again when the record is no longer being viewed.

If no records are in the queue, or if the particular records that the record consumer desires to view are not in the record consumer's queue, in block 502, then, in block 508, the record consumer can invoke his authorization and request records from one or more remote storage nodes (FIG. 16C, block 242). The system then determines if the record is available in block 510, and if it is, the record is sent to the record consumer's local storage node (FIG. 16C, block 244), and it is placed in the record consumer's queue and the record consumer can select and open the record in block 504.

In order for the image to be transferred, the record consumer must be enrolled in the system prior to the transfer, as described above in FIG. 14A. If the record consumer is not enrolled on the system, the record is routed to a queue for that record consumer. Once the record consumer joins the system, the record is waiting for viewing by the record consumer.

In one embodiment, the record producer notifies the record consumer that the record is on the system, and that the record consumer can join the system, in one embodiment, at no cost to the record consumer. If the record consumer does not want to join, the record is then manually couriered to the record consumer. In an alternate embodiment, the forward physician can add the physician from which a second opinion is sought or to which the physician is referring the patient. FIG. 15I illustrates an example of the screen for adding a physician. In this embodiment, if the physician does not enroll (FIG. 15J), the physician is likely granted only Tier 1 access.

The same is applied to consulting record consumers in. FIG. 22. If the record consumer requires a consult on the record in block 514, a consulting consumer is selected in block 516. FIG. 15H illustrates an example of the screen for forwarding a record to a consulting consumer or specialist.

If the consulting consumer is not enrolled in the system in block 522, the consulting consumer is requested to join in block 524. FIG. 15J illustrates an example of the screen for enrolling in the system. If the consulting consumer is already enrolled in block 522, or joins in block 524, the record is routed to the consulting consumer's queue in block 526. Then, in block 528 the record consumer's chain of trust is extended to that authorized consulting consumer. Once the record is viewed by the record consumer and/or consulting consumer, the record consumer can then visit with the patient regarding the contents of the record (FIG. 16C, block 246).

FIG. 23A particularly illustrates the elements of node software 13. As shown, the node software includes client application 40, described above, as well as source code to execute the functionality of node server or node services 19, also described above. At a higher level, and in communication with the central network, node software 13 also controls and regulates versions of the application that can be downloaded to new and existing nodes. The component alerts when new software is available to be downloaded and installed.

Node software 13 is only downloaded to authorized nodes and people. Node software 13 is only downloaded if all requirements and dependencies are met. Node software 13 generates a machine key for each computer downloading the software. As noted above, FIG. 23B is a detailed data model of the software components of the system according to one embodiment of the disclosed system.

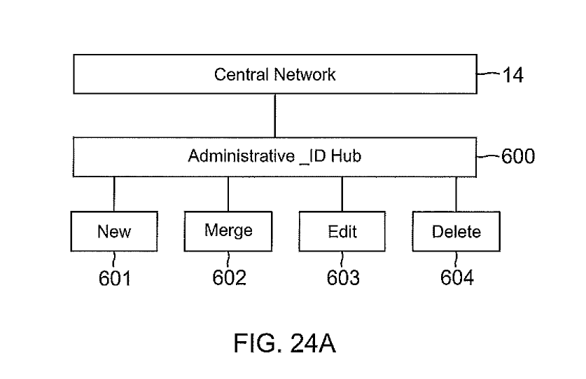

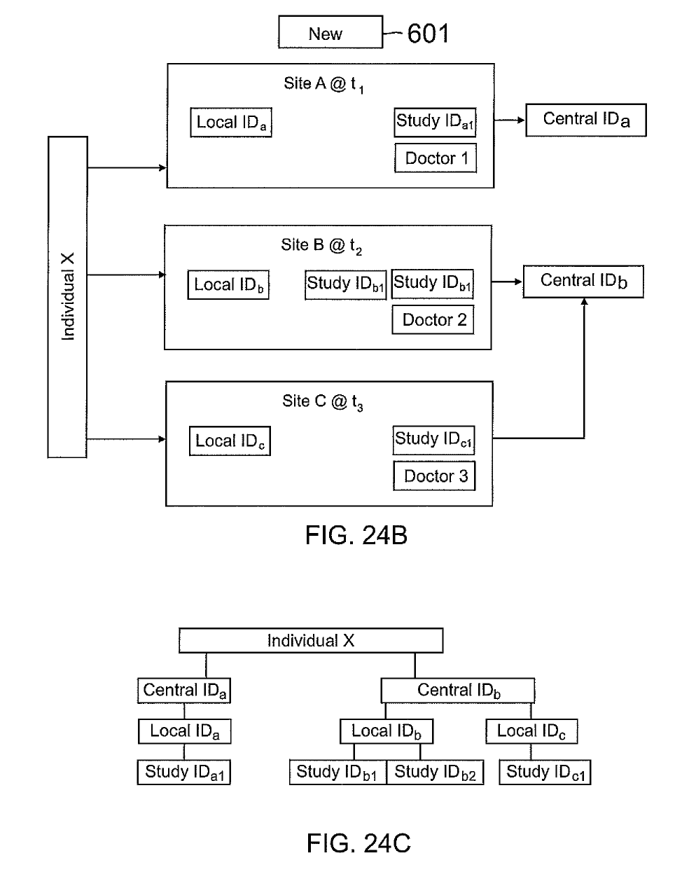

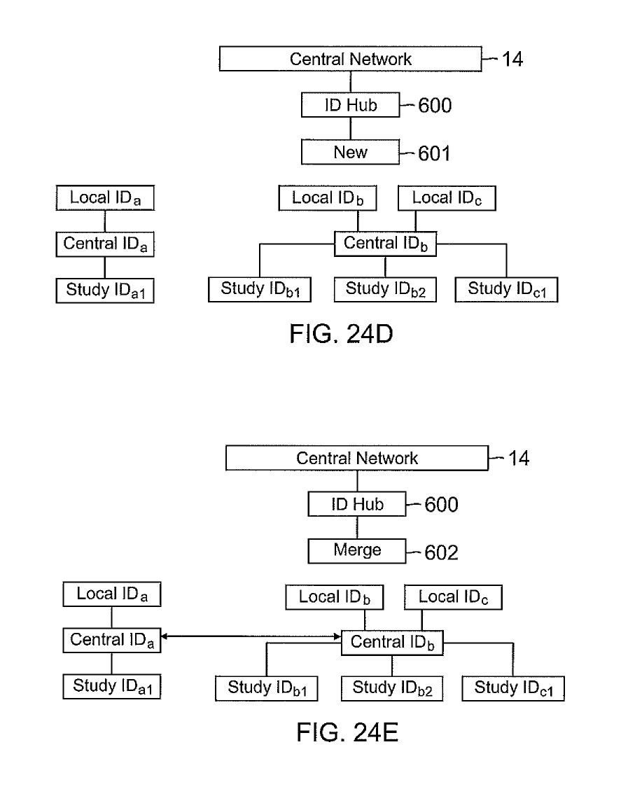

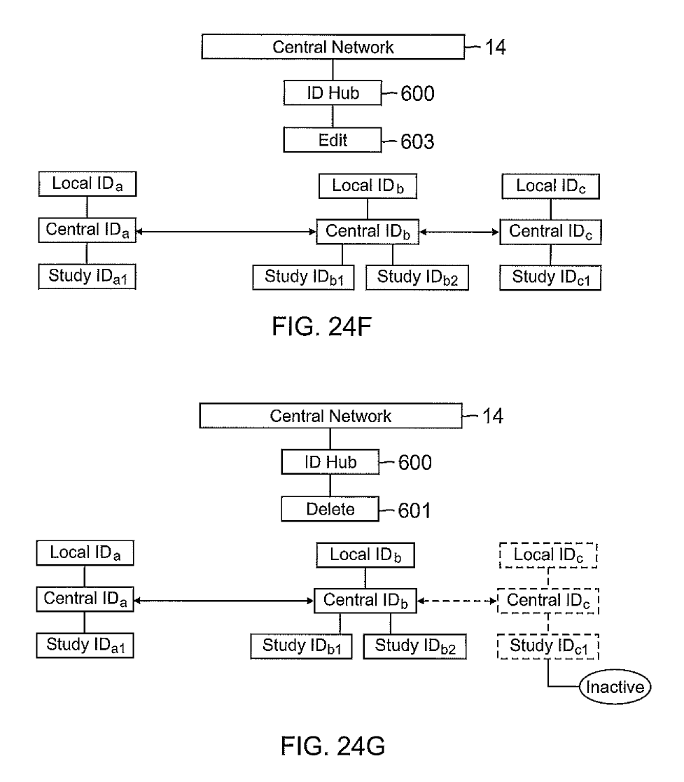

FIG. 24 illustrates the central network 14 administrative or ID Hub 600 functions of the present disclosure. The administration component maintains the accounts, persons, facilities and the configurations of the local node. As shown in FIG. 24A, administrative ID Hub 600 can add new 601 patients, physicians and facilities (record producers and record consumers) to the database. FIG. 24B illustrates the addition of a new 601 Individual X to the system.

As illustrated, Individual X has four records (referred to here as Studies) at three different sites (A, B and C) that were produced at three different times (here, t3>t2>t1). FIG. 24B illustrates how each record has a site identification (Local ID), a record identification (Study ID) and a doctor identification (Doctor ID). The record at site A was provided to the system as a new patient and given Central IDa. The records at Site B were provided to the system as a new patient and given Central IDb. However, the record at Site C was added to the system after a search successfully determined Individual X existed on the system as Central IDb, and thus was added to the system for Central IDb.

FIG. 24C shows a simplified diagram of all the information existing for Individual X that has been sent to the system. FIG. 24D illustrates how the disclosed system initially organizes the information provided on Individual X before any subsequent processing of the information occurs. As shown, Central IDa and Central IDb are not yet connected.

As shown in FIG. 24E, the system then uses its merge 603 function to link Individual X's Central or System IDs, and connects Central IDa and Central IDb so the system knows that both identifications reference the same Individual X. This also allows all other associated data to be connected. As shown in FIG. 24A, administrative ID Hub 600 can also edit 602 patient, physicians and facilities on the database. The particular edit 602 function shown in FIG. 24F, illustrates how the system can create a third system identification (Central IDc) in order to manage the information from Site C separately. This would be necessary if, as shown in FIG. 24G, the information from Site C was to be removed or deleted from the system using delete function 604. Once Central IDc is deleted from the system, all related information is inactive and cannot be accessed.

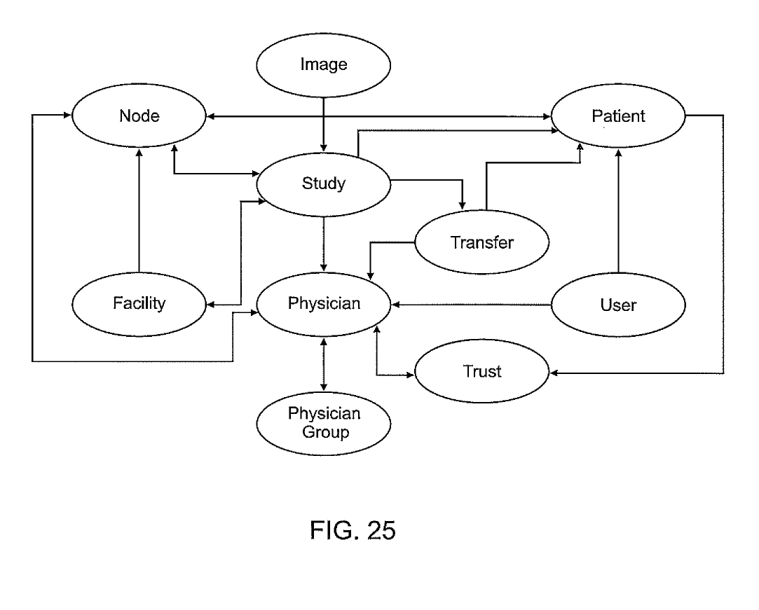

FIG. 25 gives an overview of the “chain of trust” relationships with the different entities of the system described above. FIGS. 26-29 depict how trusts are transferred across the system from patients to record consumers (physicians), first or primarily from patient to doctor ordering the study as shown in FIG. 26A, and second to record producers (facilities) with associated Local IDs, as shown in FIG. 26B. Once these trusts are established, the system can optimize the chain of trust as shown in FIG. 26B and create a “trust hub” as illustrated in FIG. 26C that shows the complete chain of trust for Individual X on the disclosed system. FIG. 26D illustrates a simplified trust hub, as would be established by the system, to determine which record consumers (doctors, and here Doctors 1, 2 and 3) would be allowed to access the record.

FIGS. 27A and 27B further illustrate how the chain of trust is passed to authorized record producers (facilities) or to record consumers (physicians), as the case may be. As shown in FIG. 27A, trusts can be added across the system. FIG. 27A illustrates how trusts are added by referral (to Doctor 5) or second opinion (to Doctor 6). The control of trusts can reside with the patient or patient's designee, such as one or more record consumers (doctor, hospital, etc.).

FIGS. 28A and 28B illustrate the proxy aspect of the chain of trusts feature of the disclosed system. Here, in FIG. 28A, a proxy, for example, a parent of a minor, a spouse, someone who has power of attorney, or another emergency authorization provides for a proxy, which, for example, has been designated by Individual X or provided for by law (in the case of a minor or emergency). FIGS. 28A and 28B illustrate how the proxy is given his own Central ID and how that ID is then connected with the existing Central IDs for Individual X, creating the modified trust hub shown in FIG. 28B. FIGS. 28C and 28D then illustrate how the chain of trust would appear if or when the proxy authorized another doctor (Doctor 7) to have access to the records on the system.

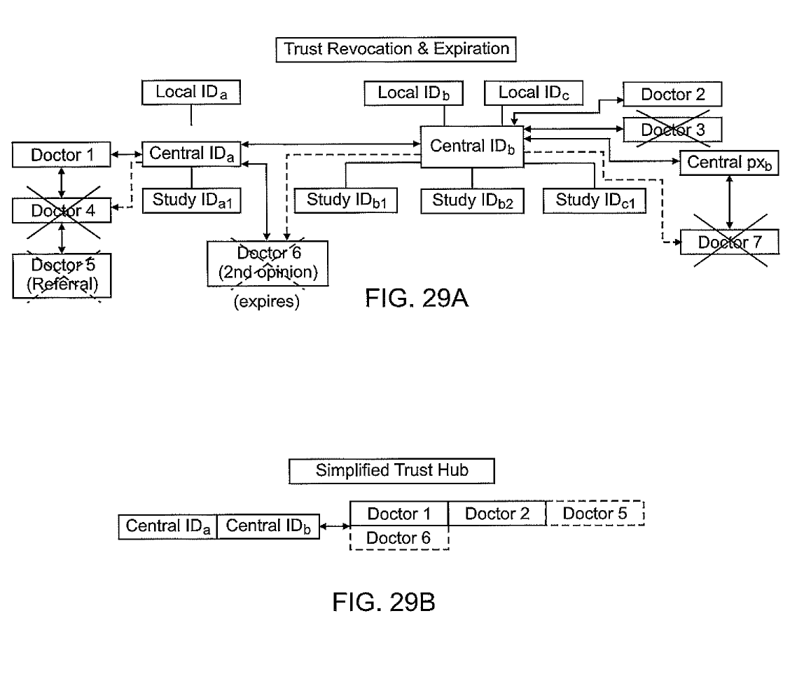

Finally, FIG. 29 illustrates the trust revocation and expiration features of the chain of trust. As illustrated in FIGS. 29A and 29B, certain trusted relationships not established by a direct doctor patient relationship (as shown in FIG. 26A), for example, doctors that have given second opinions, can expire. Also trust can be expressly revoked, either by Individual X (Doctor 3 and Doctor 4) or by the proxy (Doctor 7). Finally, when certain trusts are expressly revoked, as is the case with Doctor 3 here, certain other trusted relationship that may be dependent upon Doctor 3 (for example, possibly the referral to Doctor 5) could also be subsequently revoked, unless directed otherwise.

The Central Server has several other administrative interfaces and online reports to manage key tasks. First, the Central Server has the ability to view record consumers with records in queue but who are not enrolled in the system. This allows the system to follow up with the record consumer and enroll him. The Central Server has the ability to view a list of record consumers and record producers awaiting approval. The Central Server has the ability to assign and review credit status. The Central Server also has the ability to view node and session status and control node status, Finally, the Central Server has the ability to view issues that cannot be resolved at the record producer or record consumer level.

The client application provides basic administration and reports tools to manage the costs, resolve issues and invoice. The client application also provides an interface to administer some key information and view online reports for the record consumer.

In one embodiment, the system charges all record producers a subscription fee as well as a fee each time the record is transferred. The subscription fee is an annual or other periodic fee. The transmission or transfer fee is charged for the movement or transmission of a study from the record producer to the record consumer. The fee replaces the current courier fee paid to physically move studies. Although, the disclosure also envisions no fee, or alternate fees, for example a subscription fee, but not a transaction fee, and vice versa.

Storage fees may also be charged for storage of the records on the system. These fees will be charged for records that are stored on the system in a permanent form and become the document of legal record for the record producer. The storage fee may be a per document fee or flat fee.

In order to facilitate billing, each time a record is authorized to move across the network, it is logged as a transaction. The transmission is logged after the file has been confirmed on the destination (network) node. A report is available to view this information as well as the ability to export the information to the invoicing or billing system at the central server.

The billing system also allows support billing based on both origin and destination nodes (storage and network nodes) and takes into account any discounts or other features that have been set up for those facilities. In an alternate embodiment, patients are responsible for fees.

Security is very important to the disclosed system. Securing access to the data in the database is performed using multiple techniques to protect against unauthorized access. The techniques that are applied incorporate the functions of Resource Description Messages (RDMs) that are implemented as well as custom security developed using tables for administrative purposes and security logic on the application servers.

Direct access to the tables in the database that contain sensitive and private information is not permitted. Access to these tables is done using views and stored procedures. Using views and procedures permits data to be secured at the record level. Record level security is achieved by creating an additional column in the table to indicate the sensitivity of the date in the record. The security level column contains a numeric value to indicate the data's importance. The higher the value, the more important the data is. System users are organized into security level groups. Only users with a security level or higher of the value in the record can access the record. This is particularly useful when certain patient records are blacked out. When a user queries the table's view, the user credentials are determined and automatic filters are applied to the query to prevent any records from returning with higher security levels than the current user.

Users are also classified into groups based on their responsibilities and requirements. When a new user is created, he is assigned to a user group with a predetermined security level. As noted above, the security level determines the level of access of the data the user has. The user group will also determine the functional modules the user is allowed to perform in the system. A system administrator can override the default settings for a user group to increase or decrease the level for a specific user.

As indicated above, each area of the system is categorized into modules. The modules group organizes the functional requirements of the system into common objectives. Some of the modules in the system are administrative, reporting, record consumer, record producer and record owner (e.g., patient). User groups are assigned to the modules to which they require access.

Component level security is defined based on the functionality of a component that defines a system application. Each component has a separate database login assigned to it. The login ID is used to track the activity of the component and the permissions it has with the objects in the database.

Login access to the database is provided by login IDs. Each login ID consists of a username and a password. The password is an alphanumeric value with a minimum of eight characters. The login IDs have different object permissions and credentials. The login given to the application and component depend on its purpose and requirements. Logins only contain the necessary permissions a component or application needs. The system also supports custom user logins to identify individuals logging into the system. The user logins also consist of a username and password. The username is the email address of the user and the password is a minimum of eight characters. The username and password are stored in a table in the database. The password is encrypted by the application prior to being saved in the database to prevent database logins from viewing the passwords.

The tracking of changes of data in the database is also key to the security of the disclosed system. The auditing capabilities of the system database provides the requirements for each component and module to track data through the system. All tables will have four standard columns to track when records are created and updated. The tables will have two columns to denote the user and the time the record was created and two columns to denote the user and the time the record was last updated. Tables that track changes of its records that occur incorporate triggers to retain a copy of the record before the update occurs. The update trigger for the table inserts before a record in an audit table associated with the designated table.

All actions and events that occur between the main entities in the database are logged, as described above. An event record will contain the time the event occurred, the IDs of the entities involved in the event, the type of event and the elapsed time of the event. An example of an event is when a physician requests to view a record. The event records the physician's ID, the record ID, the time it was reviewed and the reason it was reviewed, e.g., a second opinion. User and node access to the system is logged to track overall activity of they system and to keep track of usage and growth. When a user or node is authorized on the system, a record is created containing the user ID or node ID, the IP address and the time access occurred. A second record is created when the user or node disconnects from the system.

Thus, the disclosed system and method maintain the security of private health information (PHI) in accordance with HIPAA standards while maximizing the efficiency of transmission of medical records over the Internet. As noted above, this is primarily accomplished by separating all PHI from the body of the record as they are transmitted. The PHI is only combined with the body when it is viewed by an authenticated record consumer.

Thus, the disclosed system and method provides numerous advantages over the prior art. First, the disclosed system is compliant with HIPAA privacy and security requirement, including, but not limited to, compliance requirements with downstream vendors. Second, the disclosed system and method removes the risks of human error associated with physically handling and transporting records. Third, the present system includes electronic measures to minimize the risk of lost or stolen records. Fourth, medical services providers can rely on the chain of trust that is required under HIPAA. Finally, the system and method is substantially more efficient and cost effective than any current alternatives.

Generally described hereafter, this application relates to medical images, and more particularly, to a centralized medical information network for acquiring, hosting, and distributing medical images for healthcare professionals. The medical information network can be image oriented, event driven, and service oriented. In one illustrative embodiment, a repository for discrete DICOM images is provided. The repository can be cloud based and globally accessible. The discrete DICOM images are generally not processed or persisted as image studies, but instead they can be maintained as individual DICOM images allowing each image to be separately identifiable. DICOM images can be uploaded in an event-driven manner. The DICOM images can also be stored in a flat namespace where users can query for the images via strongly authenticated web services.

Provided below are several terms used throughout the present application. The meanings for these terms are for illustrative purposes and should not be construed as limiting the scope of this application. The term consumer can refer to a node that retrieves resources from a repository. A producer can be a node that provides resources to the repository. The repository can be referred to as a grid or medical information network. Resource can refer to the smallest addressable unit of data on the repository. Resource can generally have a resource content length from 0 to 9,223,372,036,854,775,807 (263-1) octets. A universally unique identifier (UUID) can be an identifier standard to provide distributed reference numbers. Typically, the UUID is a 128-bit number. Global unique identifiers (GUID) can also be used.

As previously described, the DICOM protocol generates silo-ed data by nature. Silo-ed data refers to the DICOM standard being trapped within the four walls of the medical facility or production entity that generated the data. Data can be persisted in various media such as tape, removable magnetic optical drives, CDs, DVDs, individual hard disks, disk arrays, and Picture Archival and Communication Systems (PACs). Communicating DICOM data between authorized facilities can be typically accomplished with hand carried media or with point to point solutions such as a virtual private network (VPN) between two facilities. One of the driving forces behind the silo-ing of DICOM data is the regulatory mandate to ensure that private health information is always protected.

A system and method for separating protected health information from the actual image data was provided for. This opened the possibility of creating a network or Internet based content delivery system and method for anonymized DICOM images, which is now the context of the present application. Nonetheless, one skilled in the relevant art will appreciate that the present application is not necessarily limited to those configurations provided in the previous application.

In essence, the system and method described herein takes advantage of traditional content delivery networks that can aggregate content in network data centers and serve up that content from the data center to the end user. Peer-to-peer file sharing services can also aggregate content on each users system and propagate that data directly from one user's system to another. The present application combines and augments elements of both of these content delivery techniques and applies them to the domain specific problem of distributing DICOM data to authorized users in the clinical chain of care.

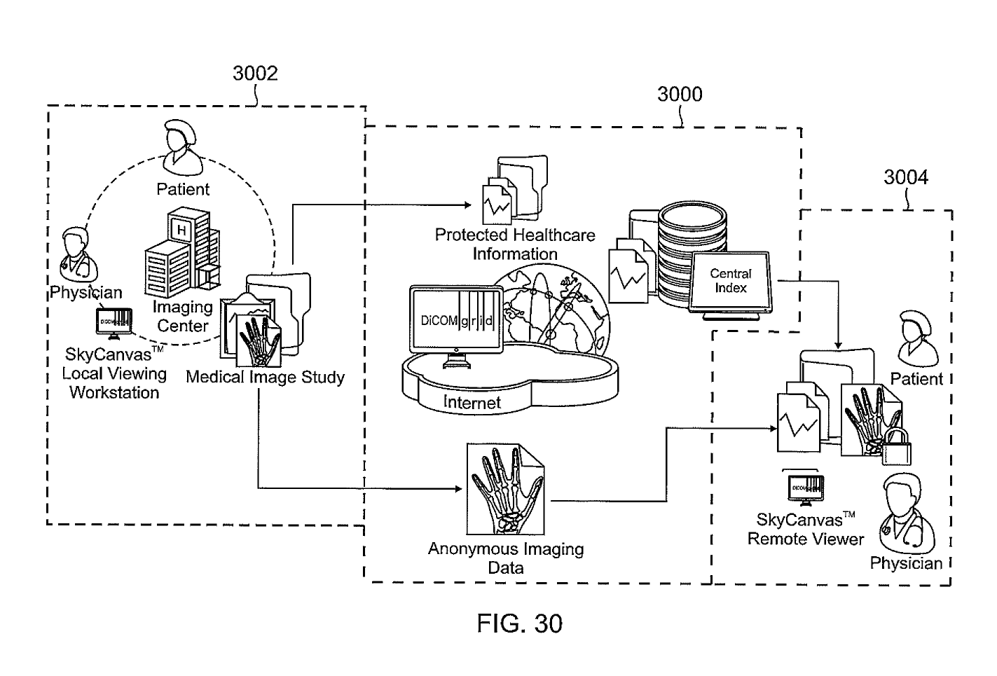

With reference now to FIG. 30, a typical environment for a medical information network 3000 in accordance with one aspect of the present application is provided. As shown, the medical information network 3000 can include producers 3002 and consumers 3004. One skilled in the relevant art will appreciate that the environment can include fewer or additional components and is not limited to the configuration shown.

Producers 3002 and consumers 3004 can operate with the medical information network 3000 using logical connections. These logical connections can be achieved by communication devices within the medical information network 3000. The medical information network 3000 can include computers, servers, routers, network personal computers, clients, peer devices, or other common network nodes. The logical connections can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet.

The medical information network 3000, producers 3002 and consumers 3004 can be linked together by a group of two or more computer systems. These links typically transfer data from one source to another. To communicate efficiently, each component can include a common set of rules and signals, also known as a protocol. Generally, the protocol determines the type of error checking to be used, what data compression method, if any, will be used, how the sending device will indicate that it has finished sending a message, and how the receiving device will indicate that it has received a message. Programmers can choose from a variety of standard protocols. Existing electronic commerce systems typically use an Internet Protocol (IP) usually combined with a higher-level protocol called Transmission Control Protocol (TCP), which establishes a virtual connection between a destination and a source. IP is analogous to a postal system in that it allows the addressing of a package and dropping it in the system without a direct link between the sender and the recipient. TCP/IP, on the other hand, establishes a connection between two hosts so that they can send messages back and forth for a period of time.

The medical information network 3000 can be classified as falling into one of two broad architectures: peer-to-peer or client/server architecture. For most, communications can be classified as a client/server architecture. The components primarily provide or receive services from remote locations. Typically, the components run on multi-user operating systems such as UNIX, MVX or VMS, or at least an operating system with network services such as Windows NT, NetWard NDS, or NetWire Bindery.

Continuing with FIG. 30, producers 3002 and consumers 3004 can be typically any devices that are capable of sending and receiving data across the medical information network 3000, for example, mainframe computers, mini computers, personal computers, laptop computers, a personal digital assistants (PDA) and Internet access devices such as Web TV. In addition, producers 3002 and consumers 3004 can be equipped with a web browser, such as MICROSOFT INTERNET EXPLORER, NETSCAPE NAVIGATOR, MOZILLA FIREFOX, APPLE SAFARI, GOOGLE CHROME or the like. Thus, as envisioned herein, producers 3002 and consumers 3004 are devices that can communicate over a medical information network 3000 and can be operated anywhere, including, for example, moving vehicles.

Various kinds of input devices and output devices can be utilized within the medical information network 3000. Although many of the devices interface (e.g., connect) with an area network or service provider, it is envisioned herein that many of the device can operate without any direct connection to such. For example, producers 3002 such as an MRI scanner, imaging center, or hospital can provide and retrieve data from the medical information network 3000 without the use of area networks or service providers. While the producers 3002 and consumers 3004 are separated, those skilled in the relevant art will appreciate that the medical information network 3000 can be used as a storage facility whereby the producers 3002 and consumers 3004 are the same. For example, the producer 3002 can upload medical imaging records and later, retrieve them from the storage facility.

The nature of the present application is such that one skilled in the art of writing computer executable code (i.e., software) can implement the described functions and features using one or more of a combination of popular computer programming languages and developing environments including, but not limited to C, C++, C#, Groovy, Scala, Ruby, Python, Visual Basic, JAVA, PHP, HTML, XML, ACTIVE SERVER PAGES, JAVA server pages, servlets, MICROSOFT .NET, and a plurality of various development applications.

Data can be formatted as an image file (e.g., TIFF, JPG, BMP, GIF, PNG or the like). In another embodiment, data can be stored in an ADOBE ACROBAT PDF file. Preferably, one or more data formatting and/or normalization routines are provided that manage data sent and received from a plurality of sources and destinations. In another embodiment, data can be received that is provided in a particular format (e.g., TIFF), and programming routines are executed that convert the data to another format (e.g., JPG2000).

It is contemplated herein that any suitable operating system can be used by each component, for example, DOS, WINDOWS 95, WINDOWS 98, WINDOWS NT, WINDOWS 2000, WINDOWS ME, WINDOWS CE, WINDOWS POCKET PC, WINDOWS XP, WINDOWS 7, WINDOWS SERVER 2003, WINDOWS SERVER 2008, MAC OS, UNIX, LINUX, PALM OS, POCKET PC, CHROME OS or any other suitable operating system. Of course, one skilled in the relevant art will recognize that other software applications are available in accordance with the teachings herein, including, for example, via JAVA, JAVA Script, Action Script, Swish, or the like.

Moreover, a plurality of data file types is envisioned herein. For example, the present application preferably supports various suitable multi-media file types, including (but not limited to) JPEG, BMP, GIF, TIFF, MPEG, AVI, SWF, RAW, PDF, JPEG2000 or the like (as known to those skilled in the art).

Continuing with FIG. 30, and in more details, a producer 3002 can be coupled to the medical information network 3000 for providing images. Multiple producers 3002 can be provided and can include, but are not limited to, an imaging center, an MRI scanner, a smart phone, or computer. The MRI scanner can produce multiple images and be coupled to the medical information network 3000. The MRI scanner can generate images that reproduce the internal structure of the body and can contrast the difference between soft tissues of the body. Generally, the MRI scanner can use a magnetic field to align nuclear magnetization of hydrogen atoms in water of the body. In another embodiment, computerized tomography (CT) scanners can be provided for. Those skilled in the relevant art will appreciate that there are numerous types of scanners and the present application is not limited to those described above.

The medical information network 3000 can also be coupled to an imaging center. The imaging center can generally refer to a location where various types of radiologic and electromagnetic images can be taken. Often, the imaging center includes professionals for interpreting and storing the images. In addition thereto, a producer 3002 can also be in the form of a computer. Today's computers are capable of handling images that are complex and intricate. Computers can typically include electronic devices that process and store large amounts of information. Smart phones can also be used for providing or generating images. Smart phones offer a variety of advanced capabilities that include image production. Smart phones often include operating system software that can provide features like e-mail, Internet, and e-book reader capabilities. While several producers 3002 were presented, there are numerous types of devices or apparatus that can generate or produce images that have not been disclosed herein and are within the scope of the present application.

As referred to herein, images generally relate to medical images. Medical images can include pictures taken of the human body for clinical purposes. For example, the medical images can show heart abnormalities, cancerous tissue growth, etc. Medical images can be taken through EEG, MEG, EKG, and other known methods. Nonetheless, the images as described above, can refer to most types of data.

The producers 3002 providing the above-described medical images can be coupled to the medical information network 3000 as shown in FIG. 30. The medical information network 3000, in one embodiment, can be on one or more LANs. For purposes of illustration, the LAN can include a computer network covering a small physical area, typically located within a home, office, or small group of buildings. Other networks for the medical information network 3000 can also include WAN, PAN, CAN, MAN, or GAN. Those skilled in the relevant art will appreciate that a combination of these networks can be used and is not wholly limited to a single network.

As will be shown below, images generated by the producers 3002 are received, stored, and distributed through the medical information network 3000. In one embodiment, the medical information network 3000 is a DICOM Internet gateway that comprehends DICOM communications on the LAN side and cloud based web services on the Internet side. DICOM images can be acquired off the LAN from any DICOM device (i.e. producer 3002), typically a PACS or DICOM modality. Images can be acquired off the LAN in real time. As discrete images are acquired by the LAN, they can be uploaded to the global medical image repository 3006.

Typical processes for uploading images to the medical information network 3000 will now be described. Typically, DICOM images are not assembled into image studies on the gateway device. Rather, they can be dynamically uploaded to the Internet to the medical information network 3000 in the general order in which they were received off the wire. This eliminates the need for timers or other DICOM receiving techniques that attempt to aggregate discrete images into complete image studies.

The image can then be fingerprinted. Fingerprinting can include embedding or attaching information to the image so that the image can be uniquely identified. Several algorithms can be used to fingerprint the image. The producer 3002 then logs onto the medical information network 3000. The producer 3002 can log into an Internet resident central index of images using strongly authenticated web services.

The image can be anonymized thereafter. The anonymized process can remove private health information from the textual DICOM header. This can allow for compliance with the standards set by HIPAA. Optionally, the image can be converted into a canonical DICOM compliant format like JPEG2000.

The image can be fingerprinted. Similar to before, the image can be fingerprinted using a hashing algorithm. The images can then be uploaded to the medical information network 3000, which can be an Internet based image repository using strongly authenticated webs services. As shown, the images are generally not aggregated into studies, but instead they are deposited into image repositories of the medical information network 3000. Each image is individually indexed and stored in a cloud where they can be conveniently queried and retrieved at a later date by the consumers 3004 shown in FIG. 30.

As shown in FIG. 30, consumers 3004 can take a variety of forms. The consumers 3004 can include, but are not limited to, a computer and phone. The computer can be a personal computer or a specialized computer for receiving medical images. The phone can be a smart phone or a tablet. In another embodiment, the consumers 3004 can be coupled to an area network. The area network can receive images from the medical information network 3000. While not limiting, the consumers 3004 can include a computer, hospital, or smart phone. In essence, the medical information network 3000 provided within FIG. 30 allows for many combinations of producers 3002 to interact with a global medical image repository 3006 to distribute that information to multiple consumers 3004.

While there are several components provided within the medical information network 3000, fewer or additional components can be provided for. Each of the connections presented above can be through wireless methods, wireline methods, or a combination thereof. Numerous combinations of the network 3000 can exists and the present application is not limited to that shown in FIG. 30. The present application, which will be described in more details below, provides upgrades to the previously discussed courier system. The medical information network 3000 provided above enables for anonymized images that facilitate the distribution of those images across the Internet. The medical information network 3000 and methods therein center on the manner and method of image acquisition and Internet distribution for those images.

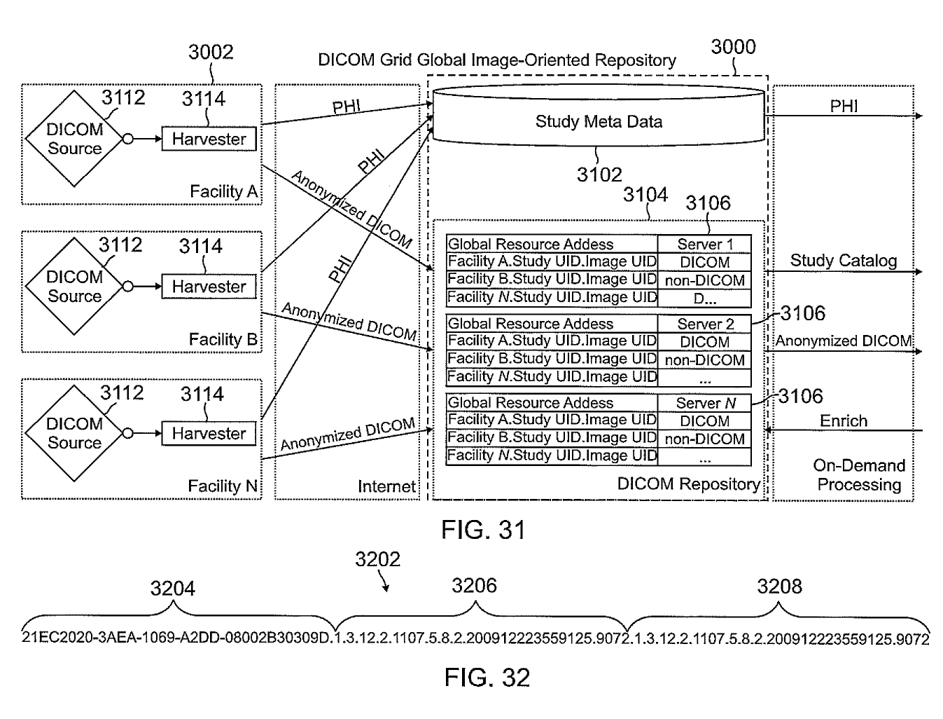

Previously, the medical information network 3000 was presented as a two entity structure within FIG. 30. The DICOM image was split into protected healthcare information and anonymous DICOM imaging data and joined by the consumer 3004. The split data was stored in different locations, for example, the protected healthcare information was stored in one area of the network 3000 while the imaging data was stored in another part. To provide more details, FIG. 31 provides a representative diagram showing storage of anonymized DICOM files and imaging-related non-DICOM data.

The storage capabilities provided within the medical information network 3000 allows globally accessible DICOM data that, in one embodiment, can be accessible over the Internet. The network 3000 can include at least one database 3102, and several nodes 3106, within a DICOM repository 3104. Generally described, the network 3000 provides cloud based services having horizontally scalable data at multiple nodes 3106, 3108 and 3110, for example.

DICOM data can be uploaded or provided by the producers 3002. The producers 3002, as illustrated above, can be, but are not limited to, an MRI scanner, imaging center, hospital etc. More than one producer 3002 can be used to load DICOM data to the network 3000 as shown. For purpose of illustration, the producers 3002 have been labeled Facility A, Facility B, and Facility N. The facilities can be at the same or entirely different locations. One or more DICOM sources 3112 for each producer 3002 are typically related to a harvester 3114. The harvester 3114, in one embodiment, can be a computer, server or similar device for receiving the DICOM source 3112 and communicate with the medical information network 3000 through the Internet.

In one embodiment, two or more harvesters 3114 can be provided within a producer 3002. The DICOM sources 3112, in such an embodiment, can be divided into multiple parts and then transferred to the medical information network 3000. Parallel processing techniques, known to those skilled in the relevant art, can be used.

As described above, the DICOM record was split into personal information and non-personal information. The personal information and the non-personal information included an identifier to link the personal information to the non-personal information. Splits within the DICOM data can be performed by the producer 3002, and more specifically the harvester 3114. Those skilled in the relevant art will appreciate that the split can be performed at another location that can be outside of the producer 3002. The producer 3002 can encrypt the personal information and add an encryption key. The record can then be stored into the medical information network 3000 having an electronic address, the record including the personal information and the non-personal information.

The personal health information and the anonymized DICOM image can be transported over the Internet or other network using known protocols. As shown in FIG. 31, the personal health information from each of the producers 3002 can be provided to a study metadata database 3102. The database 3102 can include fields for storing the personal information, encryption key and electronic address of the source node on which the record is stored. The study metadata database 3102 can be at one location or distributed among different sites. Algorithms for accessing the information will be described in a following related application.

The anonymized DICOM image, in accordance with the shown embodiment, can be provided to different servers 3106 within the DICOM repository 3104. Each of the servers 3106 can be distributed over the Internet or over some other network. The distributed repository 3104 can include one or many servers 3106 for storing the anonymized DICOM images. Server 1 3106 to Server N 3106 are nodes that can be split out over a distributed system such as a cloud, with N representing the fact that many servers 3106 can be used.

Each server 3106 within the DICOM repository 3104 can store multiple images. These images can have a global resource address identified by a Facility ID, Study UID, and Image UID. Typically, the same images are distributed through each server 3106, when possible. The Facility ID, in one embodiment, represents the producer 3002 that is providing the message, for example, the Facility ID can be Facility A, Facility B and up to Facility N. The Study UID can represent the unique identifier for the study that an image is related to. The Image UID describes the specific image unique to each study. As will be shown below, the study can include numerous images.

The servers 3106 within the DICOM repository 3104 can include each image and in one embodiment, copies of each image are provided through the servers 3106. The cloud-like nature of the repository 3104 allows copies to propagate through the servers 3106. The servers 3106 can each store a copy of the anonymized DICOM image therein. The server 3106 can point to DICOM data or non-DICOM data. For example, as shown in FIG. 31, Server 1 3106 can include images having the global resource addresses of “Facility A.Study UID.Image UID and Facility B.Study UID.Image UID.” Each image can be stored based on a file system layout convention and a file naming convention. Global resource addresses are dynamically constructed, on demand, upon receiving a web based request for a given image within a specific image study. This construction stands in stark contrast to conventional solutions where global resource addresses are statically created, stored in a database, and retrieved from a database. Such a conventional solution is inherently limited and often does not scale horizontally.

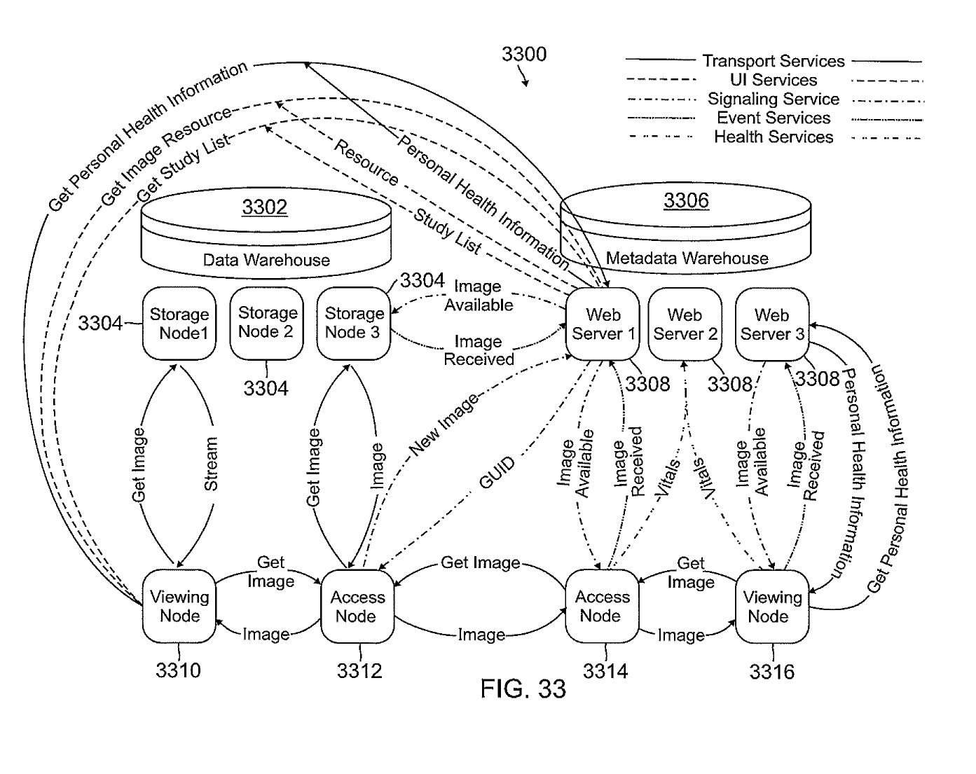

Individual pieces of hardware can be provided for each server 3106. The servers 3106 can be horizontally scalable meaning that they have the ability to connect with multiple hardware or software entities so that they work as a single logical unit. In the case of servers, speed or availability of the anonymized DICOM images is increased by adding more servers 3106, typically using clustering and load balancing. The horizontal scalable array of systems can be globally addressable as shown in FIG. 32. Images sourced from disparate medical institutions can be combined in a single logical repository and provisioned by up to N Servers 3106. The anonymized DICOM image can be globally accessible across disparate medical facilities, and be found easily with the addressing scheme.

Each individual DICOM image can be located within the medical information network 3000 through a unique address, otherwise known as a global resource address 3202. The global resource address 3202 can take the form shown in FIG. 32, or other embodiments known to those skilled in the relevant art. The global resource address 3202 can be used to access each image that can be stored within the DICOM repository 3104. The Facility ID 3204 of the global resource address 3202 can be multi-tenant and indicates which healthcare facility 3002 produced the image.

In addition to the Facility ID 3204, the Study UID 3206 can be provided within the global resource address 3202. Each study can have its own identification and is typically unique to the facility providing the study. An Image UID 3208 within the global resource address 3202 is typically provided for each image within the study and is generally unique to the study. The global resource address 3202 can be unique to the DICOM repository 3104 as this provides cross-facility and multi-tenant configurations. Data from multiple sites in one repository 3104 can be globally addressable through the use of the global resource address 3202.

Returning to FIG. 31, to access the DICOM images, the record can be transmitted from a source node or server 3106 to a target node or consumer 3004. The record can be provided through on demand processing. On demand processing can include providing study catalogs, anonymized DICOM images, and enriching the metadata in the metadata repository 3104. For the personal health information, the study metadata repository 3102 can transmit the personal information from the server to the target node or consumer 3004. The personal information, being encrypted prior to transmission, can be decrypted by the consumer 3004. The medical imaging record can be formed on a record consumer computer using the decrypted personal information and coupled with the anonymized DICOM image.

Depicted within FIG. 33, the medical information network 3000 can be represented as a grid 3300 in accordance with one aspect of the present application. The grid 3300 can include a data warehouse 3302 having storage nodes 3304. The storage nodes 3304 can be implemented by the servers 3106 discussed previously. The grid 3300 can also include a metadata warehouse 3306, which was referred to earlier as the study metadata database 3102. Central index web servers 3308 can be associated with the metadata warehouse 3306.

A viewing node 3310 coupled to the data warehouse 3302, access node 3312 coupled to the data warehouse 3302, access node 3314 coupled to the metadata warehouse 3306, and viewing node 3316 coupled to the metadata warehouse 3306 can all be provided within the grid 3300 as provided. Shown below, the grid 3300 can be made up of centrally managed nodes and services.

In one embodiment, the services can be implemented using Representational State Transfer (REST) based web services. Generally stated, REST is a simple technique for defining how resources are defined and addressed in a distributed application. REST can provide a simple interface for transmitting domain-specific data over HTTP without requiring additional messaging layers such as SOAP or session tracking via HTTP cookies. It is lightweight, human readable, unambiguous, and resource oriented.

The grid 3300 can be implemented using HTTP web services. Generally, there is no custom socket code and no custom protocols, file transfer or otherwise. The application of standard web services to a peer-to-peer grid 3300 with equivalent, parallel support for streaming and store and forward services can be implemented into the web services, at least within the narrower confines of HIPAA compliant content management. As shown in FIG. 33, a scalable web service can allow every node to be addressable and accessible by every other node. This generally can use either an open, inbound HTTP port for each node, or as a higher latency and higher cost compromise, a reverse proxy in the cloud for a node where an inbound HTTP port is not actionable.

The grid 3300 can provide several services minimizing image acquisition latencies and the perception of those latencies by users. In addition, the grid 3300 can be as responsive as any other multi-media Internet application dealing with large data sets of rich content. The grid 3300 can allow for hundreds of thousands of nodes, hundreds of thousands of users, and large amounts of data.

Typically, the grid 3300 can be platform independent and capable of supporting a localized user interface (UI) and localized DICOM content. It can also support DICOM compliant PACS, modalities, and viewers. The grid 3300 can be integrated with electronic medical record (EMR) applications through health level seven (HL7) and web service interfaces and can also update itself with new code on an as-needed and as-desired basis.

The grid 3300 can provide numerous capabilities and features. For purposes of illustration, and shown within FIG. 33, a viewing node 3310 can allow users to access the data warehouse 3302. In one typical operation, the viewing node 3310 can send a request to get an image from storage node 1 3304. In return, storage node 1 3304 can stream the image to viewing node 3310. In another operation, the viewing node 3310 can also access the metadata warehouse 3306. As shown, the viewing node 3310 can access the metadata warehouse 3306 through web server 1 3308. The viewing node 3310 can send a request to get personal health information (PHI) and in return, the web server 1 3308 can provide the PHI from the metadata warehouse 3306. The viewing node 3310 can also request for image resources and study lists. The viewing node 3310, in typical embodiments, can interact with other nodes such as access node 3312. In one operation, the viewing node 3310 can send an image request to the access node 3312. In response, the access node 3312 can return an image to the viewing node 3310.

With reference now to the access node 3312 of FIG. 33, in one operation, images can be sent to storage node 3 3304 after an image request is sent by storage node 3 3304. In other operations, the access node 3312 can both send and retrieve images to and from the storage nodes 3304. The access node 3312 can also interact with the metadata warehouse 3308. A new image request can be made and in return, the web servers 3308 can provide a GUID.

While three storage nodes 3304 are shown having access to the data warehouse 3302, one skilled in the relevant art will appreciate that there can be fewer or more storage nodes 3304. Furthermore, the storage nodes 3304 can interact with each other. The storage nodes can also interact with the web servers 308 associated with the metadata warehouse 3306. As shown in FIG. 33, web server 1 3308 can send a request to determine if an image is available from storage node 3 3304. If the image is available storage node 3 3304 can send the image to web server 1 3308.

As previously shown, the metadata warehouse 3306 can include information regarding images on the data warehouse 3302, for example, PHI, image resources, and study lists. Vitals can be sent to the metadata warehouse 3306 by access node 3314 and viewing node 3316. In addition, access node 3314 can receive image availability requests and notify the web server 1 3308 that the image has been received. Access node 3314 can interact with viewing node 3316 to retrieve images. Viewing node 3316 can also receive image availability requests and return whether or not the image has been received. In another operation, the viewing node 3316 can send a get PHI request and in return, web server 3 3308 can provide the PHI.

While numerous operations have been shown for grid 3300, one skilled in the relevant art will appreciate that there can be other nodes and features provided therein. The configuration provided above has been presented for purposes of illustration. The nodes provided above can be deployed at medical imaging facilities. They can not only act as image consumers 3004, but as providers 3002 as well. While only a handful of nodes were shown, one skilled in the relevant art will appreciate that there can be more. In addition, an arbitrary number of these gateways can be deployed.

Those skilled in the relevant art will appreciate that the grid 3300 can provide a cloud storage along with store and forward capabilities. In some embodiments, the grid 3300 can provide a streaming transport into a centrally managed peer-to-peer platform that demands support for distributed asynchronous create, read, update, and delete (CRUD). This is a challenging problem and a significant implementation challenge for the grid 3300. As such, asynchronous CRUD can be provided in the very communication fabric of the grid 3300. Signaling services can also be provided that command and control messages used to implement grid-wide CRUD.

One way to achieve distributed asynchronous CRUD is with an architectural pattern called Staged Event-Driven Architecture, also known as SEDA. Synchronous services typically do not scale well while asynchronous services can introduce unacceptable levels of latency and non-determinism. SEDA can make extensive use of queuing to address these challenges. SEDA is an approach to software design that decomposes a complex, event-driven application into a set of stages connected by queues. This architecture avoids the high overhead associated with thread-based concurrency models, and decouples event and thread scheduling from application logic. By performing admission control on each event queue, the service can be well-conditioned to load, preventing resources from being overcommitted when demand exceeds service capacity.

Described above, cloud based services were provided by the medical information network 3000. The grid 3300 provided a further breakdown of the medical information network 3000 into nodes that were capable of being deployed in a cloud with the nodes capable of receiving payloads and serving payloads. The cloud abstracts details for both the producers 3002 and the consumers 3004 who no longer need knowledge of, expertise in, or control over the technology infrastructure within the cloud that supports those features described above. This generally involves the provision of dynamically scalable and often virtualized resources as a service over the Internet.

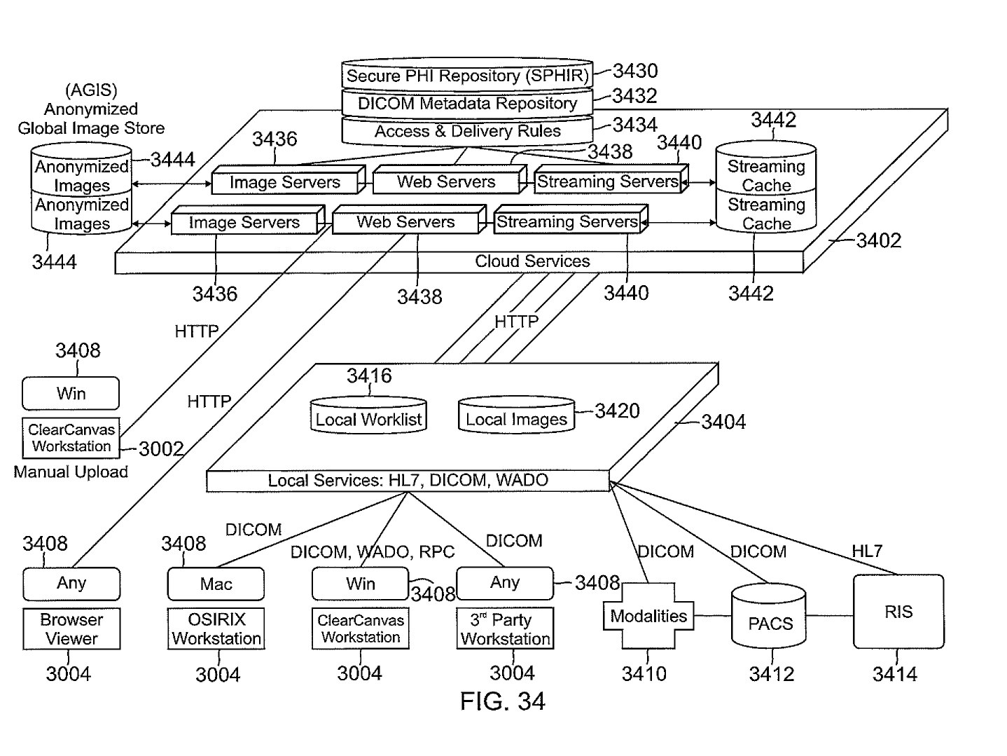

With reference now to FIG. 34, a block diagram representing typical cloud services 3402 and local services 3404 in accordance with one aspect of the present application is provided. This depicts one embodiment and should not be construed as limiting the scope of this application. Producers 3002 and consumers 3004 can interact with these services for the acquisition, hosting, and distribution of medical images.

As shown, a producer 3002, such as a DG workstation, can manually upload images to the cloud services 3402. The producer 3002 can run on an operating system 3408 such as WINDOWS or the like. As provided for earlier, the producer 3002 can send the images in an event driven manner to the cloud services 3402. The images can be sent through HTTP to the web services 3438 provided on the cloud services 3402. The images can be split into two components: a personal portion including the PHI and a non-personal portion having the anonymized DICOM image.

After the images are provided to the cloud services 3402, consumers 3004 can retrieve those images through queries or similar methods from the cloud services 3402. The images can be retrieved either directly from the cloud services 3402 or through the local services 3404. In the present embodiment, the consumer 3004 can be represented as a browser viewer, which is shown in the lower left hand corner of FIG. 34. The browser viewer 3004 can be executed on generally any type of operating system 3408. The operating system 3408 with the browser viewer 3004 can directly connect with web services 3438 provided by the cloud services 3402. One skilled in the relevant art will appreciate that there can be numerous types of consumers 3004 that can connect to the cloud services 3402 for retrieving those images uploaded earlier from producers 3002 and is not limited to a single representation.

The consumers 3004 can also be coupled to local services 3404. Generally, each consumer 3004 includes an operating system 3408. Typical consumers 3004 can include an OSIRIX workstation, a CLEARCANVAS workstation, and a 3^{rd} party workstation. The consumers 3004 can access the local services 3404 through operating systems 3408 such as MAC, WINDOWS, or any other type of suitable operation system.

Also attached to the local services 3404 are modalities 3410, PACS 3412, and Radiology Information Systems (RIS) 3414. The modalities 3410, PACS 3412, and RIS 3414 can be interconnected. The local services 3404 can include HL7, DICOM, and WADO as shown. Communications between the operating systems 3408 of the consumers 3004 can interact with the local services 3404 through DICOM. In addition, WADO and RPC can be used. Communication between the modalities 3410 and the local services 3404 can include DICOM. Communications between the PACS 3412 and the local services 3404 can include DICOM. The RIS 3414 can communicate with the local services 3404 using HL7.

The local services 3404 can incorporate a local worklist database. The local services 3404 can also include a local image store 3420. Coupled to the local services 3404 can be the cloud services 3406. Through these connections, third party viewers 3004, modalities 3410, PACS 3412, and RIS 3414 can access the cloud services 3406. Generally, communications between cloud services 3402 and local services 3404 are through HTTP.

The cloud services 3402 can include image servers 3436, web servers 3438, and streaming servers 3440 which were described in details above. The image servers 3436 can be connected to a horizontally scalable anonymized image repository 3436. Continuing, the streaming servers 3440 can be coupled to streaming cache databases 3442. The cloud services 3402 can also include a secure protected health information (PHI) repository 3430, a DICOM metadata repository 3432, and access & delivery rules 3434.

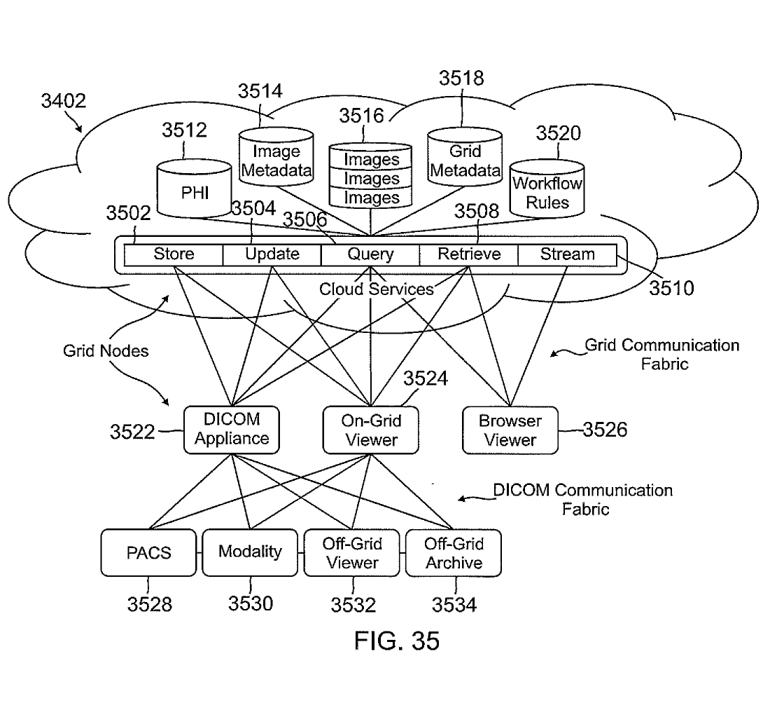

FIG. 35 depicts features provided by the exemplary cloud services 3402 in accordance with one aspect of the present application. The cloud services 3402 can provide many services that include, but are not limited to, store 3502, update 3504, query 3506, retrieve 3508, and stream 3510. These services can be connected to numerous databases. These databases can include a PHI repository 3512, image metadata database 3514, image repository 3516, grid metadata database 3518, and workflow rules database 3520. The services can be provided through grid nodes and a grid communication fabric.

Through the grid communication fabric, a DICOM appliance 3522 can interact with the store 3502, update 3504, query 3506, and retrieve 3508 services. The RIS/PACS appliance 3522 can also interact with an on-grid viewer 3524. The on-grid viewer 3524 can interact with the store 3502, update 3504, query 3506, and retrieve 3508 services. A browser viewer 3526 can interact with the query 3506, retrieve 3508, and stream 3510 services.

Coupled to the DICOM appliance 3522 and the on-grid viewer 3524 can be a series of DICOM devices connected through a DICOM communication fabric. These devices can include a PACS 3528, modality 3530, third party viewer 3532, and an off-grid archive 3534.

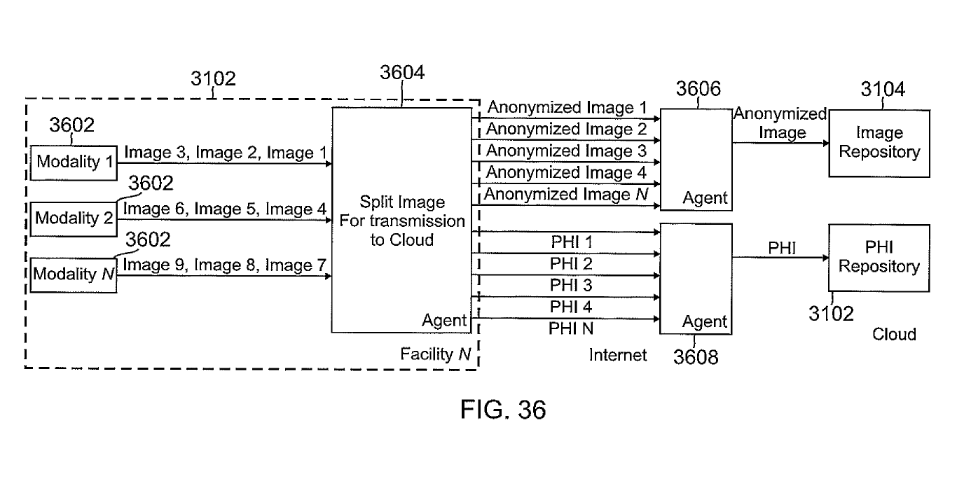

FIG. 36 is a block diagram showing an illustrative timing sequence for uploading DICOM files to the repository 3104 as well as the database 3102. This illustration represents one embodiment, but should not be construed as the only embodiment for uploading medical imaging records to the cloud. Modalities 3602 can be used to provide multiple images in sequential order with each modality being located on a producer 3102. For example, Modality 1 3602 can provide Image 1 followed by Image 2 and Image 3. Modality 2 3602 can provide Image 4, Image 5 and Image 6 and Modality N 3602 can provide Image 7, Image 8 and Image 9. Modalities 1, 2 and N 3602 can upload their images at the same time to agent 3604.

At agent 3604, the medical imaging records provided by the modalities 3602 can be split into personal information and non-personal information i.e. anonymized images and PHIs. Algorithms known to those skilled in the relevant art can be used to split the medical image records. Continuing with the previous illustration, images 1 through 9 can be split into anonymized images and PHIs. In turn, agent 3606 can receive the anonymized images simultaneously. In one embodiment, the agent 3606 can receive the anonymized images in any order meaning that anonymized image 3 can reach the agent 3606 before anonymized image 2 can. Agent 3608 can be used to receive the PHIs. The agent 3608 can receive the PHIs in any order meaning that PHI 4 can reach the agent 3608 before PHI 1 can. In one embodiment, the agents 3606 and 3608 can reorder the anonymized images and PHIs before sending them out.

The agents 3606 and 3608 can then communicate with the image repository 3104 and PHI repository 3102. The agents 3606 and 3608 can store the split medical imaging record in a cloud where the image repository 3104 and PHI repository 3102 are located. As shown in FIG. 36, timing sequences were provided indicating the flexibility of uploading images.

In FIGS. 30 through 36, a logical repository of cross-facility, anonymized DICOM image files with a corresponding logical repository of cross-facility PHI data were described. The system provides the ability to store annotations, radiology reports, and other imaging-related non-DICOM data in a global repository. Each anonymized DICOM image file can be individually indexed and Internet addressable through the global resource address. The global index for anonymized DICOM files and imaging-related non-DICOM data files can be distributed across an arbitrary number of functionally equivalent index servers. The global repository of anonymized DICOM image files and imaging-related non-DICOM data files can be horizontally scalable with the files being distributed across an arbitrary number of functionally equivalent storage servers.

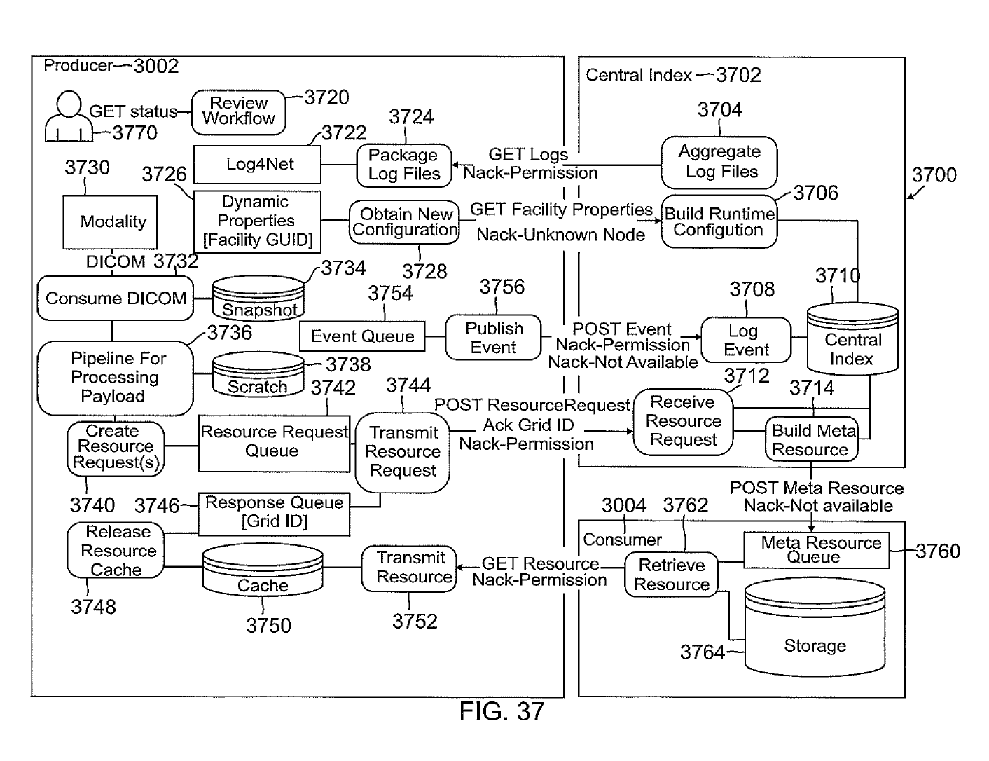

Turning now to FIG. 37, illustrative features for a grid workflow 3700 in accordance with one aspect of the present application are provided. The grid workflow 3700 can include a producer 3002, a central index 3702, and a recipient 3004. One skilled in the relevant art will appreciate that additional components can be included and the configuration presented herein does not limit the scope of this application. The central index 3702 can process images and interact with the producer 3002 and the consumer 3004. In one operation, the central index 3702 can provide log files through an aggregate/log files module 3704. In another operation, the central index 3702 can receive facility properties through a build runtime configuration module 3706. The runtime configuration can then be provided to the central index database 3710.

The central index 3702 can receive posting events from the producer 112 as well. These posting events can be sent to a log event module 3708 and then to the central index 3710. A receive resource request module 3712 can receive a resource request from the producer 112 and provide the request to the build meta resource module 3714 or the central index database 3710. The build meta resource module 3714 can send the meta resource to the consumer 3004.

Through the central index 3702 each image received from the network 100 can be assigned a globally unique identifier and registered in the Internet resident central index database 3710. The central index 3702 can track the location and disposition of each discrete DICOM image.

With reference now to the producer 3002, the producer 3002 can interact with both the central index 3702 and the consumer 3004. The producer 3002 can allow a user 3720 to review grid workflow 3700. In another operation, the producer node 3002 can include a log4net module 3722 that is coupled to a package log files module 3724. The package log files module 3724 can receive aggregated log files from the central index 3702. In addition, the producer 3002 can provide a dynamic properties [facility GUID] module 3726 that can be coupled to an obtain new configuration module 3728. The obtain new configuration module 3728 can send facility properties information to the central index 3702. An event queue module 3754 can also be provided within the producer 3002. Coupled to the event queue module 3754 can be a publish event module 3756 that provides an event to the central index 3702.

The producer node 3002 can also include a modality module 3730 which can be coupled to a consume DICOM module 3732. The consume DICOM module 3732 can be coupled to a snapshot database 3734 and a pipeline for processing payload module 3736. The pipeline for processing payload module 3736 can be coupled to a scratch database 3738 and a create resource request(s) module 3740. The create resource request(s) module 3740 can be coupled to a resource request queue 3742 which can then be coupled to a transmit resource request module 3744. The transmit resource request module 3744 can provide resource requests to the central index 3712.

Continuing, the transmit resource request module 3744 can be coupled to a response queue [grid ID] module 3746. The response queue [grid ID] module 3746 can be coupled to the release resource cache module 3748 which can be coupled to cache 3750. The cache can be coupled to a transmit resource module 3752. The transmit resource module 3752 can receive resources from the consumer 3004.

Generally described, the producer's 3002 nominal state can be waiting for DICOM associations for the modality module 3730. The modality module 3730 associates with the central index 3702 to send a DICOM image. The producer 3002 can commit the DICOM image to disk and begin the processing pipeline. The current pipeline includes hashing the DICOM image, anonymizing the DICOM header information, creating the anonymous image, hashing the new image, and compressing the image. In other embodiments, the image can be processed on the central index 3702.

The producer 3002 can then submit an image resource request to the central index 3702 sending the DICOM header information in the request. The central index 3702 can use the DICOM header information to determine if the image is new or it is an update to an existing image. The central index 3702 can return either a new grid identifier or the grid identifier to update. Each image can be uniquely identified on the grid 3300 by the following formula HarvesterUUID+“.”+ResourceUUID. The producer 3002 can then move the anonymous-ized image to the producer's 3002 cache 3750.

The producer 3002 can answer requests for resources. If a resource exists with the given grid Id, it is returned otherwise an error can be returned. An “Error 404” can be returned if the resource has not been released to cache or does not exist. An “Error 410” can be returned when the resource has been marked for deletion.

Continuing with FIG. 37, a consumer 3004 can interact with the producer 3002 and the central index 3702. The consumer 3004 can include a retrieve resource module 3762 for retrieving a resource from the producer 3002. The retrieve resource module 3762 can be coupled to a storage database 3764. A meta resource queue module 3760 can receive a meta resource from the central index 3702.

The nominal state for the consumer 3004 can be waiting for notifications to retrieve and cache resources. The consumer 3004 can register the criteria for the resources it wishes to receive with the central index 3702. This can be modeled after the Whiteboard Pattern from the OSGi framework. The event source and listener can be de-coupled at the central index 3702. The additional overhead of this decoupling is warranted by the operational management afforded and the nature of the public Internet.

Central index 3702 notifications can be queued on the node and prioritized based on grid Id, priority, and time. Collisions on the grid Id can overwrite the old meta resource with new meta resource through an event compression. The priority allows the central index 3702 to impact the order of processing of queued meta resources. Priorities can be used to enhance interactive viewing over auto-forwarded studies.

The storage 3764 of the consumer node 3004 can be accessed by the central index 3702 or the producer 3002. The central index 3702 can send a meta resource to the storage 3764 which includes the current locations of the file to be retrieved. The storage 3764, based on its QOS requirements, can transfer and store the resource. The locations of a resource are ranked by the central index 3702. Criteria that can be applied to ranking include: network proximity, network load balancing, transmission costs, etc. Locations can be either LAN or WAN addresses depending on the deployments and configurations of the producer 3002 and consumer 3004. Any peer node can request a resource from the storage 3764. If a resource exists with the given grid Id it is returned otherwise an error can be returned. An “Error 404” can be returned if the Resource has not been retrieved from the producer 3002. An “Error 410” can be returned when the resource has been marked for deletion.

A viewer can also be placed on the consumer 3004. A user can initiate an interactive query to retrieve resources from the data warehouse. Peer nodes can request a resource from the viewer. If a resource exists with the given grid Id it is returned otherwise an error is returned. An “Error 404” can be returned if the resource does not exist on this node. An “Error 410” can be returned when the resource has been marked for deletion.

In one embodiment, image copies can be provided. Each gateway device can stage a copy of each registered image for upload to a highly redundant cloud storage facility using strongly authenticated web services. Each gateway device contains sufficient local storage to hold a copy of each registered and uploaded image for a user-specified period of time, for instance three months, six months, twelve months, or some other period of time. A timestamp can be placed on each copied image.

In one embodiment, the grid workflow 3700 can provide web service based messaging. The nodes within the grid workflow 3700 can message each other using strongly authenticated web services. These messages can encompass the full range of application messaging including signaling, eventing, performance monitoring, and application diagnostics. In addition, the grid workflow 3700 can provide web service based data propagation. The nodes can propagate image payloads between each other using strongly authenticated web services, using a client-server relationship.

As described above, the nodes can be architectural peers. They can communicate with each other exclusively through strongly authenticated web services. The nodes can have a flat namespace. With adequate network accessibility and proper authentication, the nodes can communicate with each other. The nodes can act both as a web service client and a web service server. This design allows a distributed network of content delivery nodes. Some nodes can be deployed within the infrastructure of a medical facility.

Some nodes can be capable of being deployed in a cloud. The nodes can be capable of receiving payloads. The nodes can be capable of serving payloads. The central index 3702 can rank the nodes according to their capacity and throughput capabilities. This ranking data can optimize the actual distribution of data.

In the previous design, diagnostic grade medical images were placed into a single image study file, stored in a cloud, and forwarded to down streaming physicians using peer to peer file sharing. This design mimicked legacy manual processes for aggregating and transporting medical images. In contrast, the medical information network 3000 presently provided can be an event driven web application for perpetual storage and collaborative access to medical images for patients and physicians. It can be a multi-media Internet application with all the utility, simplicity, and accessibility one would expect from any other rich content, multi-media Internet application, with the unique requirement of HIPAA compliant content management and delivery. As will be shown below, the medical information network 3000 can incorporate numerous features and operations using the grid workflow 3700 and nodes provided above.

When anonymized DICOM images propagate on the grid 3300, they can be provided in a store and forward manner. A local copy can be retained for a period of time on the producer 3002, and a new copy can be created on the authorized and qualified consumer 3004. This can allow data to propagate organically across the content delivery network. The medical information network 3000 can provide store and forward transport of discrete images as well as session based streaming of discrete images. Both transport modes can leverage image orientation and incremental download of target images. Session based streaming supports incremental resolution that can allow a rapidly acquired low resolution rendition of an image to gradually increase in resolution over time until a full fidelity image is rendered in real time.

The medical information network 3000 can expose discrete images in the cloud and can enable the dynamic assembly of those images into series and studies. The network 3000 image repository thus acts more like a data warehouse and less like a transactional data store. In addition, an actual image viewer can be located off the medical information network 3000. The network 3000 can also provide for an image viewer on an interactive client.

The central index 3702 can also contain data driven routing rules. These rules can be distribution instructions that are triggered by the metadata associated with a given DICOM image. The majority of this metadata can be contained within the DICOM data structure.

For interactive users, it is desirable to support streaming data acquisition. By design, each node in the content delivery network is capable of supporting both streaming and store and forward interfaces. A single node or any number of nodes in parallel could stream data to an interactive web client like a web browser.

An end user can use a graphical software application with an embedded content delivery node to interactively query the central index 3702 for images in a given image study. The central index 3702 can return a ranked list of nodes where those images reside. The embedded node can process this list and attempt to acquire images from nodes in the list using authenticated web services. The embedded node can have the option, based on user preference, to acquire the DICOM images as a single payload or to have the DICOM images streamed incrementally.

Images can be simultaneously acquired from multiple nodes and provided to a single recipient process like a web browser. Each discrete image can be requested in a strongly authenticated web service call. These requests can happen in parallel. The receiving node can present the inbound DICOM images to the graphical application for appropriate processing. This can allow the rapid acquisition of DICOM images downloaded from multiple sources significantly accelerating data acquisition and improving the interactive user experience. This image oriented, peer-to-peer content delivery network can facilitate the rapid acquisition of high value images.

As briefly described, the DICOM protocol generally is not study-oriented. As such, there is no protocol level definition for the canonical beginning or ending of an image study. An image study is an abstraction, an aggregation of images, grouped into series, sharing the same QUID. Discrete images are atomic to the DICOM protocol. The medical information network 3000 of the present application can leverage the reality of discrete images as the basic atom of collaborative medical image workflows.

In some embodiments, the medical information network 3000 can provide a pull transport instead of a push transport. The recipient can initiate a connection to the sender and retrieve an atom of value, typically a discrete DICOM image. Combined with image-oriented transfer, this lets multiple nodes simultaneously serve images to a single recipient node, substantially reducing latency for the transport of diagnostic grade image studies.

The grid 3300 can support peer-to-peer transport services and session based streaming transport services. Streaming services can use an image format that supports incremental resolution in a remote client. Peer-to-peer transport services can use lossless compression for full diagnostic grade image quality. In one embodiment, PEG 2000 can be used.

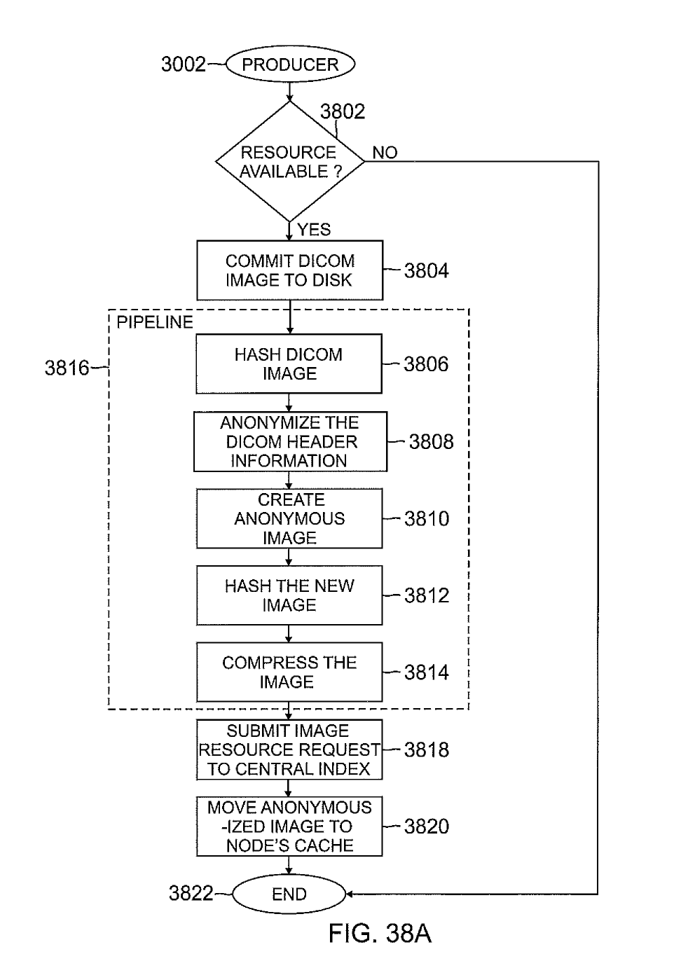

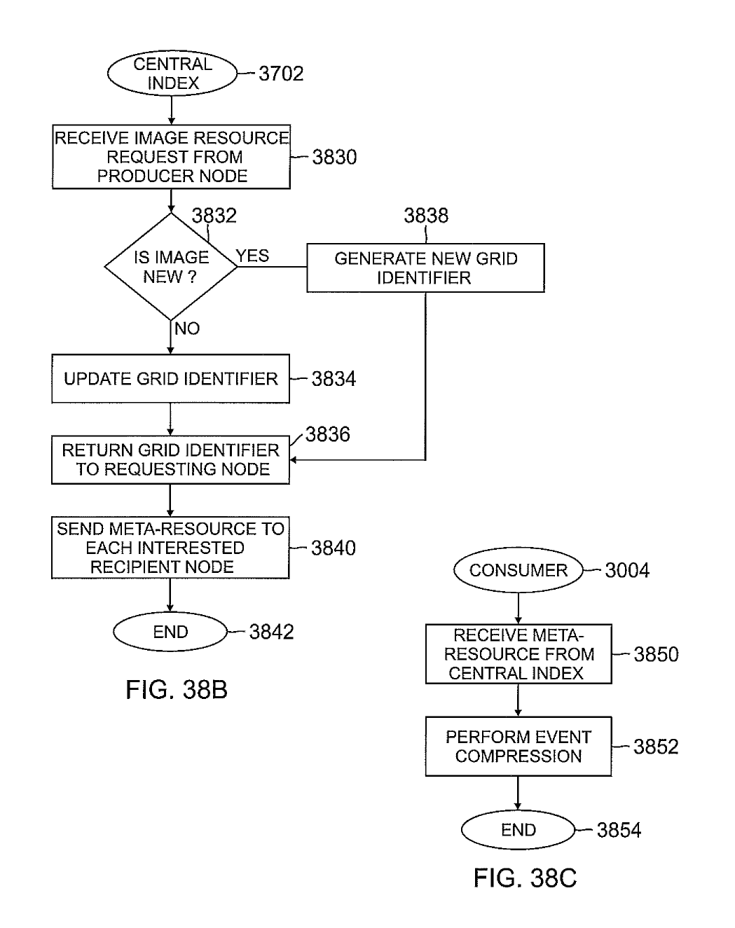

The medical information network 3000 will now be described in terms of specific processes performed by the producer 3002, consumer 3004 and central index 3702. Those skilled in the relevant art will appreciate that these processes are for illustrative purposes and should not be construed as limiting to the scope of the present application. Above, the producer 3002 was described as being capable of generating images and uploading those images for distribution to the medical information network 100. Turning to FIG. 38A, illustrative processes for the producer node 3002 for uploading data to the central index 3702 is provided. These processes are for illustrative purposes and should not be construed to limit the present application. The producer node 3002 can determine whether there are any resources available for uploading the image at decision block 3802. Generally, the resources are maintained by the central index 3702. When no resources are available, the producer node 3002 ends the processes at block 3822.

At block 3804, the DICOM image can be committed to disk. This allows for the image to be stored and wait for further processing. When processed, the image can go through a pipeline 3816. The pipeline 3816 can refer to a series of processes that the producer 3002 performs to the image. In another embodiment, the central index 3702 can perform the processes when the image is received.

Within the pipeline 3816 can be a series of processes. While several processes are shown, the processes shown herein are not intended to limit the present application. At block 3806, the DICOM image can be hashed. At block 3808, the producer 3002 can anonymize the DICOM header information. At block 3810, an anonymous image is created. The created anonymous image can be hashed at block 3812. The pipeline 3816 continues at block 3814 where the created image is compressed.

Out of the pipeline 3816, at block 3818, the producer 3002 can submit the image resource request to the central index 3702. The anonymous-ized image can be moved to the node's cache at block 3822 ending the process at block 3822.

The producer 3002 can then send the image to the central index 3702 whereby it is processed as shown in FIG. 38B. At block 3830, the central index 3702 can receive an image resource request from the producer 3002. Web services provided by the grid 3300 can include strongly authenticated web services. At decision block 3832, the central index 3702 can determine whether the image is new. Generally, this can be accomplished through the UUID. Those skilled in the relevant art will appreciate that other technologies exist for determining whether the image has or has not changed.

When the image is new, the central index 3702 generates a new grid identifier for the image at block 3838. Typically, each new image receives a new identifier making the system and method described herein image based instead of study based. The process continues at block 3836. If the image is not new, then the central index 3702 updates the grid identifier associated with the old image at block 3834. At block 3836, the central index 3702 can return the grid identifier to the requesting node i.e. the producer node 3002. At block 3840, the central index 3702 can send a meta resource to each interested consumer 3004. The processes end at block 3842.

FIG. 5C is a flow chart showing simple processes performed by an exemplary consumer 3004 in accordance with one aspect of the present application. At block 3850, the consumer 3004 can receive a meta resource from the central index 3702. At block 3852, the consumer 3004 can perform an event compression and the process ends at block 3854.

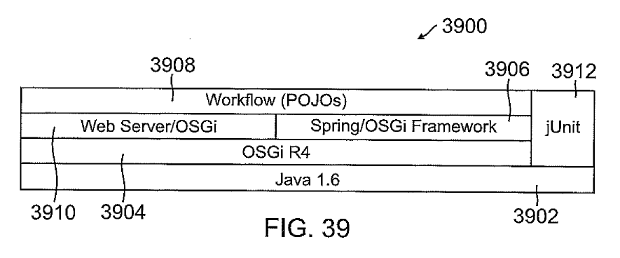

In the previous FIGURES, nodes were provisioned with the same infrastructure and capable of deploying services at run time to fulfill their role on the grid 3300. Each node can be assigned a unique UUID, used as its address on the grid 3300. In one embodiment, the grid 3300 can be built on a node deployable stack 3900 as depicted in FIG. 39. In one embodiment, the grid 3300 can be built on a Java platform 3902 to leverage Java's networking technologies and to provide cross platform support. The OSGi Service R4 Platform 3904 can promote scalability and maintainability by providing Java a versioned plug-in system 3912 that can be monitored in real-time and allows the deployment of new objects on live systems. The Spring/OSGi Framework 3906 can use the inversion of control pattern to manage the relationships between POJO Objects 3908. Dependency injection can remove the dependency on any one container API further simplifying the business objects.

A light-weight HTTP Web Server 3910 can be the end point for the web services. Business objects can be POJOs 3908 implementing the work flow for the grid application layer, e.g., auto-routing, study manager, etc. To improve readability in FIG. 39, not every possible service is included for every node. Nodes are expected to be routable from the network 3000 to maximize performance of the grid 3300.

When connecting to the network 3000, some exemplary configurations are provided below. In one configuration, the node is NAT'ed or PAT'ed through a firewall. The configured port can be accessible via the network 3000. In another configuration, the UPnP can be through a firewall. A requested port can accessible via the network 3000 while the grid 3300 is running and the router supports the protocol. The central index 3702 can learn the node's global IP address when the node “pings”. Safety and Occupational Health Office (SOHO) deployed viewing nodes are expected to be of this type. Notifications and producer services can be delayed if the cached IP address at the central index 3702 is out of date.

In another configuration, the nodes can communicate with the network 3000 through a tunneled reverse proxy with the remote end point anchored at the central index 3702. This deployment can open a tunnel to the central index 3702 which can be used for signaling. Resources can be retrieved directly from the producer 3002. This type of deployment cannot generally support any producer services, e.g. harvester, study update, etc. Notifications can be delayed because of the additional layers of software and network overhead. Additionally, this is the most expensive type of node for the grid 3300 to deploy.

The DICOM images can be stored in a flat namespace and users can query for the images via strongly authenticated web services. DICOM tags can be within each DICOM image file and can be queried for. An image study can be dynamically assembled by querying the DICOM metadata, for example, facility, patient identifier, UID, and study type.

The image repository can expose the rich metadata of each image and allows a user to dynamically query the data most relevant to that user, without the opaque and artificial confines of an image study. The most relevant data within an image study is frequently a very small subset of the entire image study, for example, key images, or images with annotations, or only images specifically referenced in the radiology report. These high value images can be queried and acquired without being encumbered by the hundreds or thousands of low value images associated with the entire image study.

This does not preclude a user from querying all the images within a given image study. This is easily accomplished by querying based on the facility ID and study UID. But queries are not limited to a study based aggregation of images. This can unlock the clinical value of the rich DICOM metadata so the right images can be served to the right people at the right time within the clinical workflow. This can be made possible by flattening out the data model from a study oriented abstraction into an image oriented repository, and then exposing the DICOM metadata to programmatic and interactive queries.

Hosting this rich repository of discrete DICOM content on the Internet makes the data universally accessible. This facilitates the efficient acquisition of not only the most relevant images in an image study, but the corresponding images in prior imaging studies. The timely acquisition of priors is one of the least efficient processes in the radiological clinical workflow. The root cause of this inefficiency is silo-ed DICOM data—silo-ed on LANS and silo-ed within study-oriented application constructs. An image-oriented, Internet accessible, universal DICOM repository can address the root cause and enable dramatic improvements in radiological clinical workflow.

Previously shown in FIG. 30, a number of producers 3002 were coupled to a medical information network 3000. The network 3000 provided a DICOM Internet gateway that allowed communications on the producer 3002 side, possibly through an area network, and cloud based web services on the Internet side. DICOM images could be acquired off the area network from any DICOM device, typically a PACS or DICOM modality. The images could be acquired off the area network in real time and processed as they were received in an event-driven manner.

Generally, as discrete images are acquired, they can be assigned a GUID and fingerprinted using a hashing algorithm like SHA. In turn, the images can be logged into an Internet resident global repository of images and optionally anonymized by removing private health information from the DICOM header. The images can be optionally converted into a canonical DICOM compliant format like JPEG2000 and optionally encrypted using a symmetric encryption key. The images can be fingerprinted again using a hashing algorithm and uploaded to an Internet based image repository using strongly authenticated web services.

In typical operations, DICOM images are not assembled into image studies on the gateway device i.e. the producer 3002 or area network. Rather, they are dynamically uploaded to the Internet in an event-driven order in which they are received via the DICOM communication protocol. This can eliminate the need for timers or other DICOM receiving techniques that attempt to aggregate discrete images into complete image studies. The discrete images can be fingerprinted, secured, optionally transformed, and uploaded to the Internet in an event driven fashion. In addition, the images are generally not aggregated into studies in the Internet based image repository. Instead, they are individually indexed and stored in the cloud where they can be conveniently queried and retrieved at a later date.

The normative event in this event-driven processing is the reception of a complete DICOM image. These events occur within the broader context of a DICOM association, but can be independent of the convention used to implement the DICOM association. For example, a sending DICOM device can choose to send one image per association or multiple images per association without impacting the efficacy of the present application. This is effective across the entire universe of DICOM association implementations. It can be dependent solely upon receiving discrete DICOM images within the context of the DICOM protocol. The Internet upload process can begin once a discrete image is completely received.

Clinical imaging workflows can generate sequences of imaging events. The grid 3300 can process these events as they occur in real time or near real time. The granularity of this event processing can be dictated by the DICOM protocol itself, where the basic unit of work is a single DICOM wrapped image. These images can be propagated on the grid 3300 as they are submitted to the grid 3300 by each customer's clinical dataflow. These clinical dataflows can thus extend throughout the clinical chain of care to create collaborative medical imaging. This is in stark contrast to legacy imaging workflows and can thus enable, and perhaps even demand, clinical workflow optimizations. As events occur in the imaging workflow, they propagate in near real time to the grid 3300. As images are harvested, they can be processed and uploaded to the grid 3300. As images are uploaded to the grid 3300, they can be made available to downstream nodes.

The grid 3300 can be designed for either time based dataflow or event driven dataflow. This design decision is normative for the entire grid 3300 and for the clinical workflows that execute on the grid 3300. Event driven dataflow means low latency, near real time dataflow that reflects the natural cadence of clinical imaging workflows. Time based dataflow relies on timers, polling loops, and fixed point scheduling to manage clinical dataflow. Using timers and polling loops to manage dataflow for a wide area application creates the following challenges such as high levels of non-determinism for distributed asynchronous CRUD, artificially imposed dataflow latencies, artificially imposed dataflow cadences that mask the native event driven workflows, and fundamentally at odds with the non-deterministic nature of the DICOM protocol

Therefore, the grid 3300 can be event driven. This is a simple and powerful approach for dynamically propagating DICOM images by extending the native dataflow of the DICOM protocol throughout the Grid using standard web services. This approach leverages the inherent design and cadence of the DICOM protocol and eliminates the liabilities associated with time based processing. For this design principle to be effective, the entire grid 300 can be event-driven from initial data acquisition all the way through the last mile of data delivery.

By uploading the images to a universally acceptable queryable Internet repository, the clinically rich content of DICOM metadata can be universally accessible. Efficient clinical radiological workflow depends on timely and accurate acquisition of relevant DICOM data. The growth in the number and density of imaging studies aggravates this problem with a multiplication of data where it is increasingly difficult to identify and acquire relevant data without the cumbersome processes for manually sifting through large amounts of image data.

Data relevancy in clinical DICOM workflows can be a function of the many images within a study. For example, images can be tagged by a reading radiologist as a key image. This tagging typically occurs within a DICOM viewer application and the key image tag is generally embedded within the textual DICOM header of a discrete DICOM image. Other images can include images that have been annotated by a reading radiologist. This tagging can occur within a DICOM viewer application. The annotations are sometimes embedded within the textual DICOM header of a discrete DICOM image. In some embodiments, the annotations are sometimes saved in a proprietary file format. In other embodiments, the annotations are sometimes saved as a copy of the original DICOM image with the on-screen annotations overwriting portions of the binary image itself. Images can also include images that are identified in the radiology report associated with a given image study. The reading radiologist can textually identify specific images or sets of images within an imaging study. Images can include radiological clinicians using prior exams to determine the progression of a given clinical condition. Key images from a current exam are frequently compared against the corresponding images from previous imaging studies, sometimes going back many years. The acid test use case of solving the data relevancy problem for clinical radiological workflows is the timely and accurate acquisition and display of key images for a target area across the entire imaging history of a patient.

Key images can be directly queried from the Internet resident DICOM image and metadata repository by constraining the query with DICOM key image identifiers as defined by the DICOM standard. The mechanism for these queries can be strongly authenticated web services.

Once these images are acquired by the requesting application, adjacent images can also be queried from the repository. In one embodiment, this can be accomplished using the serial DICOM image ID metadata which sequentially numbers each image in each series of an image study. For example, if a given image has an image ID of ‘n’, then the adjacent images are ‘n−1’ and ‘n+1’. The next level of adjacency is achieved by querying for ‘n−2’ and ‘n+2’. In this manner, any level of adjacency can be pre-fetched by an application or interactively requested by a user in order to display the most relevant images at the most appropriate time.

In the case where annotated images are also tagged as key images, annotated images can also be acquired. In the alternative, annotated images can be transformed from a proprietary format and saved as DICOM tags as part of the image oriented upload process described above. This approach has the added benefit of normalizing proprietary annotations and rendering them interoperable within the context of the current application.

The acquisition of prior images is achieved by querying the DICOM metadata repository with constraints sufficient to identify the relevant studies for a given clinical use case. This can be accomplished by constraining the repository query with information uniquely identifying the patient and study type. Key images can be added as additional constraints in a single query for priors, or these constraints can be applied sequentially. Once acquired the images can be displayed in a date relevant manner by using the DICOM study date and image ID as the display criteria.

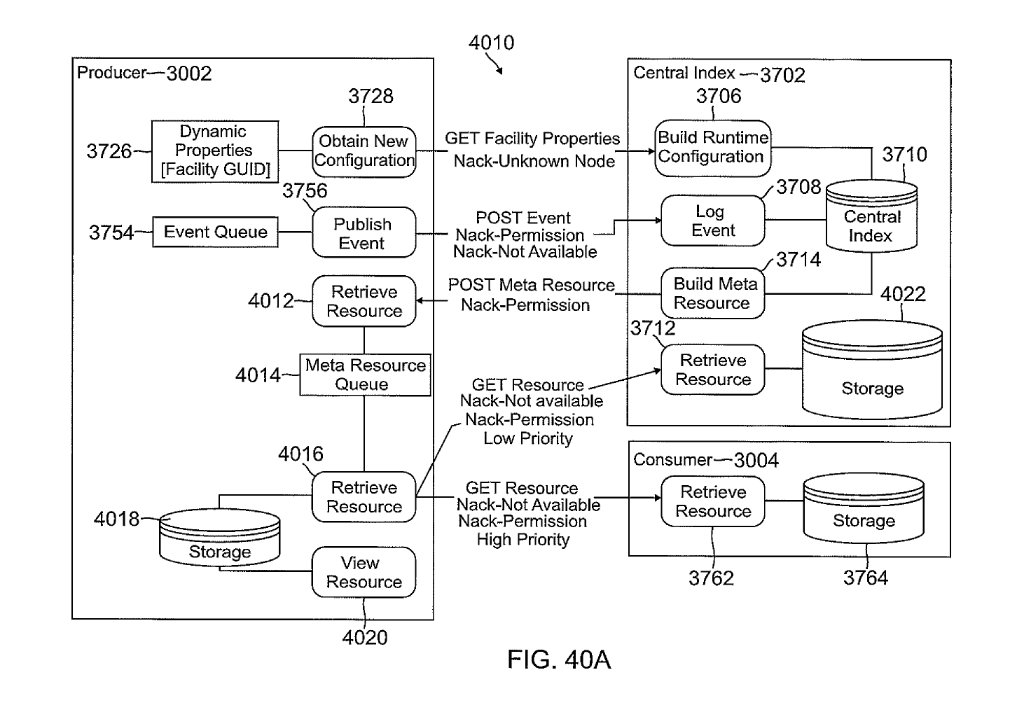

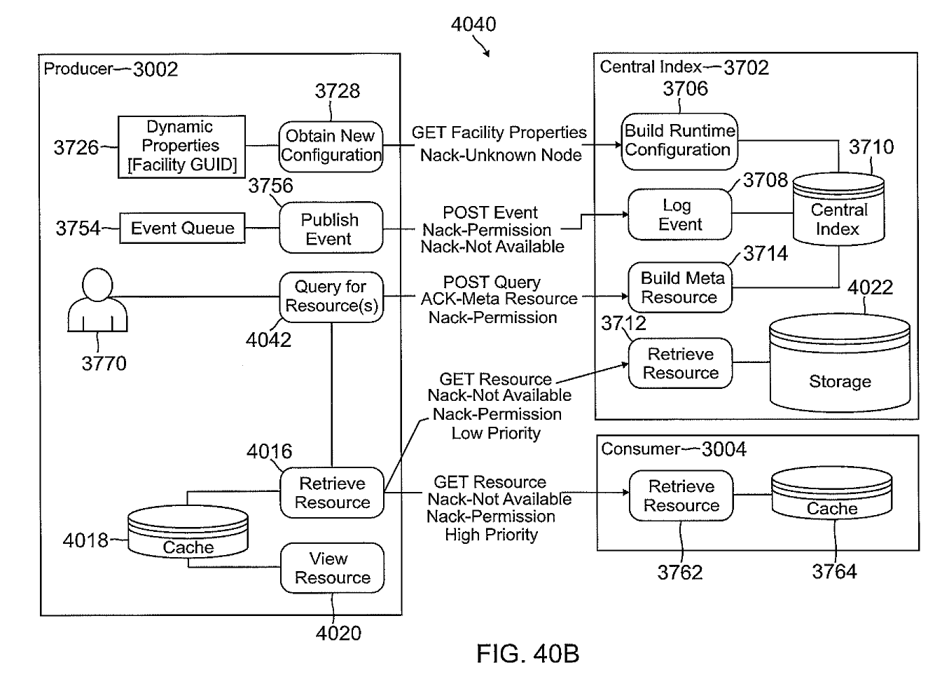

FIG. 40A is a typical interactive viewing node workflow 4010 in accordance with one aspect of the present application. In essence, the viewing node workflow 4010 can allow a user, such as a physician or a doctor, to query the central index 3702 for a study. The central index 3702 can resolve the study as a collection of resources and return the necessary meta resource from the metadata warehouse 3306 to retrieve the resources from the grid 3300. The meta resource can be queued and the resources can be retrieved. The central index 3702 can set the meta resource's priorities to cause the mix-in of interactive meta resources with any outstanding auto-forwarded meta resources. The meta resources from the interactive query can be weighted higher than the outstanding auto-forwarded meta-resources.

As shown, the producer 3002 can provide several operations through several included modules. In one operation, the producer 3002 can provide facility properties to the central index 3702 using a call to obtain a new configuration 3728. The obtain new configuration call 3728 can be coupled to a dynamic properties module 3726. In another operation, the producer 3002 can post an event to the central index 3702 using an event queue module 3754 and a publish event call 3756.

The producer 3002 can also retrieve meta resources through a retrieve resource module 4012 from the central index 3702. The retrieve resource module 3712 can be coupled to a meta resource queue module 4014 which can be coupled to a retrieve resource module 4016 that communicates with the consumer 3004. The retrieve resource module 4016 can provide resources to the consumer 3004. The retrieve resource module 4016 can be coupled to storage 4018 and the storage 4018 can be coupled to a view resource module 4020.

Continuing with FIG. 40A, the central index 3702 can include a build runtime configuration module 3706 that can receive facility properties from the producer 3002. The build runtime configuration module 3706 can be connected to a central index database 3710. The central index database 3710 can be coupled to a log event module 3708 where posted events are received from the producer 3002. The central index database 3710 can also be coupled to a build meta resource module 3714. The build meta resource module 3714 can provide meta resources to the producer 3002. The build meta resource module 3714 can be coupled to storage 4022.

The consumer 3004 can further provide operations as shown in the interactive viewing node workflow 4010. The consumer 3004 can include a retrieve resource module 3762 to receive resources from the producer 3002. The retrieve resource module 3762 can be connected to storage 3764.

While many components and operations were described herein for the producer 3002, central index 3702, and the consumer 3004, one skilled in the relevant art will appreciate that the interactive viewing node workflow 4010 provides one illustration among many possible implementations.

With reference now to FIG. 40B, an auto forwarding viewing node workflow 4040 is provided in accordance with one aspect of the present application. The central index 3702 can send a meta resource to the viewing node based on the node's registered criteria for observation. In turn, the central index 3702 can set the meta resource priorities to cause the mix-in of interactive meta resources with any outstanding auto-forwarded meta resources. The meta resources can be weighted lower than any interactive query results.

The nominal state of the central index 3702, with respect to the grid 3300, is waiting for resource requests. On receipt of a request, the central index 3702 can determine if the resource is new or if the resource is an update to an existing resource. UUIDs can be generated for new resources. Updates can use an existing resource UUID. The identifier for the resource can be returned to the requesting node. Each resource can be uniquely identified on the grid by ProducerUUID.ResourceUUID.

The central index 3702 can review the grid node's observation criteria upon receipt of a resource request. In turn, the central index 3702 can send a meta resource to each interested grid node whether a new resource or an update to an existing resource is provided. A node can overwrite any existing resource in its cache. The central index 3702 can send an updated meta resource to a node when the state of a resource has sufficiently changed. Event compression on the node can ensure that an older meta resource is deleted, if still pending. This can be done when necessary as it can cause the node to retrieve another copy of the resource. This can be necessary if a meta resource was sent to the grid nodes for a resource with a location that is no longer valid.

The central index 3702 can delete a resource by sending a meta resource to all nodes that have been notified to cache the resource. Event compression of the meta resources on the nodes can cause the canceling of the caching of a resource if the resource request is pending when the delete is received.

Nodes can “ping” the central index 3702 periodically with their status and UUID. The central index 3702 can cache this information and the node's IP address. The central index 3702 can use this as the default address when signaling the node. This behavior can be overridden if an explicate IP address is necessary.

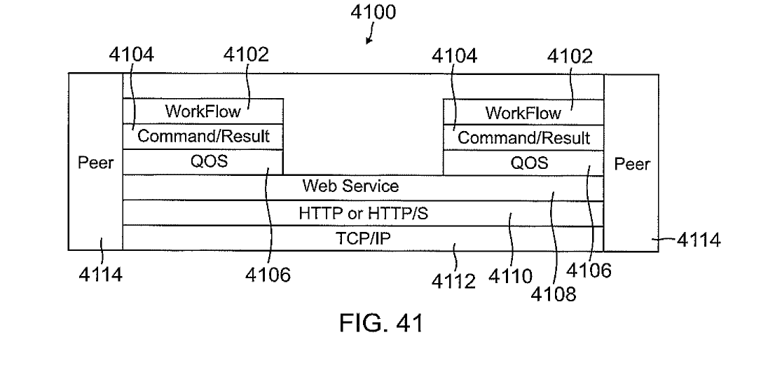

FIG. 41 illustrates layers within a node communication quality of service (QOS) 4100 in accordance with one aspect of the present application. The grid nodes' workflow 4102 can use queuing in the QOS layer 4106 to allow asynchronous retrieval of data while providing a synchronous propagation of signaling. Typically, each web service 4108 does not return until either the request has been completed or successfully queued for later processing. This can enforce the asynchronous nature of the grid 3300 and prevent any grid-wide deadly embraces from developing.

A consuming peer can use the HTTP range request header 4110 and multiple connections to retrieve a large resource in segments from multiple producing peers. The consumer 3004 can review the meta resource attributes to determine the ranking of peers mapped against the QOS 4106 for this node. The consumer 3004 can pull from lower ranked nodes when the higher ranked nodes either failed, or the QOS 4106 was sufficiently high to warrant using the lower ranked nodes. The lower ranked nodes can either incur higher costs, slower data links or some other deficiency. The resulting resource can be checked against the hash in the meta resource to ensure the resource is intact. Successfully transferred resources can be cached. Failed transfers are re-queued or dropped if there is a duplicate entry in the queue. This can cause the central index 3702 to modify the queued meta resources as the grid topology changes.

A producing peer 4114 can use the chunked transfer encoding when returning larger files. The producer can introduce an “inter-chunk latency” to throttle the data link usage. When too many simultaneous connections are requested from grid nodes, the producer can refuse additional connections. The consumer can be expected to retry the transfer after a random delay.

The asynchronous nature of the grid 3300 can cause the need to queue and retry units of work, Failures can typically be caused by connectivity outages, planned node maintenance, a node being over utilized, etc. The default retries and timeout mechanism provided within the grid 3300 can be a two bucket “Monte Carlo” implementation. The first bucket can be limited to a number of retries (default: 3) with a short random timeout (default: typically no more than 10 minutes). The units of work can be initially queued into this first bucket with an initial random delay (default: generally no more than 5 minutes). The second bucket can have unlimited retries with a long random timeout (default: no more than 2 hours). A unit of work can move from the first bucket to the second when it has exhausted its retries in the first bucket. A unit of work can remain hi the second bucket until either success or the central index 3702 deletes or modifies the meta resource. On a node restart, the queue can be rebuilt with all work units in the first bucket.

It can be necessary to implement a slow-start algorithm much like TCP/IP 4112 if it found segments of the grid 3300 that are synchronously restarted on a schedule causing congestion on another segment of the grid 3300. For purposes of illustration, the nodes at a facility can be restarted at 8 pm daily and have outstanding units of work pending against one remote node. The resulting congestion on the remote node can cause the restarting nodes' units of work to drop into the second bucket with long timeouts.

The number of threads on a node dedicated to processing work units can be the tuning mechanism for reserving resources on a node or the under-lying network. The complexity of the mechanism for the number and allocation of threads can be determined by the number and complexity of business requirements leveled against the node's resource usage i.e. reduced capability during work hours, increased capacity during off hours, no capacity on holidays, only allow transfers on the second Tuesday of the month between 12:00 and 12:01 if ifs raining, etc.

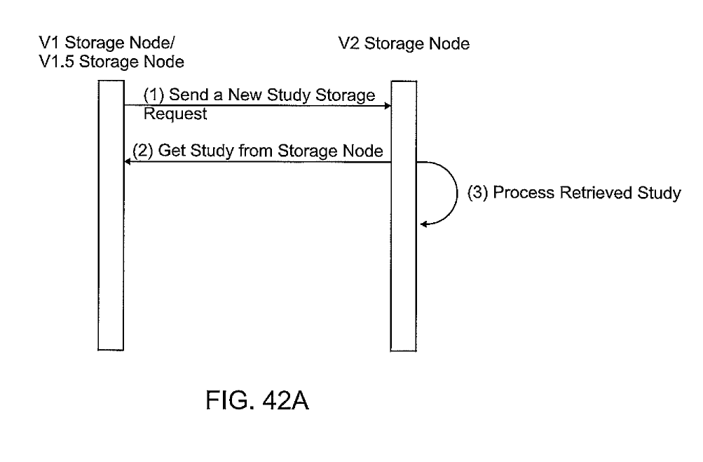

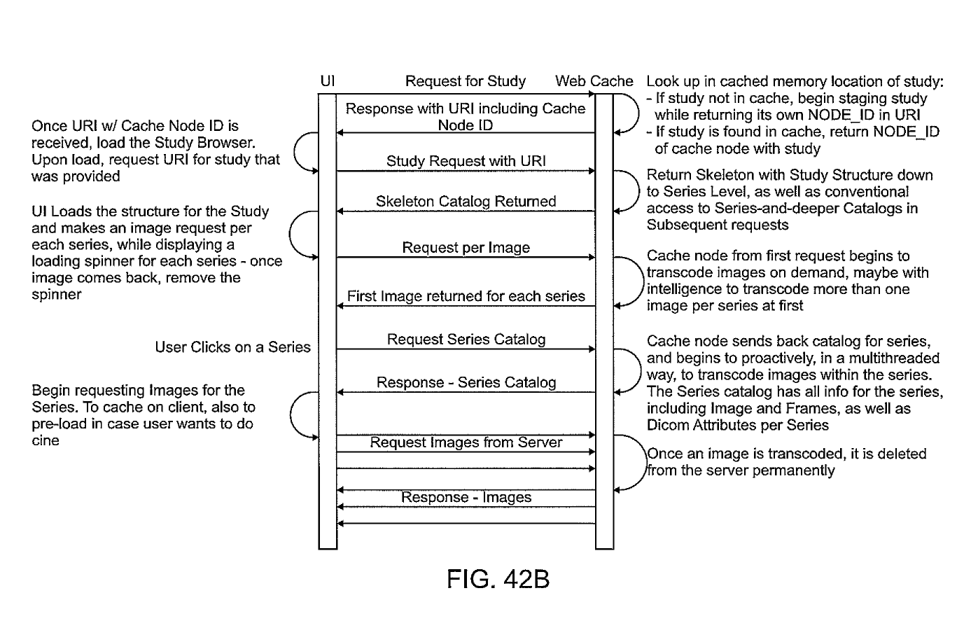

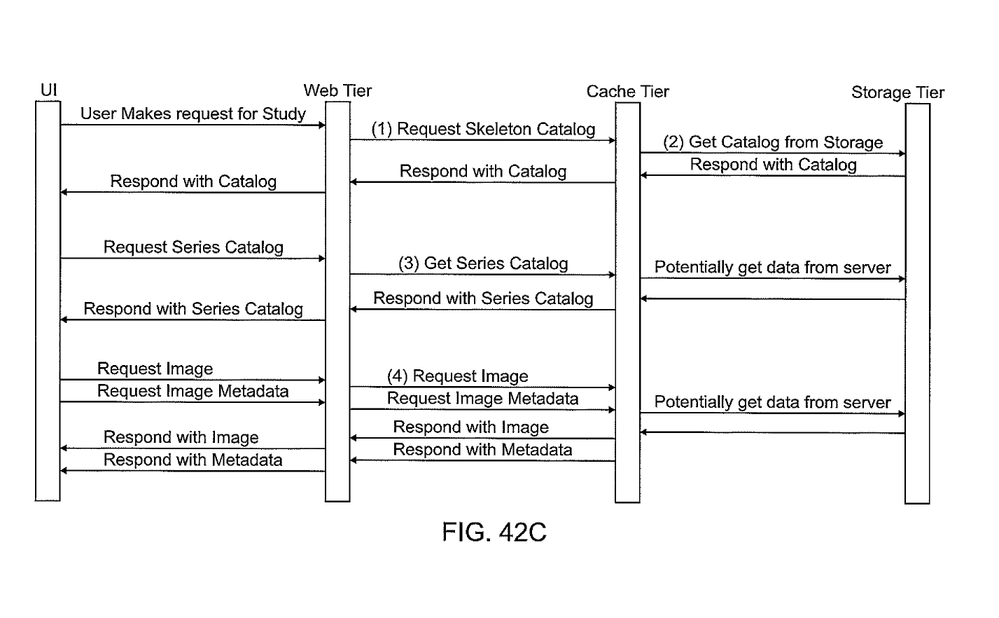

FIGS. 42A, 42B and 42C show retrieval of DICOM data using timing sequence charts known to those skilled in the relevant art. The sequences are provided for illustrative purposes and should not be construed as limiting the scope of the present application. Beginning with FIG. 42A, simple procedures by a consumer 3004 to retrieve a study from the medical information network 3000 are provided. The consumer 3004 can initially send a new study storage request. The request can include information such as an image identifier. In turn, the medical information network 3000 can process the retrieve the study. The consumer 3004 can then get the study from the storage nodes ending the process.

FIG. 42B present communications between a user interface (UI) and a web cache to retrieve images. Initially, the user, through the UI, can make a request for a study to the web cache. The web cache, in turn, can look up in cached memory the location of the study. If the study cannot be found in the cache, the web cache can begin staging of the study while returning its own node identification and NODE_ID in a URI. When the study is located within the cache, the web cache returns the NODE_ID of the cache node with the study. A response is provided with the URI including the Cache NODE_ID to the UI.

Once the URI with the cache NODE_ID is received, the UI can load the study browser. Upon loading the browser, the UI can request a URI for the study that was provided to the web cache. The web cache can return a skeleton to the UI. The skeleton can include a study structure down to a series level as well as conventional access to series-and-deeper catalogs in subsequent request. At the UI, the structure for the study is loaded. The UI can make an image request per each series while displaying a loading spinner for each series. Once the image comes back, it removes the spinner. A request per image is sent to the web cache by the UI. The cache node from the first request can begin to transcode images on demand. In one embodiment, this can be performed with logic that allows more than one image per series.

In operation, when the user on the UI clicks on a series, a request for series catalog is made. The cache node can send back the catalog for the series and begin to, proactively in a multithreaded way, transcode images within the series. The series catalog can have all the information for the series including image and frames as well as DICOM attributes per series. The UI can begin making requests for images for the series. The web cache can respond with images. Once an image is transcoded, the original DCM file can optionally be deleted from the server.

FIG. 42C illustrates a timing sequence between a UI and a web tier, cache tier and storage tier to retrieve images. Initially, the UI can make a request for a study. In turn, the web tier can receive the request. The web tier can make a request for a skeleton catalog to the cache tier. The cache tier can get a catalog from storage at the storage tier. The storage tier can respond with the catalog and the cache tier can forward the catalog. The web tier can provide the catalog to the user interface.

At the UI, a request for a series catalog can be made. The request can be processed by the web tier and then sent to the cache tier. The cache tier can potentially get data from the server at the storage tier. When the data is retrieved, the cache tier can respond with the series catalog to the web tier, which then responds with the series catalog to the UI. The UI can then request for an image. The web tier can make a request for the image from the cache tier. Similarly, at the UI, a request for image metadata can be made with the web tier making the request for the image metadata to the cache tier. The cache tier can potentially get the data from the server on the storage tier.

When the requested image is provided by the storage data, the cache tier can respond with the image and metadata to the web tier. The web tier can then respond with the image and metadata to the UI.

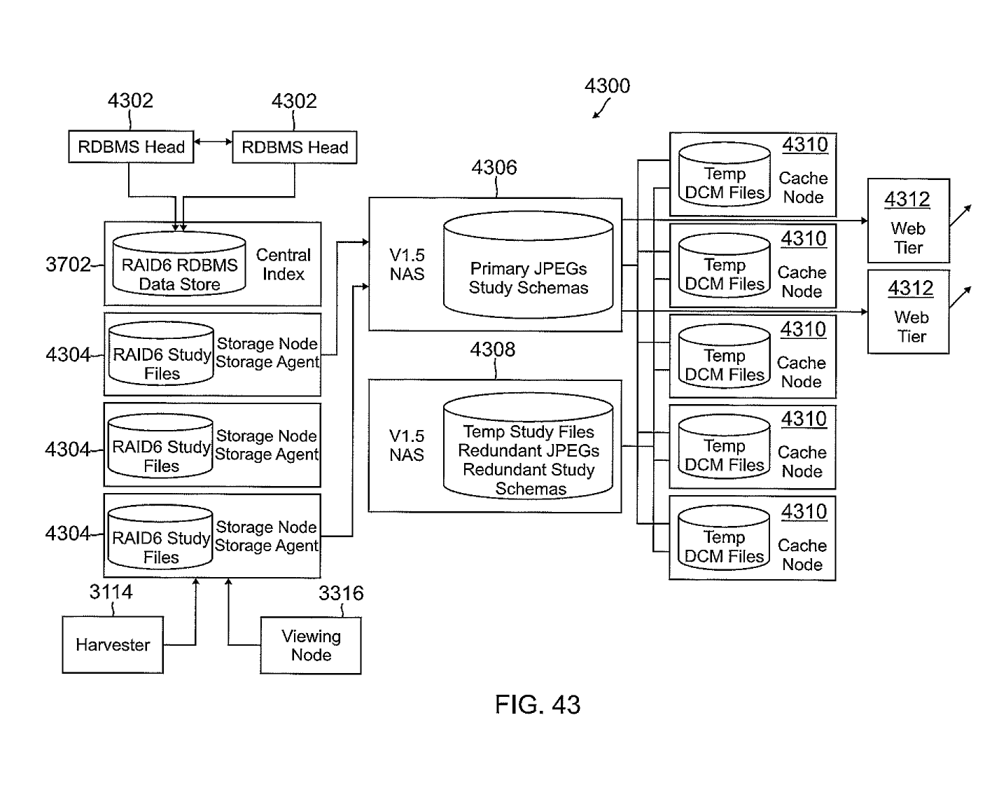

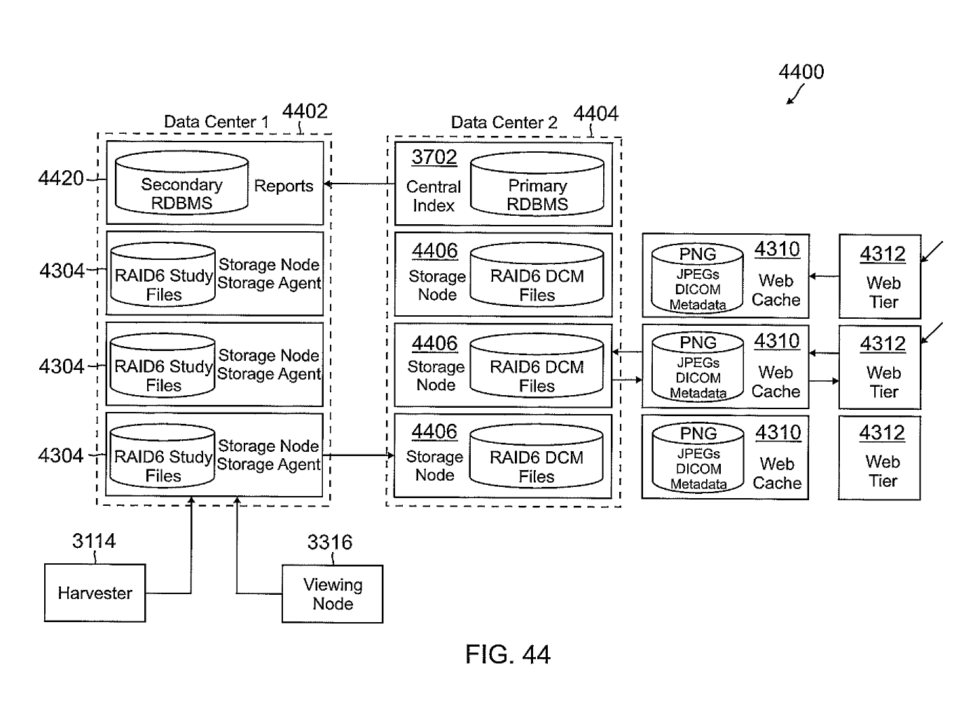

FIG. 43 provides a typical environment for node deployment 4300. This configuration 4300 illustrates one embodiment and should not be construed as the only one. The deployment 4300 can include at least one relational database management system (RDBMS). Connected to the RDBMS is the central index 3702. Coupled to the central index 3702 can be a series of storage node systems 4304. The systems 4304 can be connected through techniques known to those skilled in the relevant art.

Harvesters 3114 can be connected to the systems 4304 for providing images. Viewing nodes 3316, provided earlier, can also be connected to the systems 4304. The node deployment 4300 can include network attached storage (NAS) systems 4306 and 4306, which can be coupled to the systems 4304. The NAS systems 4306 can include a file repository for storing primary JPEGs and study schemas while another NAS system 4308 can have a file repository for storing temporary study files, redundant JPEGs and redundant catalogs.

Each of the NAS systems 4306 and 4306 can be connected to a cache node 4310. The cache nodes can include temporary DICOM files. Attached to the NAS systems 4306, can be web tiers 4312. The web tiers 4312 will be described in a subsequent application.

FIG. 44 depicts further deployment 4400 of the DICOM images. The deployment includes two data centers 4402 and 4404. The first data center 4402 can incorporate reports 420. The reports 420 can incorporate a secondary RDBMS. Data center 4402 can include storage node systems 4304 that store image study files. Harvesters 3114 can be connected to the data center 4402 for providing images. Viewing nodes 3316, provided earlier, can also be connected to the data center 4402.

In data center 2 4404 of FIG. 44, the central index 3702 can be incorporated. The central index 3702 can include a primary RDBMS as shown. Within the data center 4404 are a number of storage node systems 4406 that store individual DICOM files. The data center 4404 can be coupled to web caches 4310. Each of the web caches 4310 can include JPEG files, PNG files, and binary files with DICOM metadata. The web caches 4310 can then be connected to web tiers of load balanced web servers 4312.

Integrated into the medical information network 3000, in embodiments of the present application, are web-enabling technologies. While a single logical repository 3006 of cross-facility, anonymized DICOM image files with a corresponding logical repository 3102 of PHI data were included in the medical information network 3000, those skilled in the relevant art will appreciate that different configurations for the medical information network 3000 can be used for the acquisition of data. As described below, the Internet and other related computer networks can facilitate acquisition of the medical imaging records and provide a more scalable system that can be integrated and used by numerous platforms. Before describing these technologies, information regarding the organization of the anonymized images will be discussed. This description will provide a better understanding of how data can be presented by the medical information network 3000. Typically, the division can occur within the repository 3104. In one embodiment, this organization can occur outside of the repository 3104 in a single server or multiple servers having appropriate computing power.

Medical imaging records can be split into personal health information as well as non-personal health information, the non-personal health information taking the form of anonymized DICOM images. The anonymized images can be stored in the image servers 3106 and can be connected to a horizontally scalable anonymized image repository 3104 with the PHI encrypted and stored in a PHI database 3102, which can be an RDBMS. The anonymized image files can be further parsed to generate web consumable files. The anonymized image can be deeply parsed into two separate files and stored in a web cache. The first file can be provided in a web compatible image format such as JPEG. A second file parsed from the anonymized image can include a metadata file. The metadata file can be a binary representation of non-image, non-personal DICOM tag data. In one embodiment, the binary metadata file can include image attributes. The binary metadata file can be stored per image in a cache alongside the JPEG version of the image.

Out of a single medical imaging record, personal health information, non-personal health information, a JPEG image and binary metadata file can be created. In addition, a data object can be created and served to a web browser. This object generally never gets stored anywhere in cloud services 3402. The object, which is dynamically created, can be held in memory and dynamically provided. This object, a study schema, can provide a many-to-one mapping of individual image files into a study hierarchy. With respect to the web enabled technologies described above, applications viewed by a browser through a consumer 3004 can use this study schema in order to access relevant image data from cloud services 3402 and display it appropriately.

Meaningfully presenting DICOM images in a standard web browser generally requires presenting those images in the context of an imaging study, which is an aggregation of individual DICOM images that contain the same DICOM study UID. The schema can provide for an explicit structure and relation to the aggregation of DICOM images. An arbitrary number of ordered frames make up a DICOM and an arbitrary number of ordered images make up a DICOM series and an arbitrary number of ordered series make up a DICOM study. This structure of study, series, image and frame can be fundamental to presenting imaging data to the user in a web browser. This study structure or schema is derived from the DICOM image files themselves. Such a study structure or schema can be created and updated every time a DICOM image is added to a repository. However, this approach involves a large amount of processing overhead to create or update a study schema every time a new image is stored in the repository. This approach makes it difficult to maintain the referential integrity between the study schema and the DICOM images. As will be shown below, the study schema can be generated dynamically and on demand to address these challenges.

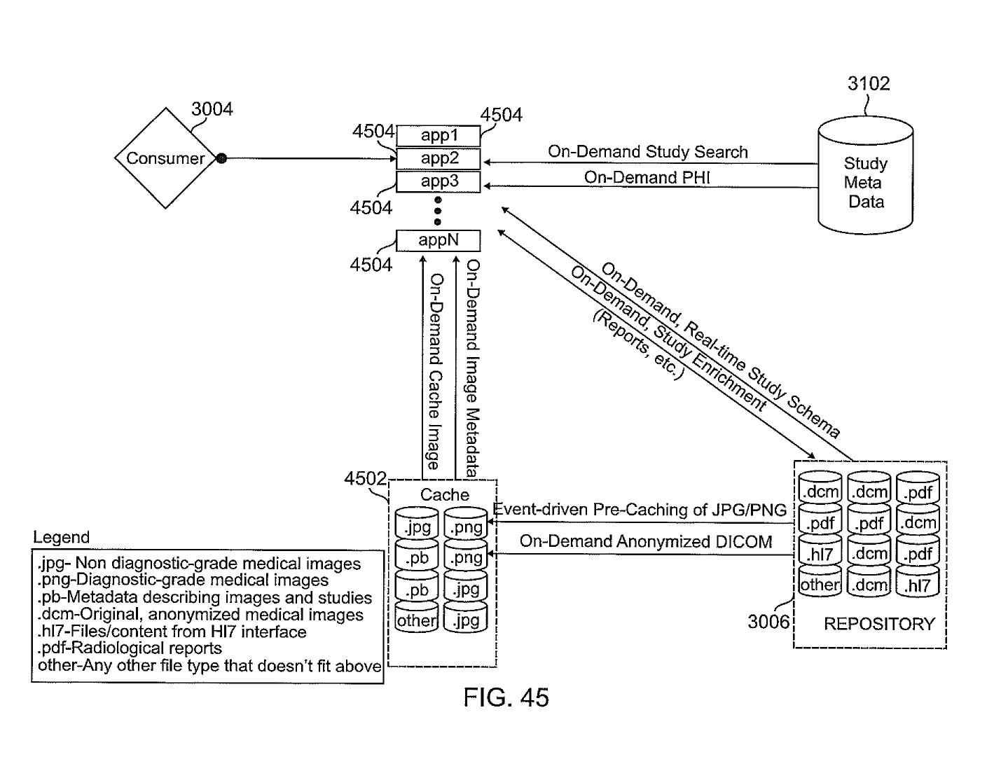

Turning now to FIG. 45, a diagram representing web enabling DICOM data is provided. More specifically, the diagram shows acquisition of the DICOM data by a consumer 3004 having a web browser. In the shown configuration, the consumer 3004 communicates with the study metadata 3102 housing the PHI, repository 3006 with the anonymized images and cache 4502. While still interacting with the different types of data sources described previously, the database 3102 and repository 3006 in combination with the cache 4502 can provide additional advantages which will become clear in the discussion provided below. Those skilled in the relevant art will appreciate that other configurations can be used.

The consumer 3004 can interact with one or many applications 4504. In one embodiment, the processes for retrieving a study can begin with the consumer 3004 who issues a request for a study. The one or more applications 4504 can forward the request to the repository 3006, as shown in the lower right of FIG. 45. After receiving a web request for a specific DICOM image study, native DICOM image files in the anonymized DICOM image file repository 3006 that are part of this specific image study are located. These DICOM files are then parsed deeply enough to determine the hierarchical structure of the image study. This study schema information is dynamically created in compact binary format and returned to the web browser where it is used to create the appropriate presentation context for displaying images in the browser.

The study schema data is not stored in the DICOM file repository or in the cache repository. It is dynamically derived every time a web request for a specific study is received. This ensures the referential integrity of the study schema at any given moment in time, even as the underlying DICOM file repository is being updated with new images. This response is generally provided on demand. The native DICOM data when stored as individual files is not in browser compatible form or format. The study schema provided in response to the request enables the creation of a user friendly, study-oriented presentation context in the browser. The study schema is often generated in response to the request and is not static in nature. This provides a low latency scalable solution that can be invoked in real time. The ability provides the study schema rapidly in real time gives the system scale and flexibility.

When triggered, the stored anonymized DICOM image file can be deeply parsed and converted into two separate files including a compressed, reduced resolution JPEG image and a binary file containing DICOM metadata that corresponds to the image, which were described above. The event triggering the creation of the files, for example, can occur when the consumer 3004 makes the request for the study schema. In one embodiment, the binary file can be converted on demand to a web compatible JSON payload so it can be easily consumed by a standard web browser.

The newly created JPEG file and binary metadata file can be stored in a cache 4502 where they can quickly be served to a standard web browser on a consumer 3004 and be meaningfully displayed. Both files are aged out of the cache 4502 over time based on a standard aging algorithm like FIFO. In one embodiment, the cache 4502 includes a plurality of horizontally scalable servers.

The binary study schema received by a browser request can contain sufficient information for the consumer 3004 to request each image in the image study from the cloud based imaging repository. In one embodiment, parallel processes can be used by the applications 4504 to retrieve the study. These browser requests can be made in parallel depending on the ability of the browser to execute parallel http requests.

Each discrete image is Internet addressable. The address can be derived by convention and generally is not statically defined and stored in a database. The convention by which the images are stored and addressed within the repository can be based on the inherent canonical DICOM instance UIDs and study UIDs. This data driven organization of the data enables deterministic conventions for addressing and accessing the data in the cloud repository without the use of static addressing schemes which are inherently limited in their ability to scale. The binary study schema received by a browser enables the presentation of a meaningful image study context and enables that context to be populated with actual browse-able imaging data.

Many anonymized images can be parsed to create one schema defining the hierarchical relationship of the images. The applications 4504 can retrieve the JPEG images from the cache 4502 to create the study according to the schema provided by the repository 3006. To complete the contents of the imaging study, an authenticated browser call to the PHI repository 3102 can be made and the PHI for this study returned to the browser and displayed in the appropriate image study context. Thus, a web browsable version of the imaging study is safely, quickly and created in any standard web browser. The personal information can be decrypted and combined with the JPEG images to reform the medical imaging records according to the hierarchical structure.

The formed medical imaging records formed from the JPEG images can have a lower resolution. As a user browses an image study and interacts with the reduced resolution JPEG images, they can encounter an image where they would like to view a higher resolution version of that image. A user can request a PNG version of the images being viewed in the browser. In one embodiment, the user explicitly requests a higher resolution image by clicking on a user interface control in the browser. When the request is received by the cloud service 3402, the anonymized DICOM source file for that image is located in the repository. A dynamic image conversion from native DICOM to PNG is executed in the cloud and the resulting PNG file is returned to the browser and displayed in the context of the appropriate image study.

The PNG files can be capable of representing the full resolution of a DICOM image on the X plane representing a horizontal resolution, Y plane representing a vertical resolution and Z plane representing grayscale. The Z plane of many DICOM images, and thus the Z plane of the corresponding converted PNG file, can be in excess of 65,000 distinct shades of gray. In one embodiment, grayscale display capabilities of standard Internet browsers are limited to 8 significant bits on the Z plane and 256 shades of gray. PNG converted DICOM images, while theoretically preserving the original resolution on all three display planes, can have their Z plane down converted by standard web browsers to 8 significant bits of grayscale resolution and thus be less than the original resolution of the native DICOM file.

In one embodiment, study enrichments can be provided to the applications 4504. The study enrichment can be provided on demand similar to the study schema described above. Study enrichments such as radiological reports can provide diagnostic opinions and are a valuable tool beyond the images provided. The study enrichments can be stored within the repository 3006 and be associated with a study.

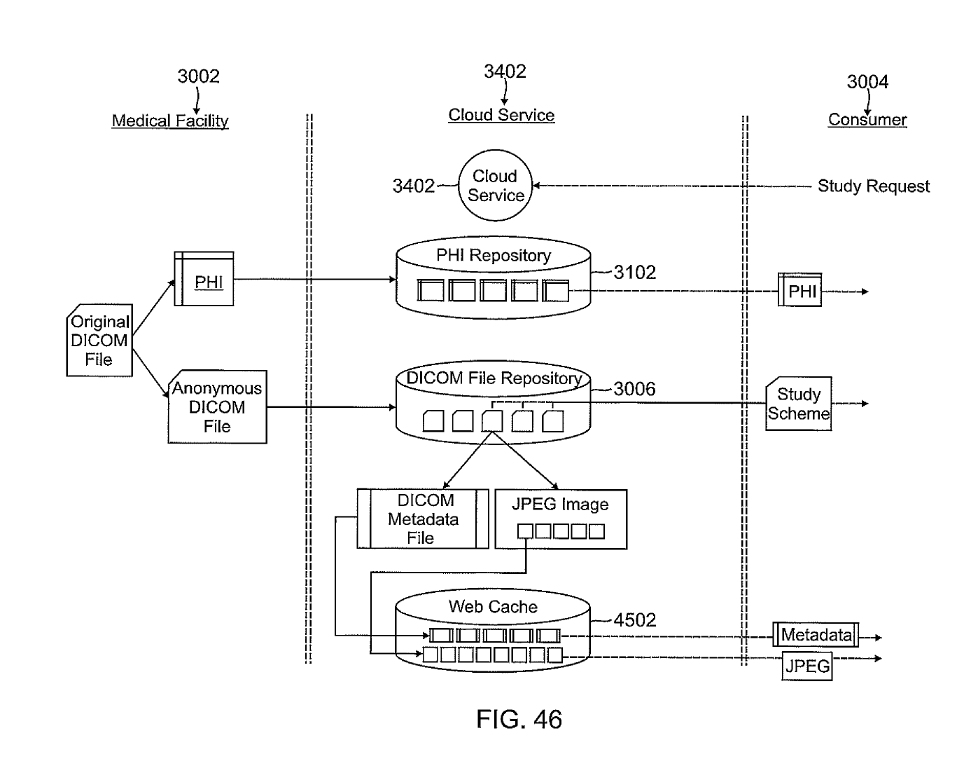

FIG. 46 is a block diagram showing an illustrative timing sequence for acquisition of medical imaging records. This diagram represents one embodiment. Known to those skilled in the relevant art, fewer, more or different processes can be used. At the medical facility/producer 3002, original DICOM files can be split into PHI and anonymous DICOM files. The PHI is stored on the PHI repository 3102 while the anonymous DICOM files can be stored on the DICOM file repository 3006.

Generation of the PHI and anonymous DICOM files can typically occur at any time allowing for dynamically created information that can be accessed by the consumer 3004. When the consumer 3004 makes a study request to the cloud service 3402, the cloud service 3402 responds with a study schema from the DICOM file repository 3006. The study schema is generated on demand when the request is received.

In one embodiment, when the request is received by the cloud service 3402, the anonymous DICOM file is parsed into a DICOM metadata file and a JPEG image. These files can then be stored into the web cache 4502. The consumer 3004 can then receive the metadata file and the JPEG image from the web cache 4502 according to the study schema provided earlier. Combined with the PHI, the consumer 3004 can reform the medical imaging records to form the study.

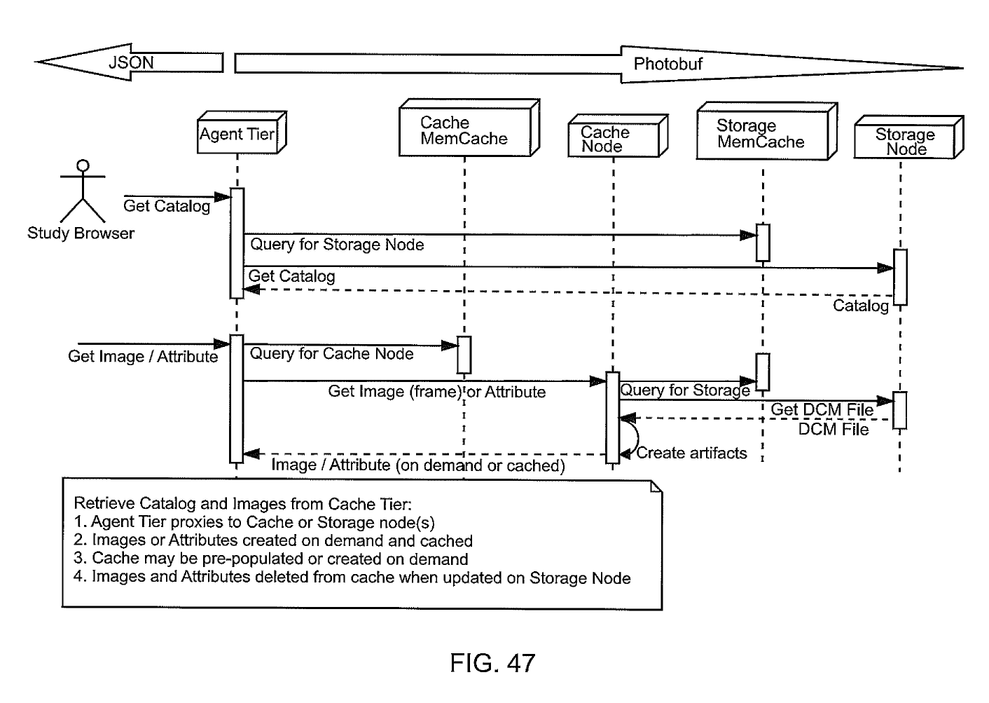

FIG. 47 shows dynamic study schema (or study catalog) generation and dynamic image transcoding in greater detail. Catalog generation can begin when a study browser makes a request to an agent tier for a catalog. In turn, the agent tier can query a storage memory cache to locate the storage node containing the native anonymized DICOM files for a given image study. The storage node then dynamically generates the study catalog and returns it to the agent tier which in turn returns it to the browser.

The study browser, using the returned catalog, can query the cache memory cache to locate the cache node containing the browser compatible images and attributes for a particular study. In the event of a cache miss, where the images and attributes do not exist in the cache, the cache node can query the storage memory cache to locate the storage node containing the native anonymized DICOM files for the image study. The storage node then dynamically generates the browser compatible images and attributes and returns them to the cache node. The cache node stores the images and attributes and also returns them to the browser. Communications between the components generally use binary encoded data that can be implemented as protocol buffers. A JavaScript Object Notation payload can be used to return non-image data to the study browser.

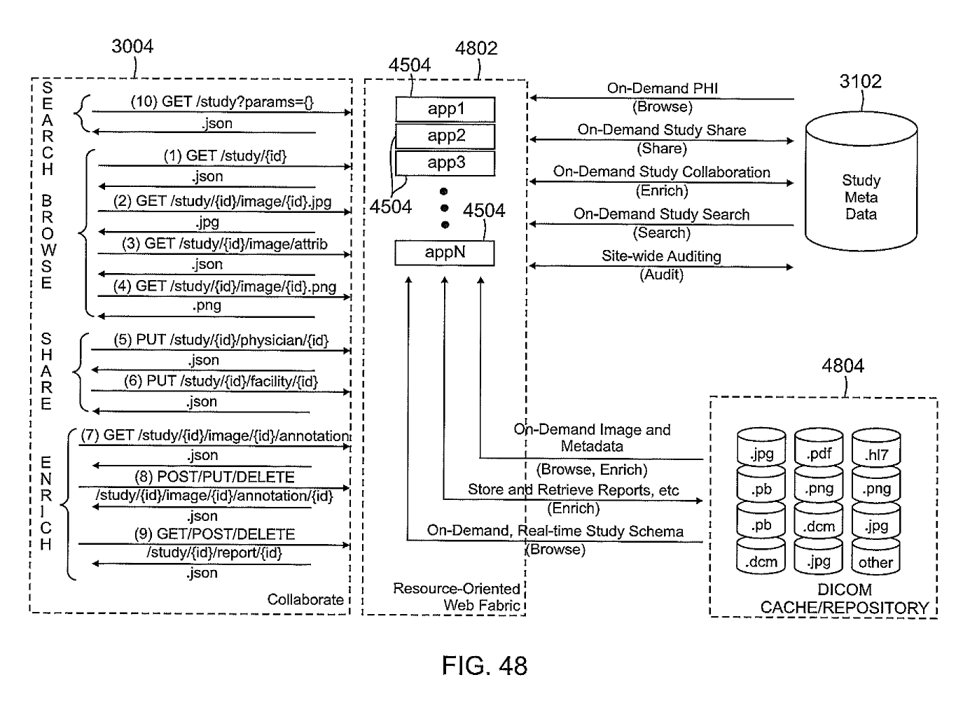

Previously, a repository with data was described. The data was then made web friendly in browser consumable formats. Now referring to FIG. 48, a collaborative medical imaging web application is depicted. The web application can operate as a web consumer 3004 and provide collaborative functions having application level capabilities that can access, process, analyze or augment the personal information from the database 3102 and the non-personal information from the repository 3006 split from said medical imaging records. One or more web consumers 3004 can communicate with the medical information network 3000. By allowing more than one consumer 3004, cross facility features, using the split-join concept described above, can be implemented.

The consumer 3004 can interact with one or many web application servers 4504. The web application servers 4504 can be provided on a resource-oriented web fabric 4802. The resource-oriented web fabric 4802, in one embodiment, can be used by the web consumer 3004 to facilitate interactions between the database 3102 storing personal information and the cache 4502 and repository 3006 storing non-personal information, which is combined in FIG. 48 as the DICOM cache/repository 4804.

While five collaborative functions for the consumer 3004 are shown, those skilled in the relevant art will appreciate that numerous features can be provided through the protocols that are provided herein. It should be noted that the functions described herein are for purposes of illustration and do not limit the present application. The GET, PUT, POST and DELETE commands used herein can be combined to form other features. Below, five features for the consumer 3004 are described. These functions include a search, browse, share, enrich and audit feature. The features provided above can be implemented as a sequence of representational state transfer based API calls

The search feature can allow the consumer 3004 to locate a study. In one embodiment, a GET /study?params={ } command can be placed to the applications 4504. Parameters can be provided to distinguish a specific study. For example, a search query can include a date, type, location, date of birth or last name of a patient in a study. In one embodiment, the search can be performed using a unique patient identifier, such as a social security number. Through such commands, cross facility search within the repository 3006 can be made and data can be indexed in a patient centric way. Searches, in one embodiment, can be based on metadata or information about the study.

In response to the received command, a study schema can be provided by the applications 4504. In one embodiment, the study schema is a web compatible JavaScript Object Notation payload. The applications 4504 in the resource-oriented web fabric 4802, for the search feature, can communicate with the study metadata database 3102. The metadata database 3102 can contain study information related to the parameters searched. The database 3102 can return the study on demand to the applications 4504, whereby it can be provided to the consumer 3004. Because typically there are no globally unique identifiers, the search within the database 3102 is performed with constraints by the entered parameters allowing the DICOM devices or consumers 3004 to perform the search.

The search can be described as user centric meaning that through the parameters the consumer 3004 can define their own attributes for locating a study and retrieving a study schema corresponding to the study. The other features described in FIG. 48 can also be user centric. Typically, and after the search is performed, the other features can be implemented. For example, the consumer 3004 can browse, share and enrich the study received. Also, an audit can be performed. Each of these features will be described in more detail below.

The browse feature on the consumer 3004 can provide numerous commands to the applications 4504. A GET /study/{id} command can be provided to the applications 4504 and in return, a study schema can be provided. The {id} can refer to a study globally unique identifier or GUID. When the applications 4504 receive this command, a query can be made to the cache/repository 4804 to receive the on-demand, real time study schema as shown in FIG. 48.

The browse feature can also implement GET /study/{id}/image/{id}.jpg, GET /study/{id}/image/attribute and GET /study/{id}/image/{id}.png commands. In these commands, the applications 4504 can request personal health information from the database 3102 as well as on demand image and metadata from the cache/repository 4804. Using the split join concept described above, information from both the database 3102 and the cache/repository 4804 can be combined to form medical imaging records. In return, the applications 4504 can provide an image in a web compatible format such as .jpg or .png. The attributes can be returned as a .json file.

While GET commands were described above, those skilled in the relevant art will appreciate that there are numerous types of communications that can be used so that the consumer 3004 can interact with the resource-oriented web fabric 4802. Those commands, as well as those that will be described below, can be replaced or interchanged with other commands.

A share feature allows the consumer 3004 to provide studies that are of value to other DICOM devices. The share feature can use PUT /study/{id}/physician/{id} and PUT /study/{id}/facility/{id} commands. Specific attributes for these commands, as described, can include physician and facility identifiers. In operation, the consumer 3004 can provide specific studies that are oriented with a physician or facility using the identifiers. A JavaScript Object Notation payload, in the form of a .json file, can be returned by the applications 4504. When the commands for the share feature are received by the applications 4504, the study can be shared modifying access controls in the database 3102. The sharing can allow other consumers 3004 to look up information and access a study that other devices have posted.

The enrich feature can allow the consumer 3004 to add radiological reports, measurements, annotations, etc. to the medical record. The GET /study/{id}/image/{id}/annotation.json command can return annotations for this medical record to a web consumer. The POST /study/{id}/image/{id}/annotation/{id}.json command can add annotations to a medical record. The PUT /study/{id}/image/{id}/annotation/{id}.json command 3004 (8) can update annotations in a medical record. The DELETE /study/{id}/image/{id}/annotation/{id}.json command can delete annotations from a medical record. The GET /study/{id}/report/{id}.j son command can retrieve a radiological report for an image study. The POST /study/{id}/report/{id}json command can add a radiological report to an image study. The PUT /study/{id}/report/{id}.json command can update a radiological report in an image study, while the DELETE /study/{id}/report/{id}.json command can delete a radiological report from an image study.

An audit feature can also be implemented as shown in FIG. 48. The audit feature can allow each invocation of a collaborative feature to be recorded within the database 3102. This capability can create a detailed audit trail of end user operations against specific medical studies. While several features have been provided, known to those skilled in the relevant art, fewer or more features can be used that provide consumers 3004 that ability to interact with the medical imaging network 3000.

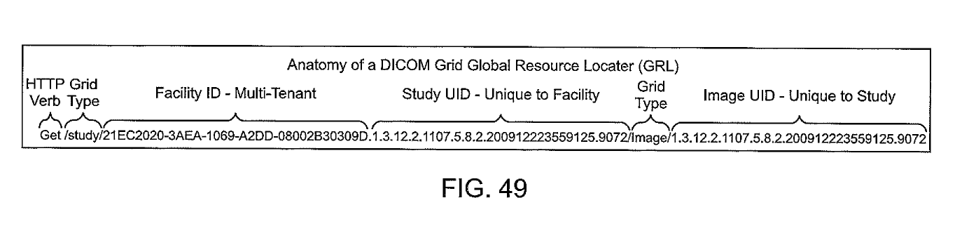

FIG. 49 provides an anatomy of a DICOM grid global resource locator. The provided global resource locator represents one embodiment and should not be construed as the only embodiment. The locator can act as an addressing scheme for locating data within the medical imaging network 3000. Specifically, in the cache/repository 4804, the consumer 3004 can co-locate and co-mingle files from different modalities from different types of machines and facilities in a coherent and a singular way using the global resource locator. Based on the scheme of the global resource locator, the consumer 3004 can then refer to the data all the way throughout the network 3000. The global resource locator can place the data into the context of a web location. Bringing up the medical record resources in the cache/repository 4804 can be easily performed through the resource locator.

As shown, a command can include an HTTP verb and a resource type along with the global resource locator. The verb can provide the action to be taken, for example, GET, PUT, POST, DELETE, etc. The resource type can refer to the type of resource within medical information network 3000, for example study, image, annotation, report, etc. Within the global resource locator can be a number of attributes that include, but are not limited to, a Facility ID, Study UID, Grid Type and Image UID. Other attributes can be attached to the global resource locator known to those skilled in the relevant art. The Facility ID can represent the facility where image data was created, while the Study UID can refer to a specific image study.

In accordance with one aspect of the present application, a system is provided. The system can include a database storing personal information split from medical imaging records and a repository storing non-personal information split from the medical imaging records. In addition, the system can include one or more participant devices in communication with the database and repository including collaborative functions having application level capabilities that access, process, analyze or augment the personal information from the database and the non-personal information from the repository split from the medical imaging records.

In one embodiment, the collaborative functions can include a search feature. In one embodiment, the search feature can access the database storing the personal information and receive a study schema of the medical imaging records. In one embodiment, the study schema can be a web compatible JavaScript Object Notation payload.

In one embodiment, the collaborative functions can include a browse feature. In one embodiment, the browse feature can access the database for the personal information and the repository for the non-personal information. In one embodiment, the repository can provide images and image metadata attributes. In one embodiment, the images can be browser compatible images. In one embodiment, the repository can provide a study schema. In one embodiment, the study schema can be a web compatible JavaScript Object Notation payload.

In one embodiment, the collaborative functions can include a share feature. In one embodiment, the share feature can include granting access to a study schema for a physician. In one embodiment, the share feature can include granting access to a study schema for a facility. In one embodiment, the share feature can include accessing the database storing the personal information.

In one embodiment, the collaborative functions can include an enrich feature. In one embodiment, the enrich feature can add annotations and reports to the repository. In one embodiment, the enrich feature can access the repository of reports and annotations and retrieve them.

In one embodiment, the repository can include a cache. In one embodiment, the collaborative functions can include an audit feature. In one embodiment, the audit feature can access the database. In one embodiment, the collaborative functions can access the repository using a global resource locator, the global resource locator comprising a facility identifier, study identifier unique to a facility and an image identifier unique to a study. In one embodiment, the application level capabilities can be provided on a resource-oriented web fabric.

In accordance with another aspect of the present application, a device is provided. The device can include a processor and memory coupled to the processor, wherein the memory can include program instructions executable by the processor to implement at least one application. The at least one application can be in communication with cloud services for executing collaborative functions. The cloud services can include accessing and updating medical imaging records. The medical imaging records can be split between a database having personal information and a repository having non-personal information within the cloud services.

In one embodiment, the cloud services can provide application programming interface calls for the at least one application to execute the collaborative functions. In one embodiment, the application programming interface calls are Representational State Transfer web calls. In one embodiment, the application, using the Representational State Transfer web calls, can add, update, acquire and view the medical imaging records, measurements, annotations and radiological reports associated with a given study.

In one embodiment, the application, using the Representational State Transfer web calls, can share a study with another device. In one embodiment, the application, using the Representational State Transfer web calls, can enrich the medical imaging records interactively adding measurements or annotations. In one embodiment, the application, using the Representational State Transfer web calls, can enrich the medical imaging records with radiological reports. In one embodiment, the at least one application can be a browser. In one embodiment, the collaborative functions can include at least one of a search feature, browse feature, share feature, enrich feature and audit feature.

In accordance with yet another aspect of the present application, a method for implementing collaborative features on a medical imaging system is provided. The method can include providing one or more routines to a participating node. In addition, the method can include receiving a routine request from the participating node corresponding to the one or more routines. The method can also include processing or analyzing medical imaging records dependent on the routine request by accessing the medical imaging records in the medical imaging system.

In one embodiment, processing or analyzing the medical imaging records can include determining whether to access a repository storing personal information and a database storing non-personal information within the medical imaging system. In one embodiment, the one or more routines can correspond to application programming interfaces. In one embodiment, the application programming interfaces can be combined to create application level collaborative capabilities. In one embodiment, the routine request can include a command along with a global resource locator.

In one embodiment, the global resource locator can include an internet addressable schema. In one embodiment, the routine request can include a search query. In one embodiment, the search query can correspond to at least one of a date, type, location, date of birth or last name of a patient in a study.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system comprising:
a database storing personal information split from medical imaging records;
a repository storing non-personal information split from said medical imaging records; and
one or more participant devices in communication with said database and repository comprising collaborative functions having application level capabilities that access, process, analyze or augment said personal information from said database and said non-personal information from said repository split from said medical imaging records.

2. The system of claim 1, wherein said collaborative functions comprise a search feature.

3. The system of claim 2, wherein said search feature accesses said database storing said personal information and receives a study schema of said medical imaging records.

4. The system of claim 3, wherein said study schema is a web compatible JavaScript Object Notation payload.

5. The system of claim 1, wherein said collaborative functions comprise a browse feature.

6. The system of claim 5, wherein said browse feature accesses said database for said personal information and said repository for said non-personal information.

7. The system of claim 6, wherein said repository provides images and image metadata attributes.

8. The system of claim 6, wherein said images are browser compatible images.

9. The system of claim 6, wherein said repository provides a study schema.

10. The system of claim 9, wherein said study schema is a web compatible JavaScript Object Notation payload.

11. The system of claim 1, wherein said collaborative functions comprise a share feature.

12. The system of claim 11, wherein said share feature comprises granting access to a study schema for a physician.

13. The system of claim 11, wherein said share feature comprises granting access to a study schema for a facility.

14. The system of claim 11, wherein said share feature accesses said database storing said personal information.

15. The system of claim 1, wherein said collaborative functions comprise an enrich feature.

16. The system of claim 15, wherein said enrich feature accesses said database storing said personal information and receives a study.

17. The system of claim 15, wherein said enrich feature accesses said repository for non-personal information and receives images and image metadata attributes.

18. The system of claim 15, wherein said enrich feature accesses said repository storing reports and receives said reports.

19. The system of claim 1, wherein said repository comprises a cache.

20. The system of claim 1, wherein said collaborative functions comprise an audit feature.

21. The system of claim 20, wherein said audit feature accesses said database.

22. The system of claim 1, wherein said collaborative functions access said repository using a global resource locator, said global resource locator comprising a facility identifier, study identifier unique to a facility and an image identifier unique to a study.

23. The system of claim 1, wherein said application level capabilities are provided on a resource-oriented web fabric.

24. A device comprising:
a processor; and
memory coupled to said processor, wherein said memory comprises program instructions executable by said processor to implement:
at least one application in communication with cloud services executing collaborative functions, wherein said cloud services include stored medical imaging records, said medical imaging records split between a database having personal information and a repository having non-personal information within said cloud services.

25. The device of claim 24, wherein said cloud services provide application programming interface calls for said at least one application to execute said collaborative functions.

26. The device of claim 25, wherein said application programming interface calls are Representational State Transfer web calls.

27. The device of claim 26, wherein said application, using said Representational State Transfer web calls, acquires and views said medical imaging records, measurements, annotations and radiological reports associated with a given study.

28. The device of claim 26, wherein said application, using said Representational State Transfer web calls, shares a study with another device.

29. The device of claim 26, wherein said application, using said Representational State Transfer web calls, enriches said medical imaging records interactively adding measurements or annotations.

30. The device of claim 26, wherein said application, using said Representational State Transfer web calls, enriches said medical imaging records with radiological reports.

31. The device of claim 24, wherein said at least one application is a browser.

32. The device of claim 24, wherein said collaborative functions comprise at least one of a search feature, browse feature, share feature, enrich feature and audit feature.

33. A method for implementing collaborative features on a medical imaging system, said method comprising:
providing one or more routines to a participating node;
receiving a routine request from said participating node corresponding to said one or more routines; and
processing or analyzing medical imaging records dependent on said routine request by accessing said medical imaging records in said medical imaging system.

34. The method of claim 33, wherein processing or analyzing said medical imaging records comprises determining whether to access a repository storing personal information and a database storing non-personal information within said medical imaging system.

35. The method of claim 33, wherein said one or more routines correspond to application programming interfaces.

36. The method of claim 35, wherein said application programming interfaces are combined to create application level collaborative capabilities.

37. The method of claim 33, wherein said routine request comprises a command along with a global resource locator.

38. The method of claim 37, wherein said global resource locator comprises an internet addressable schema.

39. The method of claim 33, wherein said routine request comprises a search query.

40. The method of claim 39, wherein said search query corresponds to at least one of a date, type, location, date of birth or last name of a patient in a study.
